(19) United States
(12) Patent Application Publication
(10) Pub. No.: US 2025/0338369 A1
(43) Pub. Date: Oct. 30, 2025

(54) Power Transmission Vehicle Device

(71) Applicant: Hunan Huaxia Tebian Co., Ltd., Xiangtan (CN)

(72) Inventors: Xiangbin XIA, Xiangtan (CN); Fuque XIA, Xiangtan (CN)

(21) Appl. No.: 19/258,337

(22) Filed: Jul. 2, 2025

Related U.S. Application Data
(63) Continuation of application No. PCT/CN2024/081657, filed on Mar. 14, 2024.

(30) Foreign Application Priority Data
Mar. 16, 2023 (CN) 202310253914.8
Mar. 16, 2023 (CN) 202320508646.5
Mar. 16, 2023 (CN) 202320508912.4
Mar. 16, 2023 (CN) 202320511531.1
Aug. 4, 2023 (CN) 202322094753.0
Aug. 14, 2023 (CN) 202311015618.0
Aug. 14, 2023 (CN) 202322173551.5
Sep. 4, 2023 (CN) 202311126800.3
Oct. 8, 2023 (CN) 202322688537.9
Oct. 27, 2023 (CN) 202322899464.8

(51) Int. Cl. H05B 7/102; F27B 14/06; F27B 14/14; H05B 7/11; H05B 7/12; H05B 7/18

(52) U.S. Cl. CPC H05B 7/102; F27B 14/06; F27B 14/14; H05B 7/11; H05B 7/12; H05B 7/18

(57) ABSTRACT

The present application provides a power transmission vehicle device, including a vehicle body, an electrode clamping mechanism and an aluminum row clamping mechanism, wherein the electrode clamping mechanism and the aluminum row clamping mechanism are both provided on the vehicle body, the aluminum row clamping mechanism is used for clamping a power transmission aluminum row, and the aluminum row clamping mechanism is connected to the electrode clamping mechanism via a connecting cable; the electrode clamping mechanism comprises a strut and an electrode clamping assembly arranged on the strut. According to the present application, when an electrode clamping assembly clamps a conductive electrode, a corresponding operation can be performed according to a deformation change of the conductive electrode, thereby satisfying the effect of a stable clamping of the conductive electrode by an electrode clamping mechanism.

### CROSS REFERENCE TO RELATED APPLICATIONS

This application is a Continuation of PCT/CN2024/081657 filed on Mar. 14, 2024, which claims priority to Chinese Patent Application No. CN202322899464.8, filed with the Chinese Patent Office on Oct. 27, 2023 and entitled AN ELECTRODE CLAMPING DEVICE, Chinese Patent Application No. CN202310253914.8. filed with the Chinese Patent Office on March 16. 2023 and entitled CONTACT COPPER-ALUMINUM ROW CLAMPING DEVICE, Chinese Patent Application No. CN202322094753.0, filed with the Chinese Patent Office on Aug. 4, 2023 and entitled STAND OF ELECTRODE CLAMPING MECHANISM, ELECTRODE CLAMPING MECHANISM AND POWER TRANSMISSION VEHICLE DEVICE, Chinese Patent Application No. CN202320508912.4, filed with the Chinese Patent Office on Mar. 16, 2023 and entitled WATER-COOLING CLAMPING PLATE FOR FURNACE HEAD ELECTRODE AND CLAMP, Chinese Patent Application No. CN202311015618.0, filed with the Chinese Patent Office on Aug. 14, 2023 and entitled ADAPTIVE CLAMPING MECHANISM AND POWER TRANSMISSION VEHICLE DEVICE, Chinese Patent Application No. CN202322173551.5, filed with the Chinese Patent Office on Aug. 14, 2023 and entitled ADAPTIVE CLAMPING MECHANISM AND POWER TRANSMISSION VEHICLE DEVICE, Chinese Patent Application No. CN202320511531.1, filed with the Chinese Patent Office on March 16. 2023 and entitled ADAPTIVE CLAMP AND ELECTRODE CLAMPING MECHANISM, Chinese Patent Application No. CN202320508646.5, filed with the Chinese Patent Office on Mar. 16, 2023 and entitled ELECTRODE CLAMPING OPENING STRUCTURE AND ELECTRODE CLAMPING DEVICE, Chinese Patent Application No. CN202311126800.3, filed with the Chinese Patent Office on Sep. 4, 2023 and entitled ELECTRODE CLAMPING STOPPER STRUCTURE AND POWER TRANSMISSION VEHICLE, the Chinese Patent Application No. CN202322688537.9, filed with the Chinese Patent Office on Oct. 8, 2023 and entitled COOLING STRUCTURE OF ALUMINIUM CLAMPING PLATE, ALUMINIUM CLAMPING MECHANISM AND POWER TRANSMISSION VEHICLE, which are hereby incorporated by reference in its entirety.

### TECHNICAL FIELD

The application relates to the technical field of Acheson graphite furnace power transmission equipment, in particular to a power transmission vehicle device.

### BACKGROUND TECHNOLOGY

Acheson Graphite Furnace is a device for transforming amorphous carbon into layered and regularly arranged graphite structure by high temperature. Acheson furnace is one of Acheson graphite furnaces. Acheson graphite furnace has cuboid furnace body and conductive electrodes at both ends of furnace head and furnace tail. The conductive electrodes at both ends of Acheson graphite furnace need to be directly connected with power transmission aluminum row to obtain high current.

Among them, the conductive electrode will deform when assembled or heated, and there will be deviation compared with the initial preset position, which makes it difficult for the electrode clamping mechanism of the power transmission vehicle device to form stable clamping with the conductive electrode, thus reducing the power transmission stability of the power transmission vehicle device.

In view of this, it is necessary to propose a power transmission vehicle device to solve the above technical problems.

### SUMMARY

Based on this, the present application aims to provide a power transmission vehicle device for improving the stability of power transmission and improving the stability of the electrode clamping mechanism for clamping conductive electrodes. In order to solve the technical problem, the technical proposal adopted by the application is: a power transmission vehicle device comprises a vehicle body, an electrode clamping mechanism and an aluminum row clamping mechanism. wherein the electrode clamping mechanism and the aluminum row clamping mechanism are arranged on the vehicle body. wherein the aluminum row clamping mechanism is used for clamping the power transmission aluminum row, and the aluminum row clamping mechanism is electrically connected with the electrode clamping mechanism;

The electrode clamping mechanism comprises a strut and an electrode clamping assembly arranged on the strut, the strut is arranged on the vehicle body, the electrode clamping assembly is used for clamping the conductive electrode, and the electrode clamping assembly can be movably arranged on the strut.

Preferably, the electrode clamping assembly is arranged on the strut being movable back and forth.

Further preferably, the electrode clamping assembly is provided with a slide assembly, the strut comprises a base pillar. a supporting block is arranged on one side of the base pillar facing the conductive electrode, and the electrode clamping assembly is arranged on the supporting block being movable back and forth through the slide assembly.

Further preferably, the electrode clamping assembly further comprises:
a first supporting frame arranged on the supporting block to be movable back and forth through the slide assembly;
two electrode clamping plates together realize clamping operation for a conductive electrode on a furnace;
two first clamping arms respectively hinged to two sides of the first supporting frame, and two electrode clamping plates being respectively arranged on the two first clamping arms; and
a first driving member arranged between the two first clamping arms and connected to the two first clamping arms.

Further preferably, the electrode clamping assembly further comprises an ejection assembly arranged on the first supporting frame, and the ejection assembly is used for displacing the electrode clamping assembly back and forth.

Further preferably, the ejection assembly comprises a mounting block and an ejection member, which are connected to each other, the mounting block disposed on the first supporting frame, and an ejection member is used for abutting against one side of the strut.

Further preferably, the first supporting frame comprises two first support plates, and the sliding assembly comprises a first sliding member and/or a second sliding member, wherein the first sliding member is arranged below one of the first support plates: and/or a second sliding member is provided below the other first support plate.

Preferably, the strut comprises a base pillar, a supporting block is arranged on one side of the base pillar facing the conductive electrode, and an electrode clamping assembly is movably arranged on the supporting block; the electrode clamping mechanism also comprises a connecting component which is arranged between the electrode clamping assembly and the supporting block;
the connecting component comprises a connecting piece and a plurality of elastic pieces arranged on both sides of the connecting piece, one end of the elastic piece is connected with the supporting block, and the other end is connected with the electrode clamping assembly; at least one of the electrode clamping assembly, the supporting block and the connecting piece is provided with a circular arc portion, and the electrode clamping assembly can rotate opposite to the connecting piece along the bending direction of the circular arc portion.

Further preferably, the electrode clamping assembly comprises a first supporting frame, the connecting piece is arranged between the first supporting frame and the supporting block, and one end of the elastic pieces is connected with the first supporting frame and the other end is connected with the supporting block.

Further preferably, the circular arc portion is provided on the connecting piece, the first supporting frame and/or the supporting block are in contact with the connecting piece through the circular arc portion, and the first supporting frame and/or the supporting block can rotate along the bending direction of the circular are portion of the connecting piece.

Further preferably, the circular are portion is provided on the first supporting frame, and the first supporting frame is in contact with the connecting piece through the circular are portion.

Further preferably, the circular arc portion is provided on the supporting block, and the supporting block is in contact with the connecting piece through the circular arc portion.

Preferably, the electrode clamping assembly comprises:
a first supporting frame arranged on the strut;
two opposite electrode clamping plates; the two electrode clamping plates jointly realize the clamping operation of the conductive electrodes on the furnace;
two first clamping arms respectively hinged with both sides of the first supporting frame, and two electrode clamping plates are respectively provided on the two first clamping arms; each electrode clamping plate is hinged on a first clamping arm on a corresponding side through a second rotating shaft, and the electrode clamping plate can be swung around the second rotating shaft; and
a first driving member arranged between the two first clamping arms and respectively connected with the two first clamping arms;
at least one first clamping arm provided with a first elastic body, which is bent to extend a stopper portion for abutting against one side of the electrode clamping plate.

Further preferably, the stopper portions of the two first elastic body are respectively provided on both sides of the second rotating shaft.

Further preferably, the first clamping arm is provided with a first fixing plate, and the first elastic body is provided on the first fixing plate at intervals.

Further preferably, a screw hole is provided in the limit part, and a first limit bolt is arranged in the screw hole, and one end of the first limit bolt is used for abutting against one side of the electrode clamping plate.

Further preferably, a cushion block is protruded toward the side of the electrode clamping plate toward the stopper portion, and the cushion block is arranged to abut against with the stopper portion.

Preferably, the electrode clamping mechanism further comprises a stopper assembly, the electrode clamping assembly comprising:
a first supporting frame arranged on the strut;
two opposite electrode clamping plates;
two first clamping arms respectively hinged with both sides of the first supporting frame, and two electrode clamping plates are respectively arranged on the two first clamping arms; and
a first driving member arranged between the two first clamping arms and respectively connected with the two first clamping arms;
wherein, two stopper assemblies are respectively arranged on both sides of the strut, and the stopper assembly is used for adjusting the direction of opening of the electrode clamping plates.

Further preferably, when the stopper assembly is arranged on the first clamping arm, a stopper plate is arranged at the first end of the first clamping arm, a first limiting hole is provided on the stopper plate, and the stopper assembly is arranged through the first limiting hole and close to one side of the strut.

Further preferably, when the stopper assembly is arranged on the strut, the distance between the strut and the first end of the first clamping arm is adjusted by adjusting the limiting assembly, so as to adjust the opening direction of the electrode clamping plate.

Preferably, the electrode clamping assembly comprises an electrode clamping plate comprising a first clamping plate and a first conductive plate, a cooling pipeline is arranged on the back of the first clamping plate, and a connecting hole for connecting circulating liquid is arranged at the end of the cooling pipeline; the first conductive plate is tightly arranged on the front surface of the first clamping plate.

Further preferably, the first clamping plate is further provided with a protective case, the protective case comprising a side plate surrounding the cooling pipeline and a cover plate covering an edge of the side plate; the cover plate is provided with a through hole corresponding to the connecting hole.

Further preferably, the cooling pipeline comprises a first pipeline and a second pipeline arranged side by side along the first direction of the first clamping plate, a first protective case and a second protective case are respectively arranged corresponding to the first pipeline and the second pipeline, and an avoidance groove is arranged between the two protective cases, and the avoidance groove is provided in the avoidance groove for pivots to penetrate.

Further preferably, the cooling pipeline is a water-cooling pipeline and the circulating liquid is circulating water.

Preferably, the electrode clamping assembly comprises two electrode clamping plates which are close to or far away from each other, the electrode clamping plate comprises a first clamping plate, a first conductive plate is installed on the inner side of the first clamping plate, an elastic pad is also arranged between the first conductive plate and the first clamping plate. and the first conductive plate is divided into a plurality of conductive sheets arranged in parallel.

Preferably, the electrode clamping assembly comprises an electrode clamping plate, the electrode clamping plate comprises a first clamping plate and a first conductive plate, the first conductive plate is arranged on the first clamping plate. and the first conductive plate is provided with a first conductive end and a second conductive end;
the first conductive end is arranged in communication with the first conductive plate through a first flow pipe, the second conductive end is arranged in communication with the first conductive plate through a second flow pipe, and a cooling channel is arranged on the first conductive plate.

Further preferably, the first conductive plate is integrally formed, the inlet of the cooling channel is connected with the first flow pipe, and the outlet of the cooling channel is connected with the second flow pipe.

Further preferably, the first conductive plate comprises at least one first conductive sheet and at least one second conductive sheet, the first conductive sheet and the second conductive sheet are arranged side by side, the first conductive end is fixedly connected to the first conductive sheet, and the second conductive end is fixedly connected to the second conductive sheet: one end of the first flow pipe is connected with the first conductive end, the other end of the first flow pipe is connected with the first conductive sheet, one end of the second flow pipe is connected with the second conductive end, the other end of the second flow pipe is connected with the second conductive sheet, and the first conductive sheet is connected with the second conductive sheet through a third flow pipe.

Preferably, the strut comprises a base pillar, the base pillar comprises a pillar body and a cross bar, and the cross bar is connected to the pillar body and is perpendicular to each other;

Among them, the crossbar extends towards Acheson graphite furnace.

Preferably, the electrode clamping assembly comprises:
a first supporting frame;
two opposite electrode clamping plates; wherein, the clamping surfaces of the two electrode clamping plates are arranged opposite to each other with curved surfaces;
two first clamping arms respectively hinged with both sides of the first supporting frame, and two electrode clamping plates respectively arranged on the two first clamping arms; and
the first driving member arranged between the two first clamping arms and respectively connected with the two first clamping arms.

Further preferably, the electrode clamping plate comprises a first clamping plate and a first conductive plate, the first conductive plate is attached to the inner side of the first clamping plate, the outer side of the first clamping plate extends in the direction of the first clamping arm and is rotationally connected to the first clamping arm, and the clamping surface is one side surface of the first conductive plate away from the first clamping plate.

Further preferably, the first clamping plate comprises a bending portion, two stiffeners and two connecting plates: each stiffener extends in the circumferential direction of the bending portion, two stiffeners arranged at intervals along the axial direction of the bending portion; the two connecting plates arranged at intervals along the circumferential direction of the bending portion, and both ends connected to the two stiffeners respectively, the connecting plates being rotationally connected to the first clamping arm.

Compared with the prior art, the application discloses a power transmission vehicle device comprising a vehicle body. an electrode clamping mechanism and an aluminum row clamping mechanism, wherein, the electrode clamping mechanism and the aluminum row clamping mechanism are arranged on the vehicle body, wherein the aluminum row clamping mechanism is used for clamping the power transmission aluminum row, and the aluminum row clamping mechanism is connected with the electrode clamping mechanism through a connecting cable; the electrode clamping mechanism comprises a strut and an electrode clamping assembly arranged on the pillar, wherein the pillar is arranged on the vehicle body, the electrode clamping assembly is used for clamping the conductive electrode, and the electrode clamping assembly can be movably arranged on the pillar; when the electrode clamping assembly clamps the conductive electrode, the electrode clamping assembly can adapt to the deformation change of the conductive electrode and operate correspondingly, thus satisfying the effect that the electrode clamping mechanism clamps the conductive electrode stably.

### DESCRIPTION OF DRAWINGS

FIG. 1 is a structural schematic diagram of a power transmission vehicle device of the present application;

FIG. 2 is a structural schematic diagram of a power transmission vehicle device of the present application from another perspective;

FIG. 3 shows a structural schematic diagram of an electrode clamping mechanism provided in embodiment 1 of the present application;

FIG. 4 shows a structural schematic diagram of an electrode clamping assembly provided in embodiment 1 of the present application;

FIG. 5 shows a structural schematic diagram of the electrode clamping assembly provided in embodiment 1 of the present application from another perspective;

FIG. 6 shows an enlarged partial view of an electrode clamping assembly provided in embodiment 1 of the present application;

FIG. 7 shows an exploded view of the structure of the first slide piece provided in embodiment 1 of the present application;

FIG. 8 shows an exploded view of the structure of the second slide piece provided in embodiment 1 of the present application;

FIG. 9 shows a structural schematic diagram of a strut provided in embodiment 1 of the present application;

FIG. 10 shows an enlarged partial view of a strut provided in embodiment 1 of the present application;

FIG. 11 shows a structural front view of an electrode clamping assembly provided in embodiment 2 of the present application;

FIG. 12 shows an enlarged partial view of an electrode clamping assembly provided in embodiment 2 of the present application;

FIG. 13 shows a schematic diagram of an electrode clamping assembly provided in embodiment 2 of the present application;

FIG. 14 shows a schematic diagram of an electrode clamping assembly provided in embodiment 2 of the present application;

FIG. 15 shows a schematic diagram of an electrode clamping assembly provided in embodiment 2 of the present application;

FIG. 16 shows a schematic diagram of an electrode clamping assembly provided in embodiment 2 of the present application;

FIG. 17 shows a schematic diagram of an electrode clamping assembly provided in embodiment 2 of the present application;

FIG. 18 shows a schematic diagram of an electrode clamping assembly provided in embodiment 2 of the present application;

FIG. 19 shows a schematic diagram of an electrode clamping assembly provided in embodiment 2 of the present application;

FIG. 20 shows a schematic diagram of an electrode clamping assembly provided in embodiment 2 of the present application;

FIG. 21 shows a schematic diagram of an electrode clamping assembly provided in embodiment 2 of the present application;

FIG. 22 shows a schematic diagram of an electrode clamping assembly provided in embodiment 2 of the present application;

FIG. 23 shows a schematic diagram of an electrode clamping assembly provided in embodiment 2 of the present application;

FIG. 24 shows a schematic diagram of an electrode clamping assembly provided in embodiment 2 of the present application;

FIG. 25 shows a structural diagram of the strut provided in embodiment 2 of the present application;

FIG. 26 shows a schematic structural diagram of an electrode clamping assembly provided in embodiment 2 of the present application;

FIG. 27 shows a structural schematic diagram of the electrode clamping assembly provided in embodiment 2 of the present application from another perspective;

FIG. 28 shows a schematic structural diagram of an electrode clamping assembly provided in embodiment 3 of the present application;

FIG. 29 shows a schematic structural diagram of an electrode clamping mechanism provided in embodiment 3 of the present application;

FIG. 30 shows a schematic structural diagram of an electrode clamping mechanism provided in embodiment 4 of the present application;

FIG. 31 shows a schematic structural diagram of the strut provided in embodiment 4 of the present application;

FIG. 32 shows a schematic structural diagram of an electrode clamping assembly provided in embodiment 4 of the present application;

FIG. 33 shows a schematic structural diagram of an electrode clamping assembly provided in embodiment 5 of the present application;

FIG. 34 shows a schematic structural diagram of the electrode clamping assembly provided in embodiment 5 of the present application from another perspective;

FIG. 35 shows a structural diagram of the first clamping plate provided in embodiment 5 of the present application;

FIG. 36 shows an exploded view of the structure of the first clamping plate provided in embodiment 5 of the present application;

FIG. 37 shows a configuration state diagram in which the electrode clamping assembly provided in embodiment 5 of the present application is mounted on the strut;

FIG. 38 shows a configuration state diagram in which the electrode clamping assembly clamping the conductive electrode provided in embodiment 5 of the present application;

FIG. 39 shows a schematic structural diagram of an electrode clamping assembly provided in embodiment 6 of the present application;

FIG. 40 shows a schematic structural diagram of the electrode clamp provided in embodiment 6 of the present application;

FIG. 41 shows an exploded view of the structure of the electrode clamping plate provided in embodiment 6 of the present application;

FIG. 42 shows a configuration state diagram in which a conductive electrode clamped by the electrode clamping assembly provided in embodiment 6 of the present application;

FIG. 43 shows a schematic structural diagram in which the first clamping plate fixedly connected to the first clamping arm provided in embodiment 6 of the present application;

FIG. 44 shows a schematic structural diagram of another v-shaped clamp structure provided in embodiment 6 of the present application;

FIG. 45 shows a schematic structural diagram of the electrode clamping plate provided in embodiment 7 of the present application;

FIG. 46 shows a schematic diagram of the combination of a first conductive end and a first conductive plate provided in embodiment 7 of the present application;

FIG. 47 shows a schematic diagram of the combination of a second conductive end and a first conductive plate when there is only one first conductive end and one second conductive end provided in embodiment 7 of the present application;

FIG. 48 shows a schematic structural diagram of a first conductive end or a second conductive end provided in embodiment 7 of the present application;

FIG. 49 shows a schematic structural diagram of a second electrode clamping plates provided in embodiment 7 of the present application;

FIG. 50 is a schematic diagram showing a combination of a second conductive end and a first conductive plate provided in embodiment 7 of the present application;

FIG. 51 shows a schematic structural diagram of an electrode clamping assembly provided in embodiment 7 of the present application;

FIG. 52 shows a schematic structural diagram of the electrode clamping mechanism provided in embodiment 8 of the present application;

FIG. 53 shows a schematic structural diagram of the strut provided in embodiment 8 of the present application;

FIG. 54 shows a schematic structural diagram of an electrode clamping assembly provided in embodiment 8 of the present application;

FIG. 55 shows a schematic structural diagram of the power transmission vehicle device provided in embodiment 8 of the present application;

FIG. 56 shows a schematic structural diagram of a sliding mechanism provided in embodiment 8 of the present application;

FIG. 57 shows a schematic structural diagram of a sliding mechanism provided in embodiment 8 of the present application;

FIG. 58 shows a schematic structural diagram of a sliding mechanism provided in embodiment 8 of the present application;

FIG. 59 shows a schematic structural diagram of an electrode clamping assembly provided in embodiment 9 of the present application;

FIG. 60 shows a schematic structural diagram of the first clamping plate provided in embodiment 9 of the present application;

FIG. 61 shows a schematic structural diagram of a base frame provided in embodiment 10 of the present application;

FIG. 62 shows a schematic structural diagram of a base frame provided in embodiment 10 of the present application;

FIG. 63 shows a schematic structural diagram of a base frame provided in embodiment 10 of the present application;

FIG. 64 shows a schematic structural diagram of the power transmission vehicle device provided in embodiment 10 of the present application:

FIG. 65 shows a schematic structural diagram of the aluminum row clamping mechanism provided in embodiment 11 of the present application:

FIG. 66 shows a schematic structural diagram of the base frame provided in embodiment 11 of the present application;

FIG. 67 shows a partially enlarged view of the base frame provided in embodiment 11 of the present application;

FIG. 68 shows a schematic structural diagram of the power transmission vehicle device provided in embodiment 11 of the present application:

FIG. 69 shows a schematic structural diagram of the power transmission vehicle device provided in embodiment 12 of the present application:

FIG. 70 shows a schematic structural diagram of the aluminum row clamping assembly provided in embodiment 12 of the present application.

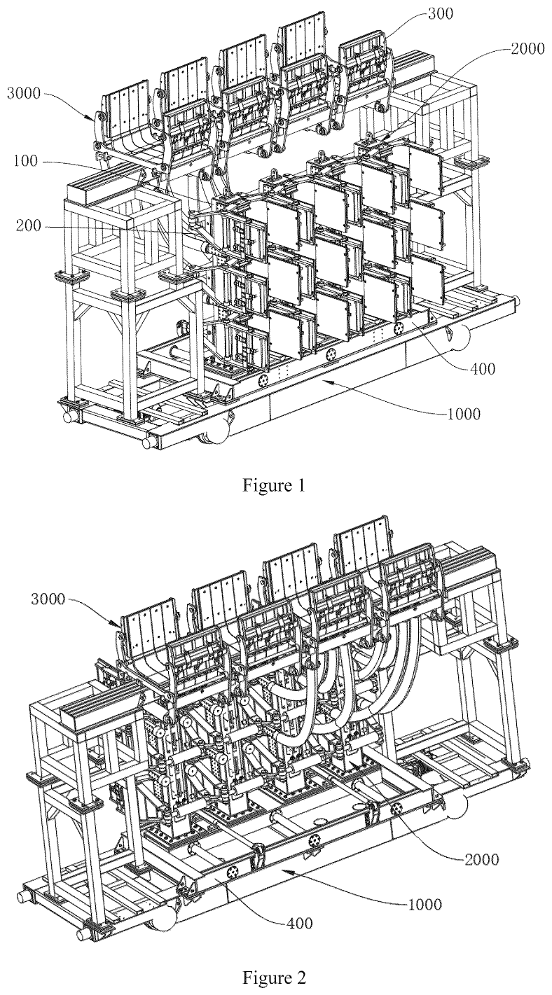

### DETAILED DESCRIPTION

The technical solutions of the present application will be clearly and completely described in the following with reference to the accompanying drawings. Apparently, the described embodiments are a part rather than all of the embodiments of the present application. All other embodiments obtained by persons of ordinary skill in the art based on the embodiments of the present application without creative efforts shall belong to the scope of protection of the present application.

In the description of the present application, it should be noted that the orientation or position relations indicated by the terms “central”, “upper”, “lower”, “left”, “right”, “vertical”, “horizontal”, “inner”, “outer” and the like are based on the orientation or position shown in the drawings. It is only for convenience in describing the present application and simplifying the description, rather than indicating or implying that the indicated device or element must have a particular orientation, be constructed and operated in a particular orientation. Therefore, it cannot be understood that the present application is limited thereto. In addition, the terms “first”, “second”, and “third” are used for descriptive purposes only and are not to be construed as indicating or implying relative importance.

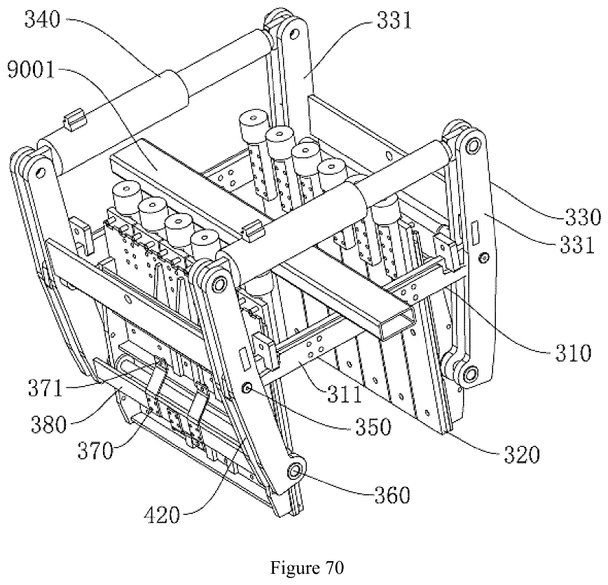

In the description of the present application, it should be noted that, unless specified or limited otherwise, the terms “mounted”, “connected”, and “linked” should be understood broadly, and may be, for example, fixed connections, detachable connections, or integral connections; may also be mechanical or electrical connections; may also be direct connections or indirect connections via intervening structures; and may also be inner communications of two elements. The specific meanings of the above terms in the present application can be understood by those skilled in the art according to specific situations. Referring to FIGS. 1-70, the present application relates to a power transmission vehicle device for supplying power to graphitization equipment, exemplarily, the graphitization device is an Acheson Graphite Furnace Group comprising a plurality of Acheson Graphite Furnaces arranged side by side at intervals. Acheson graphite furnace comprises a cuboid furnace body and conductive electrodes arranged on both ends of the furnace body. The conductive electrode is cuboid. There are 9 conductive electrodes, which are distributed on the end face of the furnace body in a square shape, or can be arranged as two. four, six, etc according to the needs. The number of conductive electrodes protruding from the end face of the furnace body is determined according to the layout of conductive electrodes for graphitization operation in Acheson graphite furnace.

A guide rail is arranged between a plurality of Acheson graphite furnace groups, and the guide rail is arranged parallel to the Acheson graphite furnace groups. The power transmission vehicle device moves along the guide rail and is used to deliver electricity to the conductive electrodes of different Acheson graphite furnaces.

Referring to FIG. 1, the power transmission vehicle device includes a vehicle body 1000, an electrode clamping mechanism 2000 and an aluminum row clamping mechanism 3000. The vehicle body 1000 has a motion function to drive the whole power transmission vehicle device to move along the rail to transmit electricity to the conductive electrodes of different Acheson graphite furnaces. The electrode clamping mechanism 2000 and the aluminum row clamping mechanism 3000 are both provided on the vehicle body 1000, and the vehicle body 1000 serves as a carrier to support the electrode clamping mechanism 2000 and the aluminum row clamping mechanism 3000.

The electrode clamping mechanism 2000 is used for clamping the conductive electrode, the aluminum row clamping mechanism 3000 is used for clamping the power transmission aluminum row, and the aluminum row clamping mechanism 3000 is electrically connected with the electrode clamping mechanism 2000; specifically, the aluminum row clamping mechanism 3000 and the electrode clamping mechanism 2000 can be electrically connected through flexible connecting pieces such as connecting cables and flexible bus bars, so that the power of the power transmission aluminum row is transmitted to the electrode clamping mechanism 2000, and then the power is transmitted to the conductive electrode by the electrode clamping mechanism 2000, thereby realizing the power supply operation for Acheson graphite furnace; the vehicle body 1000 drives the electrode clamping mechanism 2000 to move to the conductive electrode, cooperates with the electrode clamping mechanism 2000 to clamp the conductive electrode, and uses the aluminum row clamping mechanism 3000 to clamp the power transmission aluminum row, so that the electricity delivered by the power transmission aluminum row is transmitted to the conductive electrode through the aluminum row clamping mechanism 3000 and the electrode clamping mechanism 2000. When power supply to Acheson graphite furnace is not needed, only the electrode clamping mechanism 2000 and/or the aluminum row clamping mechanism 3000 need to be loosened to complete the power-off operation of the conductive electrode. thus effectively improving the convenience of power supply to Acheson graphite furnace. In addition, by clamping and loosening the power transmission aluminum row by the aluminum row clamping mechanism 3000, the wear and tear operation of the power transmission aluminum row by the existing power transmission technical scheme is avoided, and the service life of the power transmission aluminum row is effectively prolonged.

In one embodiment, the electrode clamping mechanism 2000 is sliding connected with the vehicle body 1000, the electrode clamping mechanism 2000 is arranged along the length direction of the vehicle body 1000, a sliding mechanism 400 is arranged on the vehicle body 1000, and the electrode clamping mechanism 2000 is pushed out from one side of the vehicle body 1000 by the sliding mechanism 400 to butt with the conductive electrode of the Acheson graphite furnace. After finishing power transmission, the electrode clamping mechanism 2000 is loosened and driven to the initial position by the sliding mechanism 400, so that the electrode clamping mechanism 2000 is available for clamping and power transmission operation of the conductive electrode in the next Acheson graphite furnace, and the convenience of power supply to the Acheson graphite furnace is effectively improved.

In one embodiment, the electrode clamping mechanism 2000 comprises a strut 100 and an electrode clamping assembly 200 arranged on the strut 100, the strut 100 is arranged on the vehicle body 1000, the electrode clamping assembly 200 is used for clamping the conductive electrode, and the electrode clamping assembly can be movably arranged on the strut. When the electrode clamping assembly clamps the conductive electrode, it can adapt to the deformation change of the conductive electrode and make corresponding operations, thereby satisfying the effect that the electrode clamping mechanism stably clamps the conductive electrode; the aluminum row clamping mechanism 3000 includes an aluminum row clamping assembly 300 which is used for clamping the power transmission aluminum row. The aluminum row clamping assembly 300 is connected with the electrode clamping assembly 200 through a connecting cable, so that the power of the power transmission aluminum row is transmitted to the electrode clamping assembly 200, and then the electrode clamping assembly 200 transmits the electricity to the conductive electrode, thereby realizing the power supply for Acheson graphite furnace; the electrode clamping mechanism 2000 is drove by the vehicle body 1000 to move to the conductive electrode, and cooperates with the electrode clamping assembly 200 to clamp the conductive electrode, and uses the aluminum row clamping assembly 300 to clamp the power transmission aluminum row, so that the electricity delivered by the power transmission aluminum row is transmitted to the conductive electrode through the aluminum row clamping assembly 300 and the electrode clamping assembly 200. When power supply to Acheson graphite furnace is not needed, only the electrode clamping assembly 200 and/or the aluminum row clamping assembly 300 need to be loosened to complete the power-off operation of the conductive electrode, thus effectively improving the convenience of power supply to Acheson graphite furnace. In addition, because the conductive electrode is replaced after graphitization operation, and the replacement and maintenance of the power transmission aluminum row are more complicated, the clamping and loosening operation of the power transmission aluminum row by the aluminum row clamping assembly 300 avoids the wear and tear of the power transmission aluminum row in the existing power transmission technical scheme, and effectively prolongs the service life of the power transmission aluminum row. In the present embodiment. at least one electrode clamping assembly 200 and at least one strut 100 are arranged as required, a plurality of electrode clamping assembly 200 are longitudinally arranged on the strut 100, and a plurality of struts 100 are arranged along the length direction of the vehicle body 1000 to match the positions of conductive electrodes on both ends of the furnace body. For example, when the number of strut 100 is set to three and the number of electrode clamping assembly 200 longitudinally arranged on the strut 100 is set to three, the power supply operation of no more than 9 conductive electrodes on both ends of the furnace body can be realized.

### Embodiment 1

Different from conventional workpieces, conductive electrodes have the characteristics of thermal expansion and cold contraction. Specifically, at 2600˜3000° C, the conductive electrode will stretch in its axial direction and/or perpendicular to the axial direction when heated, and the conductive electrode will have a certain angular deviation and a certain length change compared with the initial state when it works in specific condition.

In the process of transmitting electricity to the conductive electrode, the conductive electrode is elongated in its axial direction. Since the electrode clamping assembly 200 is in a state of clamping the conductive electrode during power transmission, the conductive electrode will synchronously push the electrode clamping assembly 200 to move towards the power transmission vehicle device when the radial length of the conductive electrode is increased, thus causing instability of clamping the conductive electrode by the electrode clamping assembly. In this way, in order to avoid the problem that the production efficiency of the graphite conductive electrode is affected by the instability of the electrode clamping assembly clamping the conductive electrode or the possibility that the conductive electrode is broken due to the stress generated by expansion, the present embodiment specifically adopts the following structure to solve the problem.

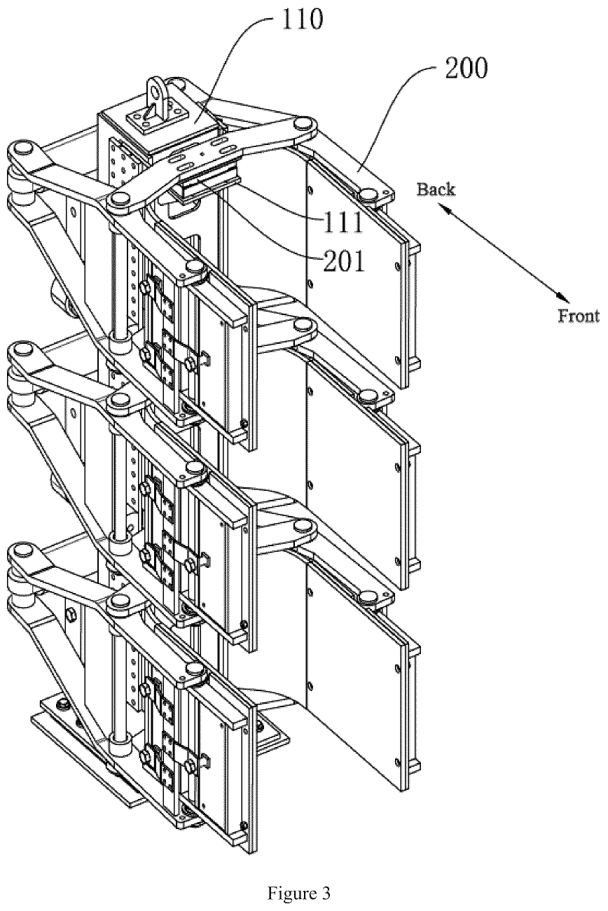

Referring to FIGS. 3 to 10, the electrode clamping assembly 200 is disposed on the strut 100 so as to be movable back and forth; in this embodiment, one side the opening of the electrode clamping assembly 200 faces as the front and the side far away from the opening of the electrode clamping assembly 200 as the back.

Specifically, the strut 100 includes a base pillar 110 in the shape of a cuboid, a supporting block 111 is provided on one side of the base pillar 110 facing the conductive electrode, and an electrode clamping assembly 200 is provided on the supporting block 111 so as to be movable back and forth. The supporting block 111 is used to support the electrode clamping assembly 200.

The electrode clamping assembly 200 is provided with a slide assembly 500, by providing the slide assembly 500, the slide assembly 500 slides on the supporting block 111, thereby driving the entire electrode clamping assembly 200 to slide, so as to realize the function of relative movement of the electrode clamping assembly 200 and the strut 100, that is, the direction indicated by the arrow in FIG. 3.

When the conductive electrode is heated and expanded, its radial length will be prolonged. The electrode clamping assembly 200 is moved towards the power transmission vehicle device under the push of the conductive electrodes. In this way, the production efficiency of the graphite conductive electrode can be prevented from being affected by the stress or even breaking caused by the expansion of the conductive electrode.

In one embodiment, the electrode clamping assembly 200 further includes:
The first supporting frame 210 arranged on the supporting block 111 so as to be movable back and forth through the sliding assembly 500;
Two opposite electrode clamping plate 220; wherein, the two electrode clamping plates 220 jointly realize the clamping operation of the conductive electrodes on the furnace body;
Two first clamping arms 230 respectively hinged with both sides of the first supporting frame 210, and two electrode clamping plates 220 are respectively arranged on the two first clamping arms 230; and
The first driving member 240 is disposed between the two first clamping arms 230 and connected to the two first clamping arms 230 respectively.

The supporting block 111 is a platform extending from the side surface of the base pillar 110, which not only supports the sliding assembly 500, but also can slide the sliding assembly 500 relative to the supporting block 111.

By providing the slide assembly 500, the slide assembly 500 slides on the supporting block 111 thereby driving the entire electrode clamping assembly 200 to slide.

In one embodiment, the first driving member 240 may be a cylinder, a hydraulic cylinder or a linear motor. Both ends of the first driving member 240 are hinged with the two first clamping arms 230, respectively. Under the action of the first driving member 240, the two first clamping arms 230 approach or move away from each other, thereby driving the two electrode clamping plates 220 to approach or move away from each other, thereby realizing the clamping or loosening operation of the conductive electrodes.

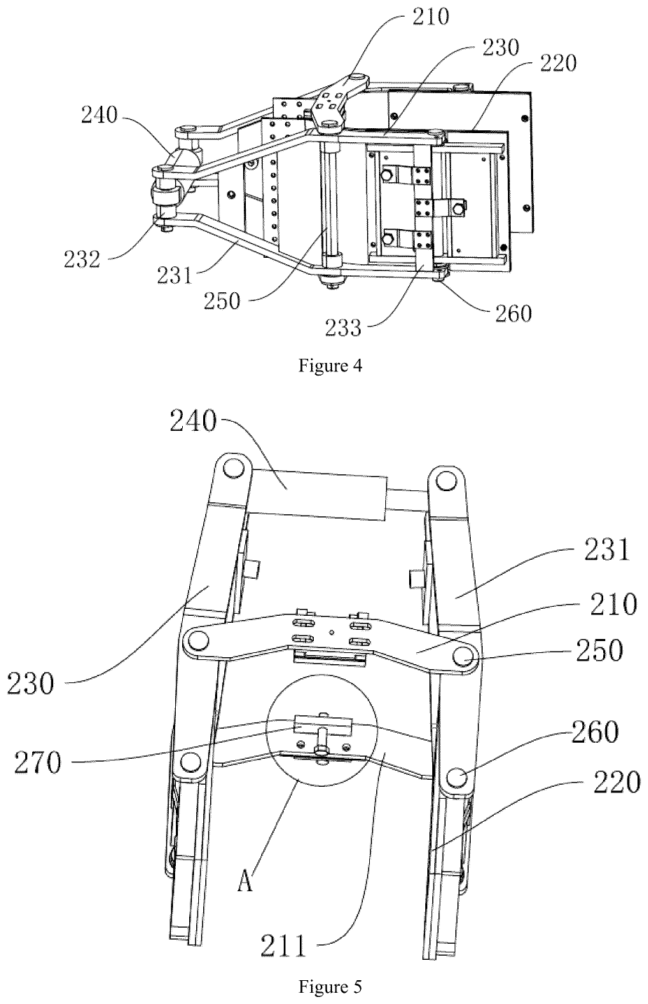

Referring to FIG. 4 and FIG. 5, in one embodiment, first rotary shafts 250 are respectively arranged on both sides of the first supporting frame 210, and the first driving member 240 is used to drive the first clamping arm 230 to rotate around the first rotary shaft 250 as the axis, and then drive the electrode clamping plates 220 to approach or move away from each other, thus completing the clamping or loosening operation of the conductive electrodes.

In one embodiment, the first clamping arm 230 is provided with a second rotary shaft 260, and the electrode clamping plate 220 rotates slightly around the second rotary shaft 260 as an axis; when the first driving member 240 drives the first clamping arm 230 to approach each other, the electrode clamping plate 220 on the first clamping arm 230 will gradually approach the conductive electrode. In order to ensure the tightness with the conductive electrode, the electrode clamping plate 220 will rotate around the second rotary shaft 260 as the axis according to actual needs to self-adjust, thereby maximizing the contact area between the electrode clamping plate 220 and the conductive electrode, and further improving the electrical conduction efficiency.

Further, the first clamping arm 230 includes two first clamping arms 231, the first rotary shaft 250 is arranged through the two first clamping arms 231, and the upper and lower ends of the first rotary shaft 250 are respectively connected with the first supporting frame 210 to improve the stability of the structure of the electrode clamping assembly 200; one ends of the two first clamping arms 231 is fixed together by a connecting rod 232, and the other ends of the two first clamping arms 231 is fixed together by a first fixing plate 233. Two ends of the first driving member 240 are respectively connected with the connecting rod 232, and the first driving member 240 drives the two first clamping arms 231 to move together by driving the connecting rod 232 to move, thus realizing the operation of driving the electrode clamping plate 220 to clamp or release the conductive electrode.

The first clamping arm 230 is provided with a first limit plate 234 near the connecting rod 232, and two ends of the first limit plate 234 are respectively connected with two first clamping arms 231, thereby enhancing the structural stability of the first clamping arm 230.

After completing the power transmission and heating of one Acheson graphite furnace, the power transmission vehicle device will continue to carry out the power transmission and heating for the next Acheson graphite furnace. However, the electrode clamping assembly 200 has been pushed some distance by the expansion of the conductive electrode in the previous Acheson furnace, and the conductive electrode in the next Acheson furnace is still in the position before expansion. The electrode clamping plate 220 of the electrode clamping assembly 200 clamps only a partial area of the conductive electrode so that the docking of the conductive electrode with the electrode clamping assembly 200 is unstable. Thus, in order to avoid the problem of unstable clamping of the conductive electrodes by the electrode clamping assembly 200 when the power transmission and heating operation of one Acheson graphite furnace is carried out for the next Acheson graphite furnace after the power transmission and heating operation of the power transmission vehicle device is completed, the present embodiment specifically adopts the following structure to solve the problem.

Referring to FIGS. 5-8, in one embodiment, the electrode clamping assembly 200 further includes an ejection assembly 270 disposed on the first supporting frame 210 for driving the electrode clamping assembly 200 forth and back to facilitate the return of the electrode clamping assembly 200 to an initial position.

In one embodiment, the ejection assembly 270 is used for abutting against one side of the strut 100 to force the strut 100, thereby moving the electrode clamping assembly 200 in the direction of the conductive electrodes and facilitating the return of the electrode clamping assembly 200 to the initial position.

Prior to docking with the next set of conductive electrodes a driving force towards the power transmission vehicle device is applied to the ejection assembly 270. Under the action of driving force, the ejection assembly 270 drives the whole electrode clamping assembly 200 to move towards the direction where the conductive electrodes are located until the electrode clamping assembly 200 returns to the position where it butts with the previous group of conductive electrodes, so as to smoothly butt with the next group of conductive electrodes and improve the butt stability between the conductive electrodes and the electrode clamping assembly 200.

Further, the ejection assembly 270 is located in the middle of the lower end of the first supporting frame 210. The ejection assembly 270 is used as a stress point proximate to the center of the entire electrode clamping assembly 200. Applying a force to the ejection assembly 270 can greatly improve the stability of the slide movement of the electrode clamping assembly 200.

In one embodiment the ejection assembly 270 may be forced manually to move the entire electrode clamping assembly 200. By means of manpower, the use cost can be greatly reduced, but it depends on the experience of operators to a great extent.

Alternatively thrust may also be applied to the ejection assembly 270 by a driving device (not shown) to move the entire electrode clamping assembly 200. The driving device has the advantages of high automation, simple operation, special control logic, high use cost and high technical threshold. In this embodiment, the driving device can be a driving motor, and can also be designed as a driving cylinder, a driving oil cylinder, etc. according to needs, all of which can complete the force application on the ejection assembly 270.

In one embodiment, the ejection assembly 270 includes a mounting block 271 coupled to the ejection piece 272, the mounting block 271 disposed on the first supporting frame 210, and an ejection piece 272 for abutting against one side of the strut 100.

Further the ejection assembly 270 may be configured such that the mounting block 271 is fixedly connected to the first supporting frame 210 and the mounting block 271 and the ejection piece 272 may be configured to be threaded.

Specifically, the mounting block 271 is mounted in such a manner that two third waist-shaped holes 2112 are provided at the lower end of the first supporting frame 210, and two locking portions are provided on the mounting block 271, and the two locking portions are matched with the two third waist-shaped holes 2112, so that the mounting block 271 and the first supporting frame 210 can be detachably connected. After the mounting block 271 is damaged, the maintenance personnel can directly replace the mounting block 271, and the maintenance cost is low.

Further the mounting block 271 is a rectangular flat plate on which a threaded mounting hole (not shown) is provided.

The ejection piece 272 is a fastening screw whose outer diameter is slightly smaller than the aperture of the threaded mounting hole of the mounting block 271 so that the fastening screw can pass through the threaded mounting hole. The head of the fastening screw is on the side facing the conductive electrode. An internal thread is formed on the hole wall of the threaded mounting hole, and an external thread is provided on the rod part of the fastening screw, so as to realize the threaded connection between the mounting block 271 and the ejection piece 272.

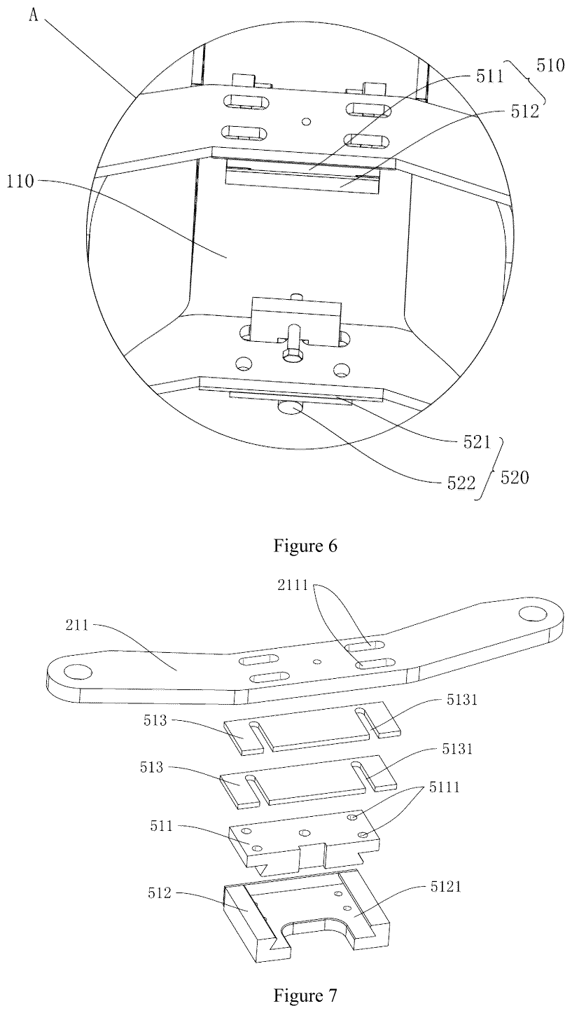

The length of the rod of the fastening screw is configured to be greater than the distance between the mounting block 271 and the base pillar 110 (see FIG. 6).

By configuring the mounting block 271 as a flat plate with a threaded mounting hole, an internal thread is formed in the threaded mounting hole: The ejection piece 272 is provided with a fastening screw, and the rod portion of the fastening screw is provided with an external thread, so that a threaded connection can be formed between the mounting block 271 and the ejection piece 272, and the structure is simple with simple operation and low use cost.

After the power transmission vehicle device has completed the power transmission of a set of Acheson graphite furnaces, the operator uses a screwdriver to turn the fastening screws counterclockwise until the rod of the fastening screws abuts against the base pillar 110. At this time, the operator continues to turn the fastening screw counterclockwise. The rotational force of the fastening screw is applied to the force in the direction of the conductive electrode through the thread transmission. This force can drive the mounting block 271 to move toward the conductive electrode side relative to the fastening screw, thereby driving the electrode clamping assembly 200 to move toward the conductive electrode side as a whole. When the electrode clamping assembly 200 is moved to a position where it is not pushed by the conductive electrode, the operator stops rotating the ejection piece 272 and the electrode clamping assembly 200 is reset.

For ease of understanding, the fastening screw can be used as a lead screw. When the fastening screw is rotated until its rod portion abuts against the base pillar 110, the base pillar 110 prevents the fastening screws from continuing to move. The fastening screw is threaded to the mounting block 271, and the threaded connection is one of the specific forms of the movable connection. The momentum applied to the fastening screw causes the mounting block 271 to move linearly in the opposite direction of the axial movement of the fastening screw.

Alternatively, in one embodiment, the ejection assembly 270 is used to provide an application point for applying a pulling force by an external force, and the ejection assembly 270 is applied by the external force, thereby completing the application effect on the electrode clamping assembly 200, so that the electrode clamping assembly 200 returns to the initial position. The electrode clamping assembly 200 may be configured such that the mounting block 271 is fixedly connected to the ejection piece 272. That is the mounting block 271 and the ejection piece 272 are integral. When a pulling force is manually applied to the ejection piece 272 the pulling force is transmitted to the entire electrode clamping assembly 200 through the whole of the mounting block 271 and the ejection piece 272.

The mounting block 271 and the ejection piece 272 are fixedly connected as a whole, which has high mechanical strength and low processing cost.

Referring to FIG. 5 and FIG. 6 again, in one embodiment, the first supporting frame 210 includes two first supporting plates 211 arranged in parallel, the upper and lower ends of the first rotary shaft 250 are respectively connected with the two first supporting plates 211, and the ejection assembly 270 is arranged on one of the first supporting plates 211. By arranging the two first supporting plates 211, the uniformity of driving force transmitted by the ejection assembly 270 can be improved. and the overall transmission efficiency of the electrode clamping assembly 200 can be improved.

In one embodiment the slide assembly 500 includes a first sliding piece 510 disposed below one of the first supporting plates 211 and/or a second sliding piece 520; and/or a second sliding piece 520 is disposed below the other first supporting plate 211. The first sliding piece 510 is located directly above the second sliding piece 520.

That is, the first sliding piece 510 or the second sliding piece 520 can be used separately in the present application, and one sliding piece can meet the basic sliding requirements. By using the first sliding piece 510 and the second sliding piece 520 at the same time, the slide of the electrode clamping assembly 200 can be more stable and reliable.

The present embodiment will be described in a case where the first sliding piece 510 and the second sliding piece 520 are provided at the same time.

Referring to FIG. 6 to FIG. 8, in one embodiment, the first sliding piece 510 includes a first sliding piece 511 and a first fixing part 512. The first sliding piece 511 is fixedly connected with one of the first supporting plates 211. The first fixing part 512 is provided with a sliding groove 5121. The first sliding piece 511 is arranged in the sliding groove 5121 and can slide in the sliding groove 5121.

The length of the first sliding part 511 is smaller than the length of the sliding groove 5121 formed on the first fixing part 512. The length of the first sliding part 511 and the length of the sliding groove 5121 will only be described with reference to FIG. 7.

Furthermore, a baffle is provided at one end of the sliding groove 5121 away from the base pillar 110, and the baffle can limit the sliding displacement of the first fixing part in the sliding groove 5121, so as to prevent the first fixing part 512 from sliding out of the sliding groove 5121, thereby causing the electrode clamping assembly 200 to fall off.

In one embodiment, the sliding groove 5121 is a dovetail groove. The lower part of the first fixing part 512 is configured in a wedge shape adapted to the dovetail groove.

The dovetail groove is wide at the top and small at the bottom, and the groove wall of the dovetail groove has a hypotenuse structure, which simultaneously exerts inward and downward forces on the first fixing part 512, so that the sliding of the first fixing part 512 is more stable and reliable.

Referring to FIG. 7, in one embodiment, a positioning portion 513 is provided between the first sliding part 511 and one of the first supporting plates 211, the first supporting plate 211 is provided with a first waist-shaped hole 2111, the positioning portion 513 is provided with a second waist-shaped hole 5131, the first sliding part 511 is provided with a first mounting hole 5111, the first waist-shaped hole 2111 and the second waist-shaped hole 5131 are perpendicular to each other, and the overlapping portion of the first waist-shaped hole 2111 and the second waist-shaped hole 5131 overlaps the projection of the first mounting hole 5111.

By providing a first waist-shaped hole 2111 in one of the first supporting plate 211, a second waist-shaped hole 5131 in the stopper portion 154, and a first mounting hole 5111 in the first sliding part 511, an assembler can fix the first supporting plate 211, the positioning portion 513, and the first sliding part 511 only by placing a fastener (not shown in the figure) into the first waist-shaped hole 2111, the second waist-shaped hole 5131, and the first mounting hole 5111 during assembly.

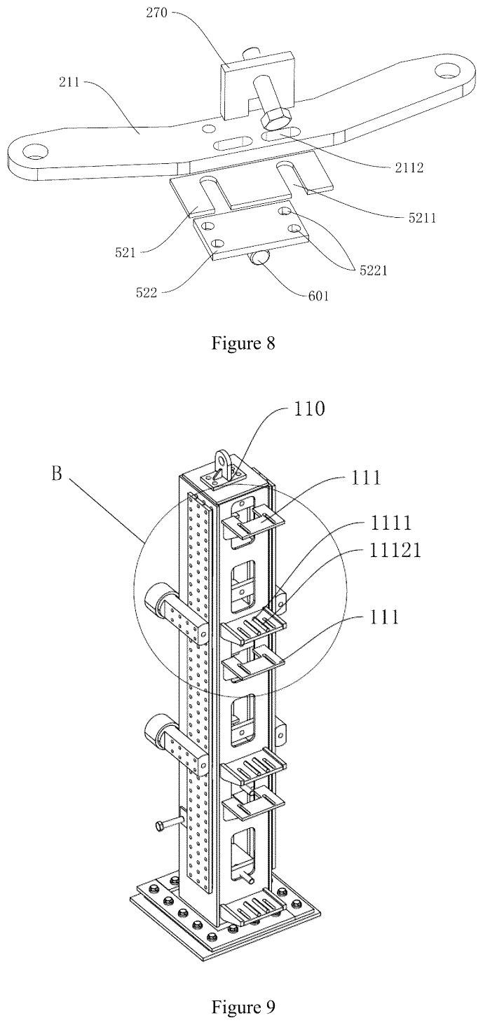

Referring to FIG. 6 and FIG. 8, in one embodiment, the second sliding piece 520 includes a second fixing part 521 fixedly connected to the other first supporting plate 211 and a second fixing part 521 fixedly connected to the second sliding part 522.

The second fixing part 521 is provided with a fourth waist-shaped hole 5211, and the second sliding part 522 is provided with a second mounting hole 5221. When assembling, an assembler can fix the other first supporting plate 211, the second fixing part 513, and the second sliding part 511 only by inserting a fastener (not shown) into the third waist-shaped hole 2112, the fourth waist-shaped hole 5211, and the second mounting hole 5221.

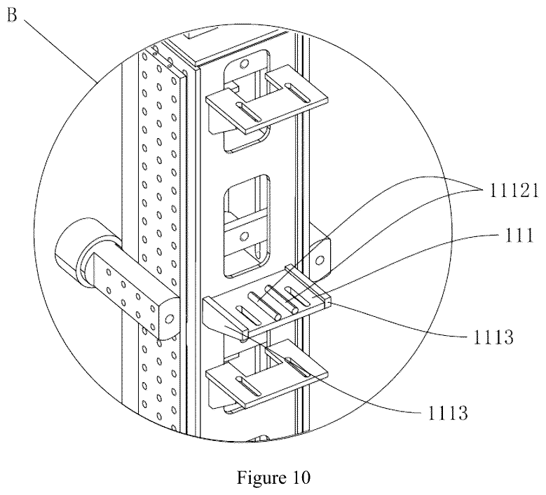

Referring to FIG. 9 and FIG. 10, in one embodiment, two supporting blocks 111 are arranged on the base pillar 110 to match each electrode clamping assembly 200, and two supporting blocks 111 are respectively arranged at the top end and the bottom end of the electrode clamping assembly 200, so as to jointly realize the supporting on the electrode clamping assembly 200, and at the same time improve the sliding stability of the electrode clamping assembly 200 on the supporting block 111, so that the clamping force of the electrode clamping assembly 200 on the conductive electrode is more uniform.

The two supporting blocks 111 are provided at intervals along the longitudinal direction of the base pillar 110. The pitch between the two supporting blocks 111 is specifically arranged according to the pitch between the first sliding piece 510 and the second sliding piece 520. Furthermore, a plurality of sets of supporting blocks 111 can be provided on the base pillar 110 for supporting the plurality of sets of electrode clamping assemblies 200, wherein, one set of supporting block 111 includes two supporting blocks 111 arranged at intervals.

Referring to FIGS. 5-10, in one embodiment, the configuration of the second sliding piece 520 is substantially the same as that of the first sliding piece 510, except that the second sliding piece 520 slides directly in cooperation with the corresponding supporting block 111.

The supporting block 111 corresponding to the second sliding piece 520 includes a plate body 1111 and a guide rail 1112 provided on the plate body 1111, wherein the width of the guide rail 1112 is arranged to be slightly larger than the width of the lower end of the second sliding piece 522. By sliding the second sliding part 522 on the guide rail 1112, the second sliding member 520 moves relative to the supporting block 111, thereby achieving a sliding effect of the entire electrode clamping assembly 200 relative to the base pillar 110.

Referring to FIGS. 8 and 10, further, a lower end of the second sliding part 522 is provided with a connecting piece 601 with a cylindrical structure, and the guide rail 1112 is composed of two guide pieces 111211 arranged in parallel, and the spacing width of the two guide pieces 111211 is arranged to be slightly larger than the width of the connecting piece 601. The second sliding piece 520 moves relative to the supporting block 111 by sliding the connecting piece 601 between the two guide pieces 111211, thereby achieving a sliding effect of the entire electrode clamping assembly 200 relative to the base pillar 110.

Referring again to FIG. 10, in one embodiment, the supporting block 111 further includes two mounting plates 1113 disposed on both sides of the plate body 1111.

The mounting plate 1113 can improve the connection strength between the supporting block 111 and the base pillar 110 thereby improving the reliability of the supporting block 111 supporting the electrode clamping assembly 200.

### Embodiment 2

Different from conventional workpieces, conductive electrodes have the characteristics of thermal expansion and cold contraction. Specifically, at 2600-3000° C., the conductive electrode will stretch in its axial direction and/or perpendicular to its axial direction when heated, and the conductive electrode will have a certain angular deviation and a certain length change compared with the initial state when it works.

Some conductive electrodes are prism-shaped, and the conductive electrodes are rotated in a small amplitude around the axial direction of the prism due to thermal expansion during the assembly of the conductive electrodes or during the power transmission of the conductive electrodes, which leads to the problem that the electrode clamping assembly 200 cannot form a stable clamping effect on the conductive electrodes or is broken due to the stress generated by the expansion of the conductive electrodes, thus affecting the production efficiency of the graphite conductive electrodes. In this way, in order to improve the stable clamping effect of the electrode clamping assembly 200 on the conductive electrode, or to avoid the problem that the production efficiency of the graphite conductive electrode is affected by breaking due to the stress caused by the expansion of the conductive electrode during the power transmission process of the conductive electrode, the present embodiment specifically adopts the following structure to solve the problem.

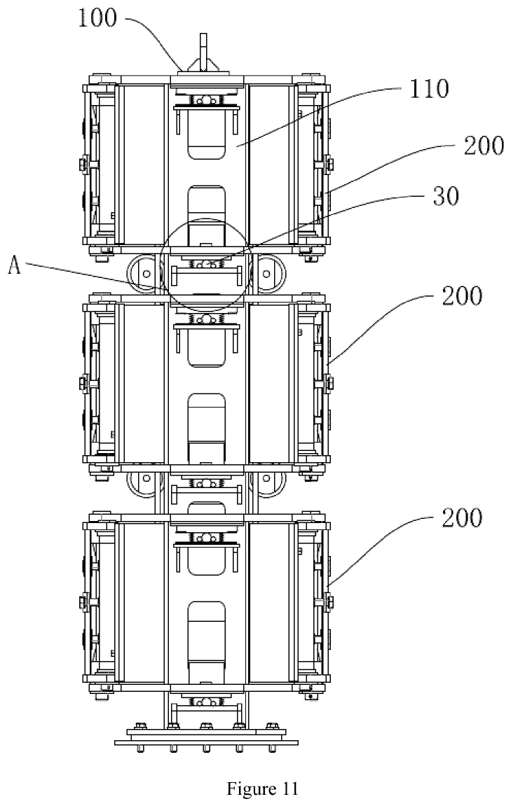

Referring to FIGS. 11-27, the electrode clamping assembly 200 is movably disposed on the strut 100.

Specifically, the strut 100 includes a base pillar 110 in the shape of a cuboid, a supporting block 111 is provided on one side of the base pillar 110 facing the conductive electrode, and an electrode clamping assembly 200 is movably arranged on the supporting block 111. The supporting block 111 is used to support the electrode clamping assembly 200.

The electrode clamping mechanism 2000 further includes a connection assembly 600, the supporting block 111 and the electrode clamping assembly 200 disposed at intervals along the height direction of the base pillar 110; the connection assembly 600 is disposed between the electrode clamping assembly 200 and the supporting block 111.

The supporting block 111 is spaced from the electrode clamping assembly 200 to provide a space for the electrode clamping assembly 200 to move. The connection assembly 600 connects the supporting block 111 and the electrode clamping assembly 200, respectively, and establishes a movable connection between the supporting block 111 and the electrode clamping assembly 200 so that the electrode clamping assembly 200 can be rotated to accommodate the problem that the position of the conductive electrode is shifted due to the rotation of the conductive electrode.

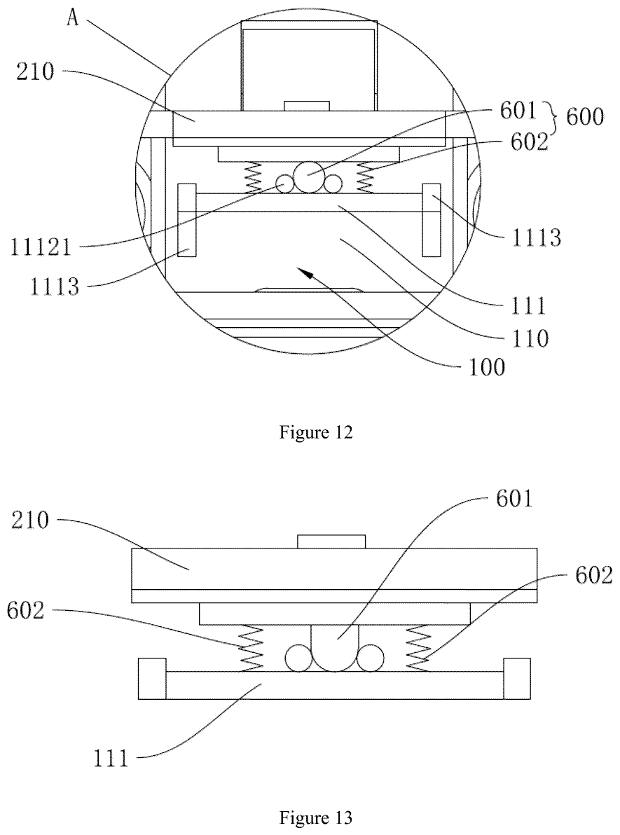

Referring to FIG. 12, in one embodiment, the connection assembly 600 includes a connecting piece 601 and a plurality of elastic pieces 602 disposed on both sides of the connecting piece 601. One end of the elastic pieces 602 is connected to the supporting block 111 and the other end is connected to the electrode clamping assembly 200.

At least one of the electrode clamping assembly 200, the supporting block 111, and the connecting piece 601 is provided with an arc portion, and the electrode clamping assembly 200 can rotate relative to the connecting piece 601 in the bending direction of the arc portion. That is, the arc portion defines the direction of movement of the electrode clamping assembly 200.

By providing a connection assembly 600 between the supporting block 111 and the electrode clamping assembly 200 and including a connecting piece 601 and an elastic piece 602, at least one of the connecting pieces 601, the electrode clamping assembly 200 and the supporting block 111 is provided with an arc portion, the electrode clamping assembly 200 can rotate in a bending direction of the arc portion with respect to the supporting block 111. That is the electrode clamping assembly 200 is movably disposed with respect to the supporting block 111. When the electrode clamping assembly 200 is butted with the prism-shaped conductive electrode, the conductive electrode is expanded and deformed by heat or the part near the electrode clamping assembly 200 is rotated around the axis of the prism during assembly, so that the electrode clamping assembly 200 is driven to rotate along the bending direction of the arc part of the connecting piece 601 to adapt to the position deviation caused by the rotation of the conductive electrode, and the electrode clamping assembly 200 is butted with the conductive electrode stably and reliably. The elastic piece 602 can give an upward elastic support force to the electrode clamping assembly 200 to limit the position of the electrode clamping assembly 200 in the unbutted state, and the electrode clamping assembly 200 is more stably and reliably butted with the conductive electrode.

Exemplarily, when the conductive electrode is axially rotated clockwise by 3 degrees, the electrode clamping assembly 200 is driven by the conductive electrode to rotate 3 degrees in a bending clockwise direction on the arc portion of the connecting piece 601. On the contrary, when the conductive electrode is axially rotated counterclockwise by 3 degrees, the electrode clamping assembly 200 is driven by the conductive electrode to rotate 3 degrees in a bending counterclockwise direction on the arc portion of the connecting piece 601.

Wherein a rotation angle of the conductive electrode with an axial direction as a rotation axis has an amplitude of −5 degrees to 5 degrees.

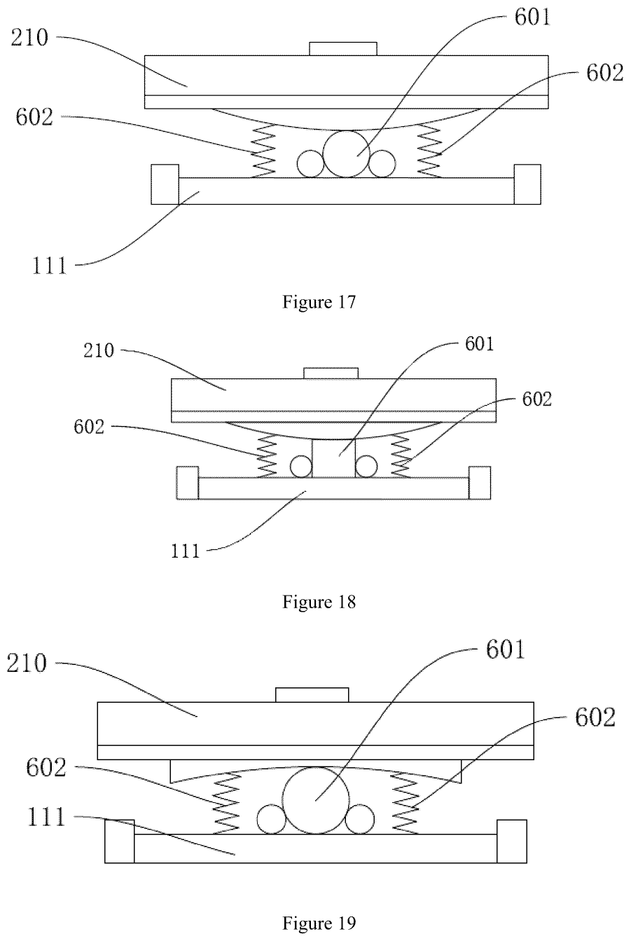

Referring to FIGS. 17, 26, and 27, in one embodiment, the electrode clamping assembly 200 includes:
The first supporting frame 210 movably arranged on the supporting block 111 through the connecting assembly 600; specifically, a connecting piece 601 is disposed between the first supporting frame 210 and the supporting block 111, and one end of the elastic piece 602 is connected to the first supporting frame 210 and the other end is connected to the supporting block 111:
Two opposite electrode clamping plates 220; wherein, the two electrode clamping plates 220 jointly realize the clamping operation of the conductive electrodes on the furnace body;

1Two first clamping arms 230 respectively hinged with both sides of the first supporting frame 210, and two electrode clamping plates 220 are respectively arranged on the two first clamping arms 230; and
The first driving member 240 disposed between the two first clamping arms 230 and connected to the two first clamping arms 230 respectively.

Two sides of the first supporting frame 210 are respectively hinged with the middle parts of two first clamping arms 230 to form two fulcrums, and the first clamping arm 230 and the first supporting frame 210 are both sheet-shaped and strip-shaped plates; the two ends of the first driving member 240 are respectively hinged at the first ends of the two first clamping arms 230, and the second ends of the two first clamping arms 230 are driven by the first driving member 240 to make opening and closing movement around the fulcrum, thereby driving the two electrode clamping plates 220 to approach or move away from each other, thus realizing clamping or loosening operation of the conductive electrodes. The first driving member 240 in the present embodiment is a hydraulic cylinder. In other embodiments, a lead screw drive, a cylinder drive, etc. may also be used, which will not be described herein again.

By providing the connection assembly 600, the first supporting frame 210 is rotated in the bending direction of the arc portion by the elastic support action of the connection assembly 600, thereby driving the entire electrode clamping assembly 200 to rotate in the bending direction of the arc portion.

Further the first clamping arm 230 includes two first clamping arms 231 each hinged at a fulcrum of the first supporting frame 210; one end of the two first clamping arms 231 is fixed together by a connecting rod 232, and the other end of the two first clamping arms 231 is fixed together by a first fixing plate 233. Two ends of the first driving member 240 are respectively connected with the connecting rod 232, and the first driving member 240 drives the two first clamping arms 231 to move together by driving the connecting rod 232 to move, thus realizing the operation effect of driving the electrode clamping plate 220 to clamp or release the conductive electrode.

The first clamping arm 230 is provided with a first limit plate 234 near the connecting rod 232, and two ends of the first limit plate 234 are respectively connected with two first clamping arms 231, thereby enhancing the structural stability of the first clamping arm 230.

The first supporting frame 210 is provided with two first support plates 211 arranged in parallel, and both ends of each first support plate 211 are hinged with a first clamping arm 231 on a corresponding side through a first rotary shaft 250, which forms a fulcrum as described above.

Each electrode clamping plate 220 is hinged to an end of the first clamping arm 231 on a corresponding side through a second rotary shaft 260 and can be swung around the second rotary shaft 260.

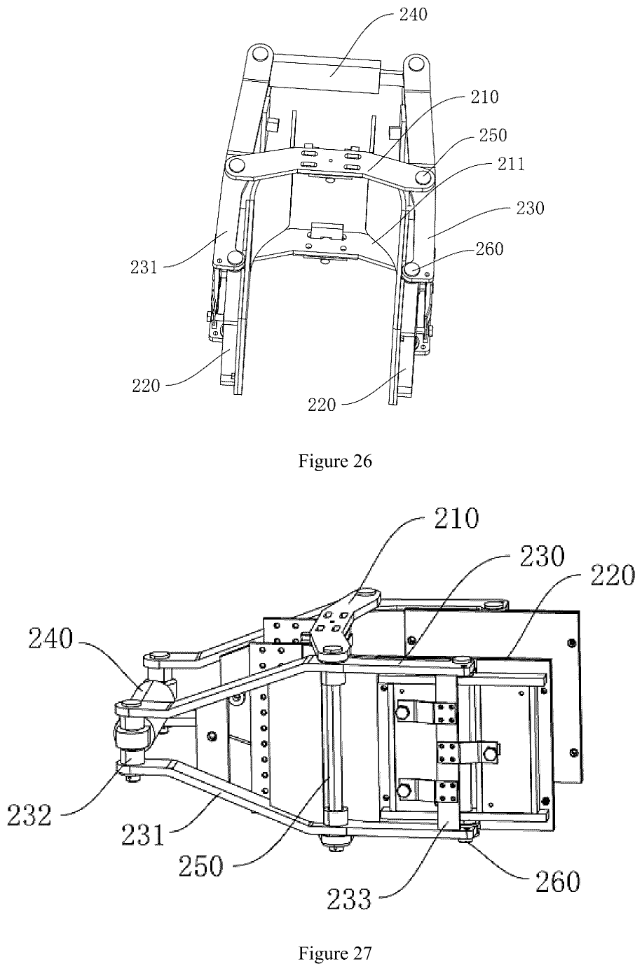

Referring to FIG. 17 and FIG. 26 again, in one embodiment, the first supporting frame 210 includes two first supporting plates 211 arranged in parallel, the upper and lower ends of the first rotary shaft 250 are respectively connected with the two first support plates 211, and the connecting piece 601 is arranged between the first support plate 211 and the supporting block 111: one end of the elastic piece 602 is connected to the first support plate 211 and the other end of the elastic piece 602 is connected to the supporting block 111.

Specifically, the first support plate 211 is provided on the circular are portion of the connecting piece 601, and the elastic piece 602 abuts against the bottom surface of the first support plate 211 so that the electrode clamping assembly 200 remains horizontal on the connecting piece 601.

When the electrode clamping assembly 200 and the conductive electrode are not butted, the elastic piece 602 can give the upward elastic support force to the electrode clamping assembly 200 to limit the position of the electrode clamping assembly 200, and the butting of the electrode clamping assembly 200 and the conductive electrode is more stable and reliable. When the conductive electrode is axially deflected in the state where the electrode clamping assembly 200 is butted with the conductive electrode, the length of the elastic piece 602 can be changed by pressure, and the conductive electrode can be rotated.

The elastic piece 602 is an integral part of the connection assembly 600. In the case where the elastic piece 602 is absent or the elastic piece 602 is present only on one side of the connecting piece 601, the electrode clamping assembly 200 is deflected toward the side where the elastic piece 602 is absent, thereby increasing the difficulty of butting with the conductive electrode, or even making butting impossible.

Specifically, the elastic piece 602 is a spring, and two springs are symmetrically arranged on both sides of the connecting piece 601. The model number, lot number and manufacturer of the two springs should be kept as identical as possible to ensure that the same elastic force is provided on both sides of the connecting piece 601 to the greatest extent. The spring has the advantages of low use cost, long service life and strong practicability.

Alternatively, the elastic piece 602 may also be a combination of a rigid body and an elastic body such as spring post. Exemplarily, the spring post includes a sleeve, a spring, and a post, the post being sleeved in the sleeve, and the bottom of the sleeve is connected with the spring. The post is rigid and can provide supporting force, while the spring is used to provide elastic force.

Referring to FIGS. 12 to 24, the shapes of the first support plate 211, the connecting piece 601 and the supporting block 111 and the positions, orientations and numbers of the arc portions will be described in detail below.

Referring to FIGS. 12 to 16, in one embodiment, an arc portion is provided on the connecting piece 601, and the first support plate 211 and/or the supporting block 111 are in contact with the connecting piece 601 through the arc portion and can rotate in a bending direction of the arc portion of the connecting piece 601.

Referring to FIG. 12, specifically the connecting piece 601 is a cylindrical body and both the supporting block 111 and the first support plate 211 are flat plates. The cylinder has upper and lower are portions, the supporting block 111 is in contact with the connecting piece 601 through one of the arc portions, and the first support plate 211 is in contact with the connecting piece 601 through the other arc portion. That is, the connecting piece 601 is provided with two circular are portions, the first support plate 211 is rotated relative to the connecting piece 601 through one of the circular arc portions, and the supporting block 111 is rotated relative to the connecting piece 601 through the other circular are portion.

The embodiment of FIGS. 13 to 16 only provides an arc portion on the connecting piece 601.

Referring to FIG. 13, specifically both the supporting block 111 and the first support plate 211 are flat plates. The connecting piece 601 is a combination of a semi-cylinder and a cube, and an are portion of the connecting piece 601 is disposed toward the supporting block 111 and bent toward the supporting block 111. That is, the connecting piece 601 is in contact with the supporting block 111 through the circular are portion, and the connecting piece 601 can rotate relative to the supporting block 111 in the bending direction of the circular arc portion, thereby realizing relative rotation of the first supporting plate 211 relative to the supporting block 111.

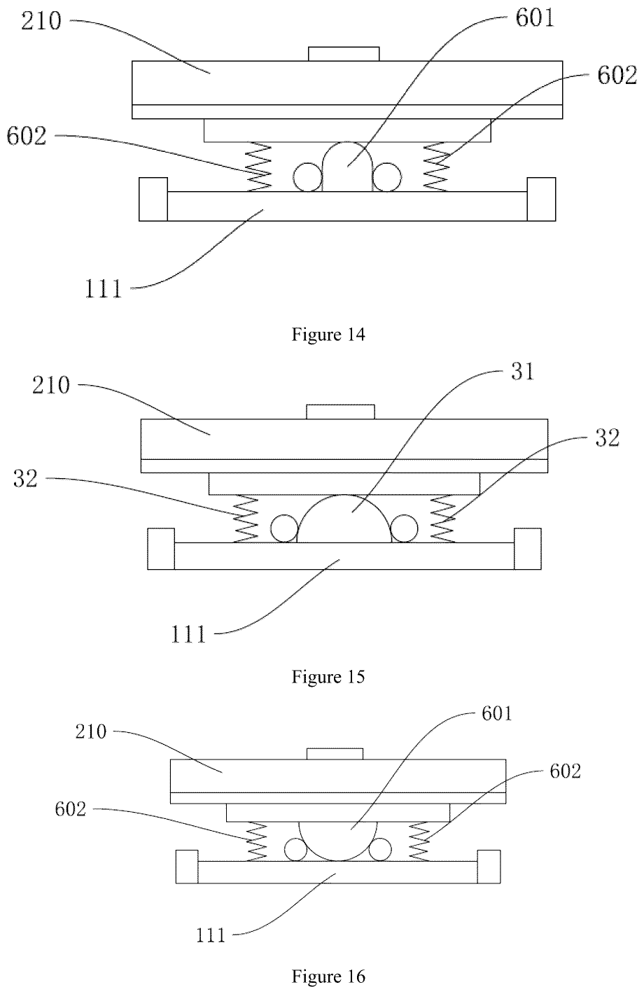

Referring to FIG. 14, as an alternative to the above-described embodiment, the supporting block 111 and the first support plate 211 are both flat plates. The connecting piece 601 is a combination of a semi-cylinder and a cube, and an arc portion of the connecting piece 601 is disposed toward the first support plate 211 and curved toward the first support plate 211. That is, the connecting piece 601 is in contact with the first support plate 211 through an are portion, and the connecting piece 601 can rotate relative to the first support plate 211 in the bending direction of the arc portion, thereby realizing rotation of the first support plate 211 relative to the supporting block 111.

Referring to FIG. 15, as an alternative to the above-described embodiment, the supporting block 111 and the first support plate 211 are both flat plates. The connecting piece 601 is a semi-cylinder whose are portion is disposed toward the first support plate 211. That is, the connecting piece 601 is in contact with the supporting block 111 through the circular arc portion, and the connecting piece 601 can rotate relative to the supporting block 111 in the bending direction of the circular are portion. thereby realizing rotation of the first supporting plate 211 relative to the supporting block 111.

Referring to FIG. 16, as an alternative to the above-described embodiment, the supporting block 111 and the first support plate 211 are both flat plates; the connecting piece 601 is a semi-cylinder whose are portion is disposed toward the supporting block 111. An arc portion of the connecting piece 601 is disposed toward the supporting block 111. That is the connecting piece 601 is in contact with the supporting block 111 through the arc portion and can rotate relative to the supporting block 111 in the bending direction of the arc portion thereby realizing rotation of the first supporting plate 211 relative to the supporting block 111.

Referring to FIGS. 17-20, in some embodiments of the present application, an arc portion is provided on the first support plate 211. The first support plate 211 is in contact with the connecting piece 601 through an arc portion.

Referring to FIG. 17, specifically the connecting piece 601 is a cylinder and the first transmission support piece 12 is a flat plate. A side of the first support plate 211 facing the connecting piece 601 is provided with an arc portion and the arc portion is bent toward the connecting piece 601. The first support plate 211 is in contact with the connecting piece 601 through an arc portion and can rotate in the bending direction of the are portion relative to the connecting piece 601, so that the first support plate 211 rotates relative to the support block 111.

Referring to FIG. 18, as an alternative to the above-described embodiment, the connecting piece 601 is a cuboid and the first transfer support 12 is a flat plate. A side of the first support plate 211 facing the connecting piece 601 is provided with an arc portion that is bent toward the connecting piece 601. The first support plate 211 is in contact with the connecting piece 601 through an arc portion, and the first support plate 211 is rotated relative to the connecting piece 601 in the bending direction of the arc portion, thereby realizing rotation of the first support plate 211 relative to the supporting block 111.

Referring to FIG. 19, as an alternative to the above-described embodiment, the connecting piece 601 is a cylinder having two arc portions and the first transmission support 12 is in a flat plate shape. A side of the first support plate 211 facing the connecting piece 601 is provided with an are portion that is bent away from the connecting piece 601. The first support plate 211 is in contact with the connecting piece 601 through an arc portion and can rotate in the bending direction of the arc portion relative to the connecting piece 601 thereby realizing rotation of the first support plate 211 relative to the supporting block 111.

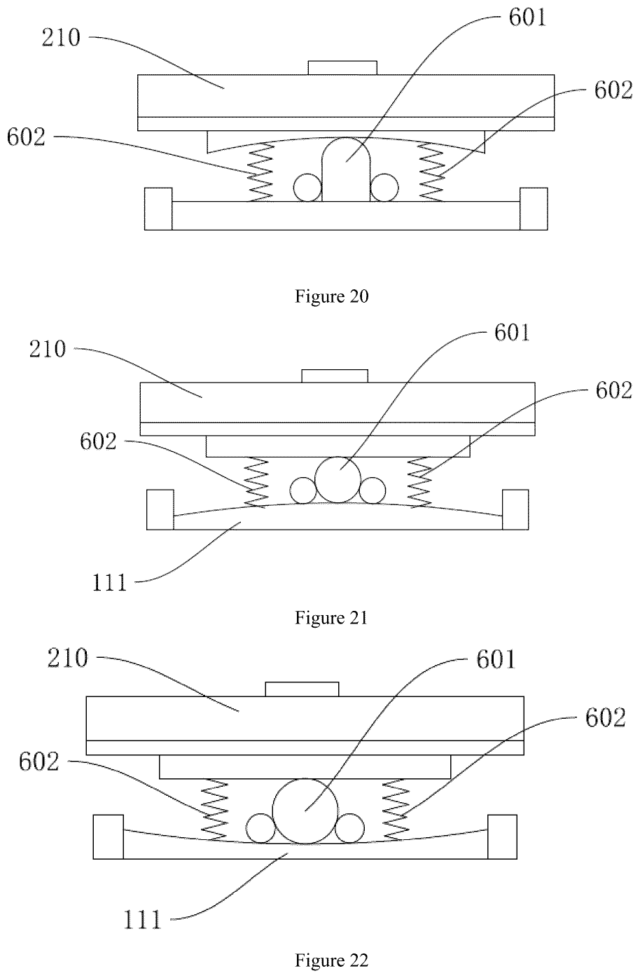

Referring to FIG. 20, as an alternative to the above-mentioned embodiment, the connecting piece 601 is a combination of a semi-cylinder having an arc portion and a cube, the semi-cylinder disposed toward the first support plate 211, and the first transmission support 12 having a flat plate shape. The circular are portion is provided on the first support plate 211 and bent away from the connecting piece 601. The first support plate 211 is in contact with the connecting piece 601 through an arc portion and can rotate in the bending direction of the arc portion with respect to the connecting piece 601 thereby realizing relative rotation of the first support plate 211 with respect to the supporting block 111.

Referring to FIGS. 21-24, in some embodiments of the present application, a circular arc portion is provided on the supporting block 111. The supporting block 111 is in contact with the connecting piece 601 through an arc portion.

Referring to FIG. 21, specifically the first support plate 211 is flat plate and the connecting piece 601 is a cylinder having two arc portions. A side of the supporting block 111 facing the connecting piece 601 is provided with an arc portion that is bent toward the connecting piece 601. The supporting block 111 is in contact with the connecting piece 601 through the circular arc portion and can rotate along the bending direction of the circular arc portion relative to the connecting piece 601 thereby realizing relative rotation of the first support plate 211 with respect to the supporting block 111.

Referring to FIG. 22, as an alternative to the above-described embodiment, the first support plate 211 is a flat plate e and the connecting piece 601 is a cylinder having two circular arc portions. A side of the supporting block 111 facing the connecting piece 601 is provided with an are portion that is bent away from the connecting piece 601. The supporting block 111 is in contact with the connecting piece 601 through the circular are portion and can rotate along the bending direction of the circular are portion with respect to the connecting piece 601 thereby realizing rotation of the first support plate 211 with respect to the supporting block 111.

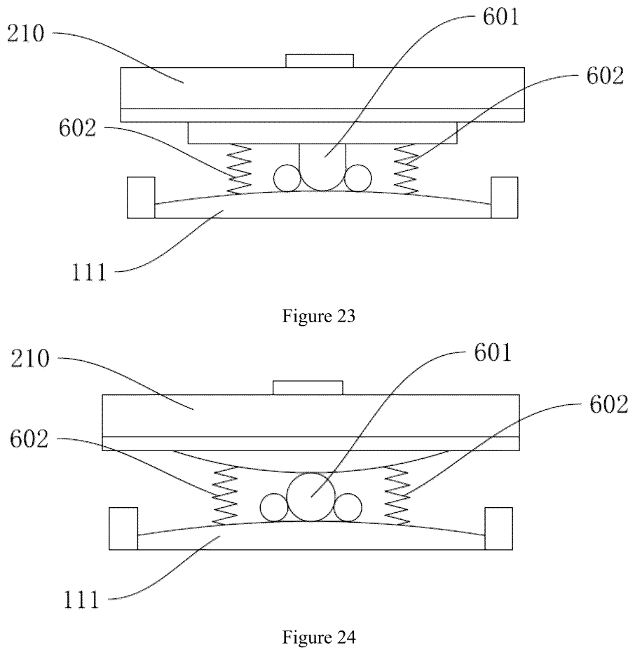

Referring to FIG. 23, as an alternative to the above-described embodiment, the first support plate 211 is in a flat plate shape. The connecting piece 601 is a combination of a cube and a semi-cylinder having an arc portion. A side of the supporting block 111 facing the connecting piece 601 is provided with an arc portion that is bent toward the connecting piece 601. The supporting block 111 is in contact with the connecting piece 601 through the circular arc portion and can rotate in the bending direction of the circular are portion with respect to the connecting piece 601 thereby realizing relative rotation of the first support plate 211 relative to the supporting block 111.

Referring to FIG. 24, as an alternative to the above-described embodiment, the first support plate 211 is provided with an arc portion disposed toward and bent toward the connecting piece 601. The connecting piece 601 is a cylinder having two arc portions. A side of the first support member facing the connecting piece 601 is provided with an arc portion that is bent toward the connecting piece 601. The supporting block 111 is in contact with an arc portion of the connecting piece 601 through the arc portion, and the first support plate 211 is in contact with the are portion of the connecting piece 601 through the arc portion, so that the first support plate 211 rotates relative to the supporting block 111.

The positions, orientations and the number of the partial circular arc portions are merely exemplarily given above, and only the shapes of the partial supporting blocks 111, the connecting piece 601 and the first support plate 211 are given. Other implementations capable of relatively rotating the first support plate 211 relative to the supporting blocks 111 also belong to the scope of protection of the present application.

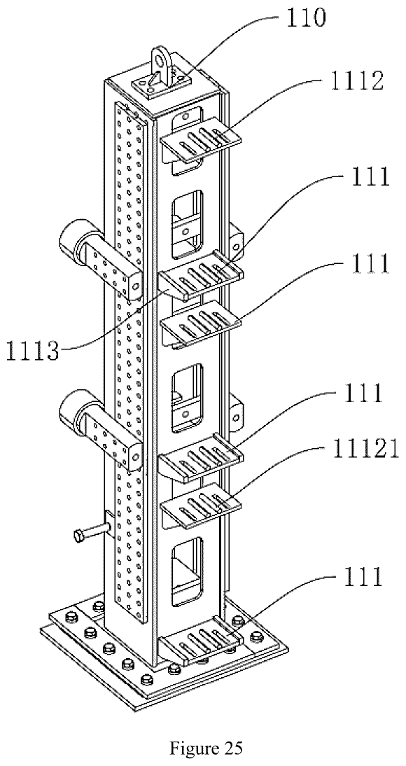

Referring again to FIG. 25, in one embodiment, the supporting block 111 is provided with two guiding members 11121 arranged parallel to each other at intervals, and the connecting piece 601 is disposed between the two guiding members 11121.

The guiding member 11121 acts as a stop for limiting the position of the connecting piece 601 and preventing the connecting piece 601 from deviating from or even rolling out of the supporting block 111 under the action of an external force. thereby achieving stable and reliable performance.

In one embodiment, the guiding member 11121 is cylindrical and the connecting piece 601 is cylindrical, and the radius of the end surface of the guiding member 11121 is smaller than the radius of the end surface of the connecting piece 601. That is the height of the guiding member 11121 is smaller than the height of the connecting piece 601. Furthermore, the connecting piece 601 has only one contact point with each guiding member 11121, thereby reducing the friction force generated when the connecting piece 601 rotates and making the rotation smoother.

The guiding member 11121 being plate-shaped and cylindrical is a conventional arrangement in the art.

In one embodiment, the two guiding members 11121 together constitute a guide rail 1112, and the connecting piece 601 is disposed within the guide rail 1112 and can slide within the guide rail 1112; the sliding degree of the connecting piece 601 can be adjusted according to the extended length of the conductive electrode due to thermal expansion and deformation. thereby further improving the self-adaptability of the electrode clamping assembly 200 and having strong practicability; that is, the connecting piece 601 is slidable with the supporting block 111 and fixedly connected to the first supporting plate 211 (see FIG. 26). The specific description is roughly the same as the mating structure of the second sliding member 520 and the corresponding supporting block 111 mentioned in embodiment 1, and is not repeated herein.

Of course, the connecting piece 601 may be configured to be fixedly connected to the supporting block 111 and movably connected to the first support plate 211. Although the adaptive function is lost in this way, the connection stability between the connecting piece 601 and the supporting block 111 can be improved.

Referring to FIG. 25, in one embodiment, mounting plates 1113 are provided on both sides of the supporting block 111.

The supporting block 111 needs to fully bear the weight of the electrode clamping assembly 200 and additional fixing means need to be added. The mounting plates 1113 are arranged at intervals on the base pillars 110 and are mounted on both sides of the supporting block 111, so that not only one side surface of the supporting block 111 is directly connected with the base pillars 110, but also two side surfaces are indirectly connected with the base pillars 110 through the mounting plates 1113. thereby greatly improving the load-bearing capacity of the supporting block 111.

Referring to FIG. 25 again, in one embodiment, two supporting blocks 111 are arranged on the base pillar 110 to match each electrode clamping assembly 200, and the two supporting blocks 111 are respectively arranged at the top end and the bottom end of the electrode clamping assembly 200, so as to jointly realize the supporting effect on the electrode clamping assembly 200, improve the sliding stability of the electrode clamping assembly 200 on the supporting blocks 111, and make the force on the electrode clamping assembly 200 more uniform.

The two supporting blocks 111 are provided at intervals along the longitudinal direction of the base pillar 110. By providing two supporting blocks 111 on the side surface of the base pillar 110 matching each electrode clamping assembly 200, the total load-bearing capacity of the supporting blocks 111 and the uniformity of the force exerted by the electrode clamping assembly 200 are effectively improved.

The distance between the two supporting blocks 111 is arranged equal to the distance between the two first support plates 211. When the upper supporting block 111 is in indirect contact with the first support plate 211 through the connection assembly 600, the lower supporting block 111 is also in indirect contact with the first support plate 211 through the connection assembly 600.

There are usually twelve conductive electrodes on one side of an Acheson graphite furnace, three for each column and four for each row. In order to adapt to the twelve conductive electrodes, in a specific embodiment, referring to FIG. 1, four conductive electrode clamping mechanisms 2000 are arranged side by side, referring to FIG. 13, and three electrode clamping assemblies 200 are arranged on each conductive electrode clamping mechanism 2000.

Of course, the number of conductive electrode clamping mechanisms 2000 and the electrode clamping assembly 200 of each conductive electrode clamping mechanism 2000 can be adaptively arranged according to the number and arrangement of conductive electrodes, and are not limited to the specific limitations of the present application.

### Embodiment 3

Different from conventional workpieces, in order to ensure stable bonding with conductive electrodes, the electrode clamping assembly 200 is generally designed as a movable electrode clamping plate 220, which will lead to uncertainty in the initial clamping angle of the electrode clamping plate 220. When the electrode clamping plate 220 is close to the conductive electrode, the opening width of the electrode clamping plate 220 is too small or too large. When the opening width of the electrode clamping plate 220 is too small, the conductive electrode cannot enter the opening of the clamping structure, resulting in damage to the conductive electrode; when the opening width of the electrode clamp 220 is too large, the conductive electrode enters the opening of the clamp structure, and the clamp structure cannot clamp the conductive electrode, thus affecting the conduction effect of current. Thus, in order to avoid the problem that the electrode clamping plate 220 hold the conductive electrodes unstably due to the fact that the openings between the electrode clamping plate 220 are not suitable for the conductive electrodes, the present embodiment specifically adopts the following configuration to solve the problem.

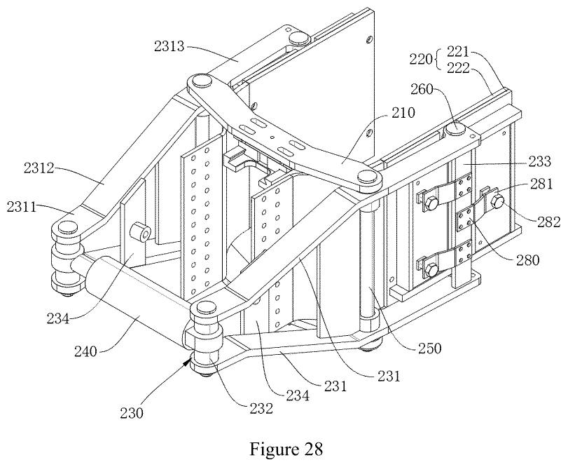

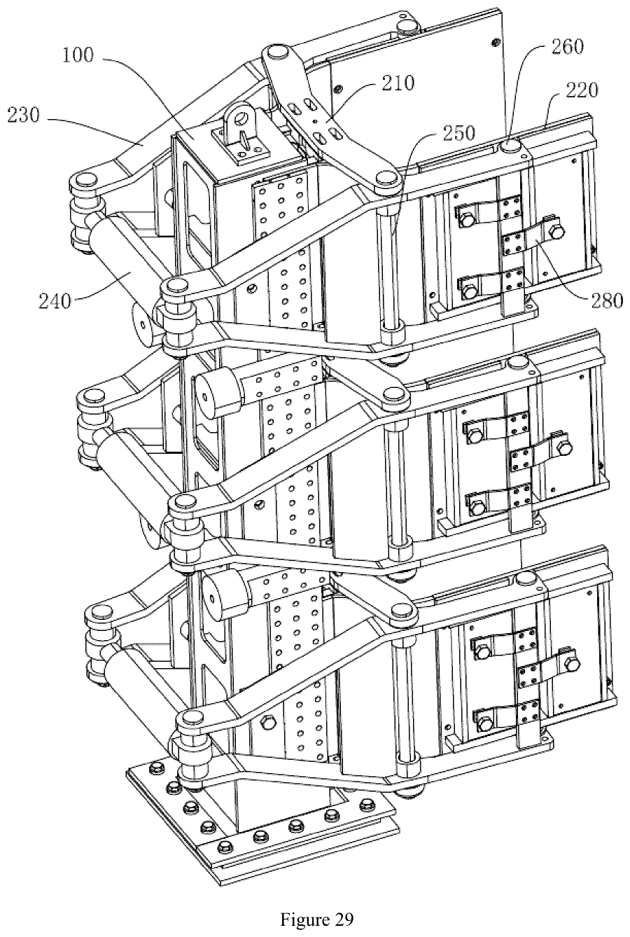

Referring to FIGS. 28 and 29, the electrode clamping assembly 200 includes:
A first supporting frame 210 for being disposed on the strut 100;
Two opposite electrode clamping plates 220; wherein, the two electrode clamping plates 220 jointly realize the clamping operation of the conductive electrodes on the furnace body;
Two first clamping arms 230 respectively hinged with both sides of the first supporting frame 210, and two electrode clamping plates 220 respectively arranged on the two first clamping arms 230; and
The first driving member 240 disposed between the two first clamping arms 230 and connected to the two first clamping arms 230 respectively.

Two sides of the first supporting frame 210 are respectively hinged with the middle parts of two first clamping arms 230 to form two fulcrums, and the first clamping arm 230 and the first supporting frame 210 are both sheet-shaped and elongated plates; the two ends of the first driving member 240 are respectively articulated at the first ends of the two first clamping arms 230, and the second ends of the two first clamping arms 230 are driven by the first driving member 240 to make opening and closing movement around the fulcrum, thereby driving the two electrode clamping plates 220 to approach or move away from each other, thus realizing clamping or loosening operation of the conductive electrodes. Hydraulic cylinder is selected as the first driving member 240 in this embodiment. Of course, in other embodiments a lead screw drive, a cylinder drive, etc. may also be used, which will not be described herein again.

Both sides of the first supporting frame 210 are respectively hinged with the first clamping arm 230 on the corresponding side through a first rotary shaft 250 which forms the fulcrum as described above.

Each electrode clamping plate 220 is hinged to an end of the first clamping arm 230 on a corresponding side through a second rotary shaft 260 about which the electrode clamping plate 220 can be provided so as to swing: specifically, when the first driving member 240 drives the first clamping arm 230 to approach each other, the electrode clamping plate 220 on the first clamping arm 230 will gradually approach the conductive electrode, and the electrode clamping plate 220 will rotate around the second rotary shaft 260 to self-adjust according to actual needs to ensure the adhesion to conductive electrode, so as to maximize the contact area between the electrode clamping plate 220 and the conductive electrode, and further improve the electrical conduction efficiency.

In one embodiment, at least one first clamping arm 230 is provided with at least one first elastomer 280, the first elastomer 280 is a spring plate structure, bending and extending a stopper portion 281 which is abutted against one side of the electrode clamping plate 220, and the stopper portion 281 is used for limiting the initial installation angle of the electrode clamping plate 220, so as to be suitable for setting the width of the conductive electrode; in other embodiments, at least one first elastomer 280 may be provided on each of the first clamping arms 230 as required.

When only one first elastomer 280 is arranged near one end of the electrode clamping plate 220 facing the conductive electrode, the electrode clamping assembly 200 clamps the conductive electrode, wherein the electrode clamping plate 220 on one side of the first clamping arm 230 moves in the direction of pressing the first elastomer 280, while the electrode clamping plate 220 on the other side of the first clamping arm 230 without the first elastomer 280 rotates around the second rotary shaft 260 to match the surface of the conductive electrode, thereby maximizing the contact area between the electrode clamping plate 220 and the conductive electrode and further improving the electrical conduction efficiency.

In one embodiment, when at least two first elastomers 280 are arranged on the first clamping arm 230, and the limiting portions 281 of the at least two first elastomers 280 are respectively arranged on both sides of the second rotary shaft 260, so as to ensure that the electrode clamping plate 220 will be counteracted by the limiting portions 281 on the corresponding side regardless of forward rotation or reverse rotation with the second rotary shaft 260 as the axis, thus ensuring that the opening corresponding to the initial mounting angle of the electrode clamping plate 220 on the first clamping arm 230 is suitable for the width of the conductive electrode. Before the electrode clamping plate 220 clamps the conductive electrode, the opening width between the electrode clamping plates 220 can adapt to the size of the conductive electrode; when the electrode clamping plate 220 clamps the conductive electrode, the electrode clamping plate 220 can also form a stable bonding relationship with the conductive electrode and ensure a contact area between the electrode clamping plate 220 and the conductive electrode.

In one embodiment, the first clamping arm 230 is provided with a first fixing plate 233, the first elastomer 280 is arranged on the first fixing plate 233 at intervals, and the limiting portions 281 on both sides of the first fixing plate 233 are respectively arranged on both sides of the second rotary shaft 260, so as to ensure that the electrode clamping plate 220 will be supported by the limiting portions 281 on the corresponding side regardless of forward rotation or reverse rotation with the second rotary shaft 260 as the axis, and further ensure that the opening corresponding to the initial mounting angle of the electrode clamping plate 220 on the first clamping arm 230 is suitable for the width of the conductive electrode. Before the electrode clamping plate 220 clamps the conductive electrode, the opening width between the electrode clamping plates 220 can adapt to the size of the conductive electrode; when the electrode clamping plate 220 clamps the conductive electrode, the electrode clamping plate 220 can also form a stable bonding relationship with the conductive electrode and ensure a contact area between the electrode clamping plate 220 and the conductive electrode.

In other embodiments, the first elastomer 280 is disposed on the first clamping arm 230 to match both ends of the electrode clamping plate 220, respectively limiting both ends of the electrode clamping plate 220, thereby limiting the initial mounting angle of the electrode clamping plate 220 to meet the width requirements of the conductive electrodes.

In one embodiment, a fixing hole is provided on the first fixing plate 233, and one end of the first elastomer 280 is fixed on the first fixing plate 233 through a screw member, and the screw member passes through one end of the first elastomer 280 and is clamped in the fixing hole.

In one embodiment, the stopper portion 281 is provided with a screw hole, and a first limiting bolt 282 is arranged in the screw hole, the first limiting bolt 282 is clamped in the screw hole, and one end of the first limiting bolt 282 abuts against one side of the electrode clamping plate 220. The initial installation angle of the electrode clamping plate 220 is adjusted by adjusting the length of a screw hole extending from one end of the first limiting bolt 282, so as to adapt to conductive electrodes of different sizes.

In one embodiment, a buffer block 401 protrudes from one side of the electrode clamping plate 220 facing the position limiting portion 281, and the buffer block 401 abuts against the position limiting portion 281 so as to increase the contact area of the position limiting portion 281 against the electrode clamping plate 220, thereby preventing the electrode clamping plate 220 from being damaged due to excessive pressure of the position limiting portion 281 against the electrode clamping plate 220; in this embodiment, the buffer block 401 abut against one end of the first limit bolt 282, thereby increasing the contact area between the first limiting bolt 282 and the electrode clamping plate 220, and avoiding damage to the electrode clamping plate 220 caused by excessive pressure of the first limit bolt 282 on the electrode clamping plate 220.

In one embodiment, the first driving member 240 is arranged at one end of the first clamping arm 230 far away from the electrode clamping plate 220, or may be arranged at one end of the first clamping arm 230 close to the electrode clamping plate 220 as required. By driving the first clamping arm 230 to rotate around the first rotary shaft 250, the electrode clamping plate 220 is driven to approach or move away from each other, and the clamping or loosening operation of the external conductive electrode is completed.

Specifically, the distance between the first driving member 240 and the first rotary shaft 250 is larger than the distance between the first rotary shaft 250 and the second rotary shaft 260. In this embodiment, the ratio of the two distances is (1.4 to 1.6): 1, so that the first driving member 240 can provide a smaller acting force and the electrode clamping plate 220 can generate a larger clamping force on the graphite electrode by using the lever principle: in addition, the electrode clamping plate 220 and the first driving member 240 are respectively arranged at both ends of the first clamping arm 230, and the first driving member 240 is matched to drive the first clamping arm 230 to rotate with the first rotary shaft 250 as the axis center. so that the first driving member 240 is arranged away from the electrode clamping plate 220, so that after the electrode clamping plate 220 clamps the conductive electrode, the first driving member 240 is far away from the heat source generated by the conductive electrode, and avoid the service life of the first driving member 240 is shortened for being too close to the heat generated by the conductive electrode to the first driving member 240.

In one embodiment, the electrode clamping plate 220 includes a first clamping plate 221 and a first conductive plate 222, and a second rotary shaft 260 is arranged through the first conductive plate 222, and the first conductive plate 222 can rotate around the second rotary shaft 260; the first conductive plate 222 is fixed on the first clamping plate 221, and the buffer block 401 is formed by the first clamping plate 221 protruding toward the side of limiting portion 281. The first conductive plate 222 is a copper soft tape structure, which is convenient for the first conductive plate 222 to form a limiting effect on the first clamping plate 221 by using the flexibility of the first conductive plate 222 after bending and extending out of the first clamping plate 221, and also effectively improves the stability of the initial installation angle of the electrode clamping plate 220.

In one embodiment, the first clamping arm 230 is hollowed out near the first fixing plate 233 to facilitate the first elastomer 280 to limit the initial mounting angle of the electrode clamp 220; one end of the first clamping arm 230 close to the first driving member 240 is arranged in a V-shaped configuration, so that sufficient space is conveniently left between two adjacent electrode clamping assemblies 200 on the strut 100 for other mechanisms to install and arrange; specifically, a first conductive block is mounted between two adjacent electrode clamping assemblies 200 on the strut 100, and one end of the first conductive block is connected to the aluminum row clamping mechanism 3000 through a connecting cable.

Specifically, the first clamping arm 230 includes two first clamping arms 231 each articulated at a fulcrum of the first supporting frame 210; one end of the two first clamping arms 231 is fixed together by a connecting rod 232, and the other end of the two first clamping arms 231 is fixed together by a first fixing plate 233. Two ends of the first driving member 240 are respectively connected with the connecting rod 232, and the first driving member 240 drives the two first clamping arms 231 to move together by driving the connecting rod 232 to move, thus realizing the operation of driving the electrode clamping plate 220 to clamp or release the conductive electrode.

Further, the first clamping arm 231 includes an integrally formed connecting part 2311, a bent part 2312 and a clamping part 2313, the two connecting parts 2311 are arranged in parallel, the two ends of the connecting rod 232 are respectively fixed on the two connecting parts 2311, and the bent parts 2312 of the two first clamping arms 231 are combined into a V-shaped structure, so that sufficient space is conveniently left between two adjacent electrode clamping assemblies 200 on the strut 100 for external mechanisms such as the first conductive block to install and set; the clamping portions 2313 of the two first clamping arms 231 on the same side are arranged in parallel, and the electrode clamping plate 220 is arranged on the side corresponding to the clamping portion 2313. The first driving member 240 drives the connecting rod 232 to move, and then drives the two first clamping arms 231 on the same side to move together, thus realizing the operation of driving the electrode clamping plate 220 to clamp or release the conductive electrode.

The first clamping arm 230 is provided with a first limit plate 234 near the connecting rod 232, and two ends of the first limit plate 234 are respectively connected with two first clamping arms 231, thereby enhancing the structural stability of the first clamping arm 230.

The first supporting frame 210 is provided with two first support plates 211 arranged in parallel, and both ends of each first support plate 211 are hinged with a first clamping arm 231 on a corresponding side through a first rotary shaft 250.

During the specific assembly of the present utility model, the initial mounting angle of the electrode clamping plate 220 is designed according to the size of the conductive electrode to be clamped. After the electrode clamping plate 220 is fixed on the first clamping arm 230, a suitable first elastomer 280 is selected to be installed and fixed on the first fixing plate 233 to limit one side of the electrode clamping plate 220 or the extension length of the first limiting bolt 282 arranged on the first elastomer 280 towards the electrode clamping plate 220 is directly adjusted to complete the setting of the initial mounting angle of the electrode clamping plate 220. When the electrode clamping plate 220 does not clamp the conductive electrode. the limiting force of the first elastomer 280 on the electrode clamping plate 220 cannot allow the stopper portion 281 to be displaced; when the first driving member 240 drives the first clamping arm 230 to clamp the conductive electrode, the electrode clamping plate 220 produces a small rotation angle in order to increase the contact area with the conductive electrode. Since the clamping force of the electrode clamping plate 220 on the conductive electrode is large, the electrode clamping plate 220 exerts a large force on the first elastomer 280, so that the limiting portion 281 moves towards the direction of the force of the electrode clamping plate 220, thereby completing the angle adjustment when the electrode clamping plate 220 clamps the conductive electrode.

### Embodiment 4

Different from conventional workpieces, after the electrode clamping assembly 200 of the power transmission vehicle device butts with the conductive electrode of the current furnace body and completes the graphitization process of the conductive electrode, it is necessary to shift the power transmission vehicle device to the conductive electrode of the next furnace body. Because of the difference in the initial installation angle of the conductive electrodes of different furnaces, the electrode clamping assembly 200 of the power transmission vehicle device cannot normally clamp the conductive electrode of the next furnace body, thus affecting the butting effect between the electrode clamping assembly 200 and the conductive electrode. Thus, in order to limit the orientation of the opening of the electrode clamping assembly 200 and improve the stability of butting the electrode clamping assembly 200 with the conductive electrode, the present embodiment specifically adopts the following configuration to solve the problem.

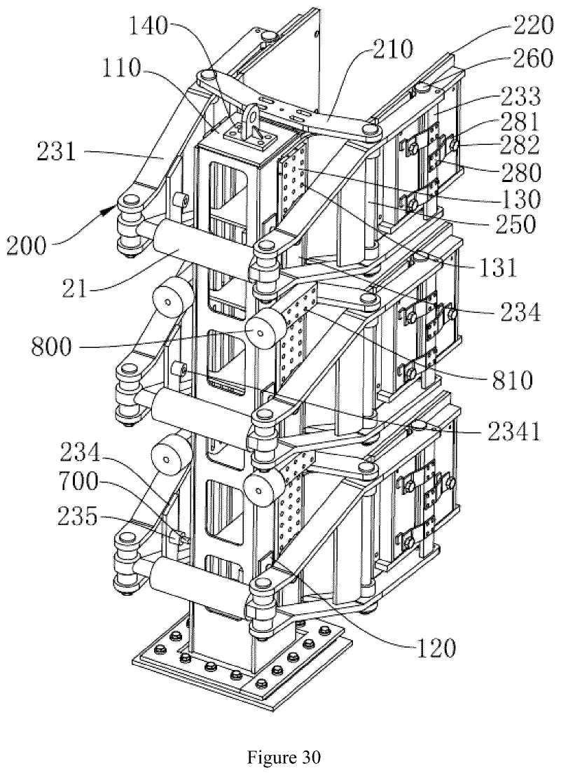

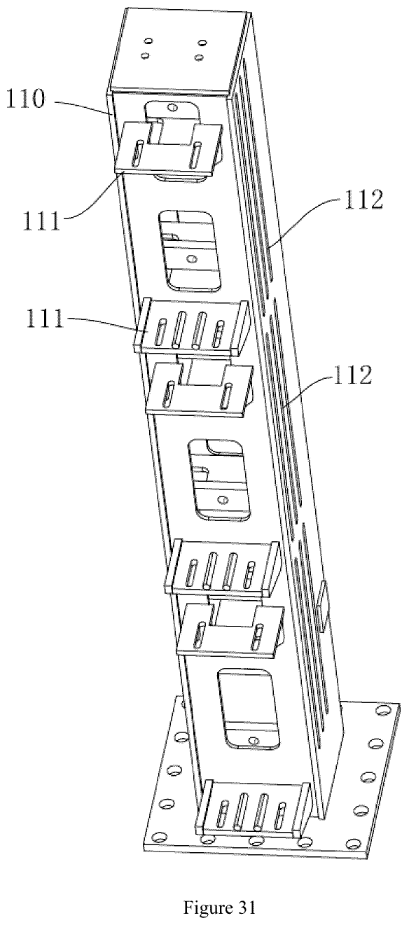

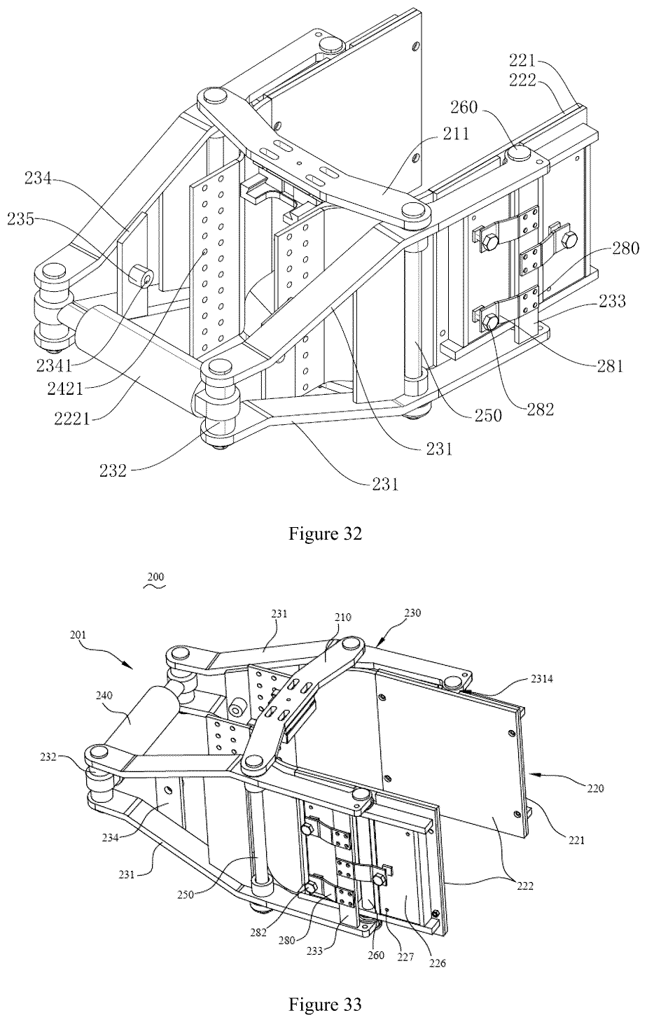

Referring to FIGS. 30-32, the electrode clamping assembly 200 includes:
A first supporting frame 210 for being disposed on the strut 100;
Two opposite electrode clamping plates 220; wherein, the two electrode clamping plates 220 jointly realize the clamping operation of the conductive electrodes on the furnace body;
Two first clamping arms 230 respectively hinged with both sides of the first supporting frame 210, and two electrode clamping plates 220 respectively arranged on the two first clamping arms 230; and
The first driving member 240 disposed between the two first clamping arms 230 and connected to the two first clamping arms 230 respectively.

The electrode clamping mechanism 2000 further includes:

Limit assemblies 700 respectively provided on both sides of the strut 100 for adjusting the opening direction of the electrode clamping plate 220.

Two ends of the first supporting frame 210 respectively hinged with the middle parts of two first clamping arms 230 to form two fulcrums, and the first clamping arms 230 and the first supporting frame 210 are both sheet-shaped and elongated plates: both ends of the first driving member 240 are hinged on the first ends of the two first clamping arms 230, and the first ends of the two first clamping arms 230 can be opened and closed around the fulcrum under the driving of the first driving member 240. Hydraulic cylinder is selected as the first driving member 240 in this embodiment. Certainly, in other embodiments, a lead screw drive, a cylinder drive, or the like may also be used, which is not described herein again.

Both sides of the first supporting frame 210 are respectively hinged with the first clamping arm 230 on the corresponding side through a first rotary shaft 250 which forms the fulcrum as described above.

Each electrode clamping plate 220 is hinged to an end of the first clamping arm 230 on a corresponding side through a second rotary shaft 260 and can be swung around the second rotary shaft 260.

Specifically, when the first driving member 240 drives the first clamping arm 230 to approach each other, the electrode clamping plate 220 on the first clamping arm 230 will gradually approach the conductive electrode, and the electrode clamping plate 220, in order to ensure the adhesion with the conductive electrode, will rotate with the second rotary shaft 260 as the axis to self-adjust according to actual needs, so as to maximize the contact area between the electrode clamping plate 220 and the conductive electrode, and further improve the electrical conduction efficiency.

In the above scheme, although the electrode clamping plate 220 can be rotated by a small amplitude with the second rotary shaft 260, and the opening direction of the electrode clamping assembly 200 can be adjusted, the deflection angle range of rotation adjustment is limited, and generally the electrode clamping plate 220 swings back and forth between the initial installation angle ±2.5 degrees, the initial installation direction of the electrode clamping plate 220 is perpendicular to the furnace wall direction, and the initial installation state of the conductive electrode is perpendicular to the furnace wall; when the deflection angle of the conductive electrode in the initial mounting state does not exceed the upper limit of the deflection angle of the electrode clamping plate 220, the first driving member 240 drives the first clamping arm 230 to approach each other, the electrode clamping plate 220 on the first clamping arm 230 gradually approaches the conductive electrode, and the electrode clamping plate 220 rotates around the second rotary shaft 260 under the effect of abutting the conductive electrode. The initial mounting angle of the conductive electrode deflects in different directions and will abut against different inner walls of the motor clamping plate 24. With the opening of the electrode clamping plate 220 facing the furnace wall as a reference. when the conductive electrode deflects to the left, the electrode clamping plate 220 gradually approaches the conductive electrode, the left inner wall of the electrode clamping plate 220 contacts the left side of the conductive electrode 220 and the right inner wall of the electrode clamping plate 220 contacts the right side of the conductive electrode 220, rotating clockwise around the second rotary shaft 260, thereby ensuring the stability of butting the electrode clamping plate 220 with the conductive electrode; with the opening of the electrode clamping plate 220 facing the direction of the furnace wall as a reference, when the conductive electrode deflects towards the right side, the electrode clamping plate 220 gradually approaches the conductive electrode, the right inner side wall of the electrode clamping plate 220 contacts the right side part of the conductive electrode, the left inner side wall of the electrode clamping plate 220 contacts the left side part of the conductive electrode, and the electrode clamping plate 220 rotates counterclockwise with the second rotary shaft 260 as the axis center. thus ensuring the stability of butting the electrode clamping plate 220 with the conductive electrode; when the mounting angles of the conductive electrodes in the initial mounting state in different furnaces are too large to cause the deflection angles of some or all of the conductive electrodes to exceed the upper limit of the deflection angle of the electrode clamping plate 220. the stability of butting with the conductive electrodes cannot be realized only by the deflection of the structure of the electrode clamping plate 220 itself. Therefore, the applicant adjusts the opening direction of the electrode clamping assembly 200 by setting the finite position assembly 700 on both sides of the strut 100, so that the opening direction of the electrode clamping assembly 200 is consistent with the mounting angle of the conductive electrodes in the initial mounting state, so as to adapt to the mounting angles of the conductive electrodes in different furnaces, thereby improving the butting stability of the electrode clamping assembly 200 with the conductive electrodes. The specific scheme is as follows:

The two first clamping arms 230 are respectively provided with a limiting position assembly 700 for adjusting the opening direction of the electrode clamping plate 220;
Or
Both sides of the strut 100 are respectively provided with a limiting position assembly 700 for adjusting the opening direction of the electrode clamping plate 220;
Or
One of the first clamping arms 230 and one side of the strut 100 are respectively provided with a limiting position assembly 700 for adjusting the opening direction of the electrode clamping plate 220; the first clamping arm 230 in which the limiting position assembly 700 is provided is provided on the other side of the strut 100.

Specifically, taking the limiting assembly 700 disposed on the first clamping arm 230 as an example, wherein one end of the limiting assembly 700 is provided toward the side of the strut 100, and the other end of the limiting assembly 700 is provided toward the other side of the strut 100, and there is a gap between one end of the limiting assembly 700 and the strut 100, so that the opening direction of the electrode clamping plate 220 is conveniently adjusted by one of the limiting position assembly 700 without being hindered by the other limiting position assembly 700; when the opening direction of the electrode clamping plate 220 needs to be adjusted, on the premise that there is an adjustment space between one of the limiting position assembly 700 and the strut 100, the distance between the strut 100 and the first end of the first clamping arm 230 is adjusted by adjusting the other limiting position assembly 700 to make the limiting position assembly 700 and the strut 100 fit together, so that the first clamping arm 230 rotates with the first rotary shaft 250 as the axis center to complete the adjustment of the installation angle of the first clamping arm 230, thereby realizing the adjustment of the opening direction of the electrode clamping plate 220 to adapt to the installation angles of conductive electrodes of different furnace bodies, thereby improving the butt stability of the electrode clamping assembly 200 and the conductive electrodes.

Specifically, when the mounting angle of the conductive electrode in the initial mounting state does not deflect or the deflection angle of the conductive electrode is between −2.5 degrees and −2.5 degrees, it is only necessary to adjust the limiting position assembly 700 on both sides of the electrode clamping assembly 200 to ensure that the distance between the first clamping arm 230 on both sides of the strut 100 and the strut 100 is consistent, and then the stability of butting with the conductive electrode is realized by deflecting the self-structure of the electrode clamping plate 220; exemplarily, the protruding length of the limiting position assembly 700 on both sides of the electrode clamping assembly 200 is adjusted such that the limiting position assembly 700 between the first end of the first clamping arm 230 and the strut 100 is identical in length and set to 4 cm; in other embodiments, the initial set length of the limiting position assembly 700 between the first end of the first clamping arm 230 and the strut 100 is related to the length of the second end to the first end of the first clamping arm 230, and the greater the length of the second end to the first end of the first clamping arm 230, the greater the initial set length of the limiting position assembly 700 between the first end of the first clamping arm 230 and the strut 100, while the deflection angle of the conductive electrode is constant.

When the deflection angle of the conductive electrode in the initial mounting state is greater than 2.5 degrees, the protruding length of the limiting position assembly 700 on both sides of the electrode clamping assembly 200 is adjusted so that the length of the limiting position assembly 700 between the first clamping arm 230 and the strut 100 is inconsistent; exemplarily, with the opening of the electrode clamping plate 220 facing the direction of the furnace wall as a reference, when the initial mounting angle of the conductive electrode is deflected to the left by 3 degrees, the protruding length of the limiting position assembly 700 on the right side of the electrode clamping assembly 200 is adjusted, such that the length of the limiting position assembly 700 between the first end of the first clamping arm 230 on the right side and the strut 100 is set to 5 cm, and synchronously adjusts the length of the limiting position assembly 700 between the first clamping arm 230 on the left side and the strut 100 so that the length of the limiting position assembly 700 between the first end of the first clamping arm 230 and the strut 100 is set to 3 cm at most, and the distance between the first end of the first clamping arm 230 and the strut 100 is adjusted by adjusting the other limiting position assembly 700 to make the limiting position assembly 700 and the strut 100 fit together on the premise that there is an adjustment space between the limiting position assembly 700 and the strut 100, so as to ensure that the first clamping arm 230 can rotate with the first rotary shaft 250 as the axis center, thereby completing the adjustment operation of the opening direction of the electrode clamping plate 220, the above-described manner may not be compensated for by using a deflection angle to the electrode clamping plate 220 itself. At the same time, after the opening direction of the electrode clamping plate 220 is adjusted by adjusting the protruding length of the limiting part assembly 700. when the conductive electrode is heated by electricity or when a deviation is generated when the heating stops, a stable connection between the electrode clamping plate 220 and the conductive electrode is achieved by using the deflection angle of the electrode clamping plate 220 itself, so as to ensure the contact area between the electrode clamping plate 220 and the conductive electrode, thereby improving the electrical conduction efficiency.

The electrode clamping assembly 200 in this embodiment is suitable for deflection of the conductive electrode at an initial mounting angle of −10 degrees −10 degrees, such as deflection of −5 degrees, −7.5 degrees, 7.5 degrees, and is not limited to 3 degrees of the example of this embodiment.

The operator may configure the length of the limiting position assembly 700 between the first clamping arm 230 and the strut 100 in advance according to the initial mounting angle of the conductive electrode to be clamped in the furnace body. so that the clamping direction of the electrode clamping plate 220 is suitable for the initial mounting angle of the conductive electrode to be clamped.

After the opening direction of the electrode clamping plate 220 is adjusted to be consistent with the initial mounting angle of the conductive electrode by adjusting the limiting position assembly 700, the first driving member 240 drives the two first clamping arms 230 to approach each other to realize the clamping and electrifying operation of the conductive electrode. At this time, the limiting position assembly 700 located at both sides of the strut 100 has a distance with the strut 100, and the conductive electrode deflects with thermal expansion or cold contraction after being electrified or stopping the electrifying operation, and provides a deflection force to the electrode clamping member 200; taking the initial installation angle of the conductive electrode as a left deflection of 3 degrees as an example, since there is a distance between the limiting position assembly 700 located on both sides of the strut 100 and the strut 100, when the electrode clamping assembly 200 is stably clamped on the conductive electrode, if the deflection force provided by the conductive electrode to the electrode clamping assembly 200 due to thermal expansion or cold contraction is left, the deflected conductive electrode will give the leftward deflection force to the electrode clamping plate 220, and then drive the opening direction of the electrode clamping plate 220 to deflect along with the conductive electrode.

When the conductive electrode deflects continuously due to thermal expansion or cold contraction, the conductive electrode will continuously deflect the electrode clamping plate 220 to the left. When the deflection angle of the electrode clamping plate 220 reaches the upper limit, the deflection force of the conductive electrode will transfer a part to the first clamping arm 230 on the left side, so that the first clamping arm 230 on the left side will receive the left deflection force, and then the two first clamping arms 230 will deflect with the first rotary shaft 250 as the axis center, so as to ensure that the opening direction of the electrode clamping plate 220 will deflect along with the conductive electrode, thereby ensuring the contact area between the electrode clamping plate 220 and the conductive electrode and further improving the electrical conduction efficiency.

Specifically, taking the limiting position assembly 700 is arranged on both sides of the strut 100 as an example, one end of the limiting position assembly 700 on one side of the strut 100 is arranged towards the first end of the corresponding first clamping arm 230, and one end of the limiting position assembly 700 on the other side of the strut 100 is arranged towards the first end of the corresponding first clamping arm 230. There is a gap between one end of at least one limiting position assembly 700 and the first end of the corresponding first clamping arm 230, so that it is convenient to adjust the opening direction of the electrode clamping plate 220 through one limiting position assembly 700 without being hindered by the other limiting position assembly 700; when the opening direction of the electrode clamping plate 220 needs to be adjusted, on the premise that there is an adjustment space between one of the limiting position assembly 700 and the first end of the first clamping arm 230, the distance between the strut 100 and the first end of the first clamping arm 230 is adjusted by adjusting the other limiting position assembly 700 to make the limiting position assembly 700 and the first end of the first clamping arm 230 fit together, so that the first clamping arm 230 rotates around the first rotary shaft 250 to complete the adjustment of the installation angle of the first clamping arm 230, thereby realizing the adjustment of the opening direction of the electrode clamping plate 220 to adapt to the installation angles of conductive electrodes of different furnace bodies, thereby improving the butt stability of the electrode clamping assembly 200 and the conductive electrodes.

Specifically, when the mounting angle of the conductive electrode in the initial mounting state does not deflect or the deflection angle of the conductive electrode is from −2.5 degrees to 2.5 degrees, it is only necessary to adjust the limiting position assembly 700 on both sides of the electrode clamping assembly 200 to ensure that the distance between the first clamping arm 230 on both sides of the strut 100 and the strut 100 is consistent, and then the stability of butting with the conductive electrode is realized by deflecting the self-structure of the electrode clamping plate 220; exemplarily, the protruding length of the limiting position assembly 700 on both sides of the electrode clamping assembly 200 is adjusted such that the limiting position assembly 700 between the first end of the first clamping arm 230 and the strut 100 is identical in length and set to 4 cm.

When the deflection of the conductive electrode in the initial mounting state is greater than 2.5 degrees, the protruding length of the limiting position assembly 700 on both sides of the electrode clamping assembly 200 is adjusted so that the length of the limiting position assembly 700 between the first clamping arm 230 and the strut 100 is inconsistent; exemplarily, with the opening of the electrode clamping plates 220 facing the direction of the furnace wall as a reference, when the initial mounting angle of the conductive electrode is deflected to the left by 3 degrees, the protruding length of the limiting position assembly 700 on the right side of the electrode clamping assembly 200 is adjusted, such that the length of the stop assembly 700 between the first end of the first clamping arm 230 on the right side and the strut 100 is set to 5 cm, and synchronously adjusts the length of the limiting position assembly 700 between the first clamping arm 230 on the left side and the strut 100. The length of the limiting position assembly 700 between the first end of the first clamping arm 230 and the strut 100 on the left side is set to 3 cm at most, and the distance between the first end of the first clamping arm 230 and the strut 100 is adjusted by adjusting the other limiting position assembly 700 so that the limiting position assembly 700 is attached to the strut 100 on the premise that there is an adjustment space between the first end of the first clamping arm 230 and the strut 100, thereby ensuring that the first clamping arm 230 can rotate around the first rotary shaft 250, thereby completing the adjustment operation of the opening direction of the electrode clamping plate 220. In this manner, the deflection angle of the electrode clamping plate 220 itself does not need to be used for compensation, after adjusting the protruding length of the limiting position assembly 700 to adjust the opening direction of the electrode clamping plate 220, when deflection occurs to the conductive electrode upon heating or upon heating being stopped, the deflection angle of the electrode clamping plate 220 itself is utilized to achieve a stable connection between the electrode clamping plate 220 and the conductive electrode. The contact area between the electrode clamping plate 220 and the conductive electrode is ensured, thereby improving the electrical conduction efficiency.

The electrode clamping assembly 200 in this embodiment is suitable for deflection of the conductive electrode at an initial mounting angle of −10 degrees to 10 degrees, such as deflection of −5 degrees, −7.5 degrees, 7.5 degrees, and is not limited to 3 degrees. of this embodiment.

The operator may configure the length of the limiting position assembly 700 between the first clamping arm 230 and the strut 100 in advance according to the initial mounting angle of the conductive electrode to be clamped in the furnace body. so that the clamping direction of the electrode clamping plate 220 is suitable for the initial mounting angle of the conductive electrode to be clamped.

After the opening direction of the electrode clamping plate 220 is adjusted through the limiting position assembly 700 to be consistent with the initial mounting angle of the conductive electrode, the first driving member 240 drives the two first clamping arms 230 to approach each other to realize the clamping and electrifying operation of the conductive electrode. In this case, a space exists between the limiting position assembly 700 located at two sides of the strut 100 and the first end of the first clamping arm 230, and after the conductive electrode is powered on or after the power-on operation is stopped. deflection occurs along with thermal expansion or cold contraction and a deflecting force is provided to the electrode clamping assembly 200; taking that the initial installation angle of the conductive electrode is deflected to the left by 3 degrees as an example, because the limiting position assemblies 700 located at both sides of the strut 100 are spaced from the first end of the first clamping arm 230, when the electrode clamping assembly 200 is stably clamped on the conductive electrode and if the conductive electrode has a deflecting force provided to the electrode clamping assembly 200 due to thermal expansion or cold contraction, the deflected conductive electrode will provide a leftward deflecting force to the electrode clamping plate 220, thereby driving the opening direction of the electrode clamping plate 220 to deflect together with the conductive electrode.

When the conductive electrode deflects continuously due to thermal expansion or cold contraction, the conductive electrode will continuously deflect the electrode clamping plate 220 to the left. When the deflection angle of the electrode clamping plate 220 reaches the upper limit, the deflection force of the conductive electrode will transfer a part to the first clamping arm 230 on the left side, so that the first clamping arm 230 on the left side will receive the left deflection force, and then the two first clamping arms 230 will deflect with the first rotary shaft 250 as the axis center, so as to ensure that the opening direction of the electrode clamping plate 220 will deflect along with the conductive electrode, thereby ensuring the contact area between the electrode clamping plate 220 and the conductive electrode and further improving the electrical conduction efficiency.

Specifically, taking the limiting position assembly 700 respectively arranged on the first clamping arm 230 and the electrode clamping mechanism 2000 as an example, one end of the limiting position assembly 700 arranged on the first clamping arm 230 is arranged towards the side of the strut 100, and one end of the limiting position assembly 700 arranged on the strut 100 is arranged towards the first end of the first clamping arm 230. There is a gap between one end of the limiting position assembly 700 and the corresponding electrode clamping mechanism 2000 and/or the first end of the first clamping arm 230, so that the opening direction of the electrode clamping plate 220 can be adjusted conveniently through one of the limiting position assembly 700 without being hindered by the other limiting position assembly 700; when the opening direction of the electrode clamping plate 220 needs to be adjusted, on the premise that there is an adjustment space between one of the limiting position assembly 700 and the strut 100 or its corresponding first clamping arm 230, the distance between the strut 100 and the first end of the first clamping arm 230 can be adjusted by adjusting the other limiting position assembly 700 to make the limiting position assembly 700 and the other first clamping arm 230 or the strut 100 fit together, so that the first clamping arm 230 rotates with the first rotary shaft 250 as the axis center to complete the adjustment of the installation angle of the first clamping arm 230, thereby realizing the adjustment of the opening direction of the electrode clamping plate 220 to adapt to the installation angles of conductive electrodes of different furnace bodies, thereby improving the butt stability of the electrode clamping assembly 200 and the conductive electrodes.

Specifically, when the mounting angle of the conductive electrode in the initial mounting state does not deflect or the deflection angle of the conductive electrode is from −2.5 degrees-2.5 degrees, only the limiting position assembly 700 on the strut 100 and the first clamping arm 230 need to be adjusted to ensure that the distance between the first clamping arm 230 on both sides of the strut 100 and the strut 100 is consistent, and then the stability of butting with the conductive electrode can be realized by using the self-structural deflection of the electrode clamping plate 220; exemplarily, the protruding lengths of the limiting position assembly 700 on the strut 100 and on the first clamping arm 230 are adjusted such that the lengths of the two limiting position assemblies 700 between the first end of the first clamping arm 230 and the strut 100 are identical and set to 4 cm.

When the deflection of the conductive electrode in the initial mounting state is greater than 2.5 degrees, the protruding lengths of the limiting position assemblies 700 on the strut 100 and on the first clamping arm 230 are adjusted so that the lengths of the two limiting position assemblies 700 between the first clamping arm 230 and the strut 100 are inconsistent: exemplarily, taking an example in which one limiting position assembly 700 is disposed at the left side of the strut 100 and the other limiting position assembly 700 is disposed at the first end of the first clamping arm 230 at the right side of the electrode clamping assembly 200, with reference to the direction in which the opening of the electrode clamping plate 220 faces the furnace wall, when the initial installation angle of the conductive electrode is deflected to the left by 3 degrees, the protruding length of the limiting position assembly 700 at the right side of the electrode clamping assembly 200 is adjusted, so that the length of the limiting position assembly 700 between the first end of the first clamping arm 230 at the right side and the strut 100 is set to be 5 cm, and synchronously adjusting the length of the limiting position assembly 700 between the first clamping arm 230 located on the left side of the strut 100 and the strut 100, such that the length of the limiting position assembly 700 between the first end of the first clamp arm 230 on the left side of the strut 100 and the strut 100 is set to at most 3 cm. On the premise of ensuring that an adjusting space exists between one of the limiting position assemblies 700 and the strut 100, the other limiting position assembly 700 is adjusted so that the limiting position assembly 700 is attached to the strut 100 and arranged to adjust the distance between the strut 100 and the first end of the first clamping arm 230, thus, the first clamping arm 230 can be ensured to rotate around the first rotary shaft 250, thereby completing the adjustment operation of the opening direction of the electrode clamping plate 220. In this manner, the deflection angle of the electrode clamping plate 220 itself does not need to be used for compensation, after adjusting the protrusion length of the limiting position assembly 700 to adjust the opening direction of the electrode clamping plate 220. When deflection occurs to the conductive electrode upon heating or upon heating being stopped, the deflection angle of the electrode clamping plate 220 itself is utilized to achieve a stable connection between the electrode clamping plate 220 and the conductive electrode. The contact area between the electrode clamping plate 220 and the conductive electrode is ensured, thereby improving the electrical conduction efficiency.

The electrode clamping assembly 200 in this embodiment is adapted for an initial mounting angle of the conductive electrode to be at a deflection of −10 degrees−10 degrees, such as a deflection of −5 degrees, −7.5 degrees, 7.5 degrees, and is not limited to 3 degrees of the example of this embodiment.

The operator may configure the length of the limiting position assembly 700 between the first clamping arm 230 and the strut 100 in advance according to the initial mounting angle of the conductive electrode to be clamped in the furnace body. so that the clamping direction of the electrode clamping plate 220 is suitable for the initial mounting angle of the conductive electrode to be clamped.

After the opening direction of the electrode clamping plate 220 is adjusted to be consistent with the initial mounting angle of the conductive electrode through adjusting the limiting position assembly 700, the first driving member 240 drives the two first clamping arms 230 to approach each other to realize the clamping and electrifying operation of the conductive electrode. In this case, there is a distance between the limiting position assembly 700 located on both sides of the strut 100 and the electrode clamping mechanism 2000 and the first clamping arm 230 respectively, and the conductive electrode will deflect with thermal expansion or cold contraction after being electrified or stopping the electrifying operation and provide a deflection force to the electrode clamping assembly 200. For example, when the initial mounting angle of the conductive electrode is deflected to the left by 3 degrees and there is a distance between the limiting position assembly 700 located on both sides of the strut 100 and the electrode clamping mechanism 2000 and the first clamping arm 230 with the electrode clamping assembly 200 being stably clamped on the conductive electrode, if the deflection force provided by the conductive electrode to the electrode clamping assembly 200 due to thermal expansion or cold contraction is left, the deflected conductive electrode will give the deflection force to the left of the electrode clamping plate 220, and then drive the opening direction of the electrode clamping plate 220 to deflect along with the conductive electrode.

When the conductive electrode deflects continuously due to thermal expansion or cold contraction, the conductive electrode will continuously deflect the electrode clamping plate 220 to the left. When the deflection angle of the electrode clamping plate 220 reaches the upper limit, a part of the deflection force of the conductive electrode will be transferred to the first clamping arm 230 on the left side, so that the first clamping arm 230 on the left side will receive the left deflection force. Because the two first clamping arms 230 are connected by the first driving member 240, the two first clamping arms 230 are respectively deflected by taking the corresponding first rotary shaft 250 as the axis center, thereby ensuring that the opening direction of the electrode clamping plate 220 follows the conductive electrode and deflects together, thus ensuring the contact area between the electrode clamping plate 220 and the conductive electrode, thus improving the electrical conduction efficiency.

Further, the first end of the first clamping arm 230 is provided with a first limit plate 234, and the limiting position assembly 700 is provided on the first limit plate 234; the first limit plate 234 is provided with a first limit hole 2341, and the limiting position assembly 700 is arranged through the first limit hole 2341; the limiting position assembly 700 is of bolt structure, a limiting block 235 is arranged on the first limiting plate 234, the first limiting hole 2341 is arranged through the limiting block 235, the limiting position assembly 700 is arranged through the first limiting hole 2341 and is close to the side of the strut 100, specifically, the limiting position assembly 700 is arranged in close contact with the strut 100 towards one end of the strut 100, the distance between the strut 100 and the first clamping arm 230 is adjusted by adjusting the length of the limiting position assembly 700 protruding out of the first limiting hole 2341, so that the first clamping arm 230 rotates with the first rotary shaft 250 as the axis center to complete the adjustment of the installation angle of the first clamping arm 230, and then the opening direction of the electrode clamping plate 220 is adjusted to adapt to the installation angle of conductive electrodes of different furnace bodies, thereby improving the butt stability of the electrode clamping assembly 200 and conductive electrode. In this embodiment, the first ends of the first clamping arms 230 on both sides of the first supporting frame 210 are respectively provided with first limiting position plates 234, and the two limiting position assemblies 700 respectively penetrate through the two first limiting holes 2341 and are close to both sides of the strut 100. When the electrode clamping assembly 200 is transferred to the conductive electrode of one of the furnace bodies, the first driving member 21 drives the first clamping arms 230 on both sides of the first supporting frame 210 to approach each other, thus driving the electrode clamping plate 220 to realize the clamping operation of the conductive electrode; when the electrode clamping assembly 200 is transferred to the conductive electrode of another furnace body, in order to ensure the stability of butt joint between the electrode clamping assembly 200 and the conductive electrode, the length of the limiting position assembly 700 protruding out of the first limiting hole 2341 is adjusted according to the mounting angle of the conductive electrode, so that the opening direction of the electrode clamping plate 220 matches the mounting angle of the conductive electrode, thereby improving the butting stability between the electrode clamping assembly 200 and the conductive electrode; when the limiting position assembly 700 is a bolt, the length of the limiting position assembly 700 protruding out of the limit block 235 is adjusted by rotating the limiting position assembly 700, that is, the length of the limiting position assembly 700 between the first clamping arm 230 and the strut 100 is adjusted by rotating the limiting position assembly 700, so that the deflection angle of the first clamping arm 230 is limited, and the opening direction of the electrode clamping plate 220 is adjusted to adapt to the installation angles of conductive electrodes of different furnace bodies.

In other embodiments, the limiting position assembly 700 can be designed to include a driving part and a limiting rod structure as desired, the driving member is fixed on the first clamping arm 230 and/or the strut 100, the limiting rod is arranged at one end of the driving member, and the driving member drives the limiting rod to extend and retract so as to limit the deflection angle of the first clamping arm 230. In addition, the opening direction of the electrode clamping plate 220 is adjusted to adapt to the installation angles of the conductive electrodes of different furnace bodies. The driving member may be configured as a driving cylinder, an electric push rod, or the like.

In addition, the conductive electrode may be tilted due to heating or cooling in the working process, and the deflection of the conductive electrode will firstly drive the electrode clamping plate 220 to rotate around the second rotary shaft 260, so as to ensure that the opening direction of the electrode clamping plate 220 is continuously consistent with the deflection direction of the conductive electrode, ensure the contact area between the electrode clamping plate 220 and the conductive electrode, and further improve the electrical conduction efficiency; the conductive electrode is tilted after being continuously heated or cooled and drives the deflection angle of the electrode clamping plate 220 reaches the upper limit, the continuous deflection of the conductive electrode will drive the first clamping arm 230 to rotate with the first rotary shaft 250 as the axis center through the electrode clamping plate 220, so as to ensure that the opening direction of the electrode clamping plate 220 is deflected along with the conductive electrode, thereby ensuring the contact area between the electrode clamping plate 220 and the conductive electrode and further improving the electrical conduction efficiency; when the power supply operation to the conductive electrode is completed, the electrode clamping plate 220 is separated from the conductive electrode, and the separated electrode clamping plate 220 returns to the initial state with the second rotary shaft 260 as the axis; when the electrode clamping assembly 200 is sent to the next conductive electrode, in order to ensure the stability of butt joint between the electrode clamping assembly 200 and the conductive electrode, the length of one of the limiting position assemblies 700 extending out of the first limiting hole 2341 is adjusted according to the mounting angle of the conductive electrode, so that the opening direction of the electrode clamping plate 220 matches the mounting angle of the conductive electrode, thereby improving the butt joint stability between the electrode clamping assembly 200 and the conductive electrode.

In one embodiment, a reinforcing block 120 is arranged on the strut 100 and/or on the side of the first clamping arm 230 matched with the limiting position assembly 700. When the first clamping arm 230 is forced to rotate, the limiting position assembly 700 prevents the first clamping arm 230 from rotating with the first rotary shaft 250 as the axis center, and then the first clamping arm 230 drives the limiting position assembly 700 to continuously exert force on the strut 100. With the buffering effect of the reinforcing block 120, the damage caused by the limiting position assembly 700 to the strut 100 is reduced, thus prolonging the service life of the strut 100.

In one embodiment, the limiting position assembly 700 is arranged on the first clamping arm 230, the second end of the first clamping arm 230 is provided with a first fixing plate 233 on one side of the electrode clamping plate 220, and the first fixing plate 233 is provided with a first elastomer 280. Specifically, the first elastomer 280 is of a spring sheet structure. and the first elastomer 280 is bent to extend the stopper portion 281, which is used for pressing on the side of the electrode clamping plate 220 to limit the initial installation angle of the electrode clamping plate 220 and further improve the reset effect of the electrode clamping plate 220. After the power supply operation for the conductive electrode is completed, the separated electrode clamping plate 220 is separated from the conductive electrode, and the separated electrode clamping plate 220 is restored to an initial state by taking the second rotary shaft 260 as an axis under the pressing action of the first elastomer 280. Further, the stopper portions 281 of at least two first elastomers 280 are respectively provided on both sides of the first fixing plate 233, so as to ensure that the electrode clamping plate 220 is pressed by the stopper portions 281 on the corresponding side when the electrode clamping plate 220 rotates forward or in the reverse direction with the second rotary shaft 260 as the axis center, and the electrode clamping plate 220 is separated from the conductive electrode after the power supply operation to the conductive electrode is completed, and the separated electrode clamping plate 220 can ensure the effect of returning to the initial state.

In one embodiment, the stopper portion 281 is provided with a screw hole, and a first limiting bolt 282 is arranged in the screw hole. One end of the first limiting bolt 282 is used for abutting against one side of the electrode clamping plate 220. By adjusting the protruding length out of the screw hole from one end of the first limiting bolt 282, the initial installation angle of the electrode clamping plate 220 is adjusted, and then the initial opening direction of the electrode clamping plate 220 is adjusted to adapt to the installation angles of conductive electrodes of different furnace bodies.

In one embodiment, a fixing hole is provided on the first fixing plate 233, and one end of the first elastomer 280 is fixed on the first fixing plate 233 through a screw member, and the screw member passes through one end of the first elastomer 280 and is clamped in the fixing hole.

In other embodiments, the first elastomer 280 may also be a combination structure of a fixing piece and a spring member. One end of the fixing piece is fixed on the first fixing plate 233 by a screw, the spring member is arranged at the other end of the fixing piece, and one end of the spring member is used to press against the side of the electrode clamping plate 220 to limit the initial installation angle of the electrode clamping plate 220, while further improving the reset effect of the electrode clamping plate 220. When the power supply operation to the conductive electrode is completed, the separated electrode clamp 220 is separated from the conductive electrode, and the separated electrode clamping plate 220 returns to the initial state with the second rotary shaft 260 as the axis under the pressure of the spring member.

In one embodiment, the first clamping arm 230 is hollowed out near the first fixing plate 233 to facilitate the first elastomer 280 to limit the initial mounting angle of the electrode clamping plate 220; specifically, the first clamping arm 230 includes two first clamping arms 231, the first rotary shaft 250 is arranged through the first clamping arm 231, and two supporting blocks 111 are arranged on the strut 100 to match each electrode clamping assembly 200, and the two supporting blocks 111 are respectively arranged at the top end and the bottom end of the electrode clamping assembly 200, so as to jointly realize the supporting effect on the electrode clamping assembly 200.

The first supporting frame 210 comprises two first supporting plates 211 arranged in parallel, the top end and the bottom end of the electrode clamping assembly 200 are respectively arranged on the first supporting plates 211, the two first supporting plates 211 are respectively arranged on the two supporting blocks 111, and the top end and the bottom end of the first rotary shaft 250 are respectively arranged through the two first supporting plates 211, thereby improving the stability of the connection between the first clamping arm 230 and the first supporting plate 211; one end of the two first clamping arms 231 is fixed together by a connecting rod 232, the other end of the two first clamping arms 231 is fixed together by a first fixing plate 233. both ends of the first driving assembly 21 are respectively connected with the connecting rod 232, and the first driving member 240 drives the two first clamping arms 231 to move together by driving the connecting rod 232, thus realizing the operation effect of driving the electrode clamping plate 220 to clamp or release the conductive electrode.

Further, one end of the first clamping arm 230 close to the first driving member 240 is arranged in a V-shaped configuration, specifically, the two first clamping arms 231 close to the one end of the first driving member 240 are combined in a V-shaped configuration, so that sufficient space is conveniently left between two adjacent electrode clamping assemblies 200 on the strut 100 for other structures to mount and arrange: specifically, a first conductive block 800 is installed between two adjacent electrode clamping assemblies 200 on the strut 100, one end of the first conductive block 800 is connected with an aluminum row clamping mechanism 3000 through a connecting cable, and the aluminum row clamping mechanism 3000 transmits electricity to the strut 100 through the first conductive block 800, and then the strut 100 transmits electricity to the electrode clamping assembly 200, thereby realizing the power supply effect for the conductive electrodes.

In one embodiment, the electrode clamping plate 220 includes a first clamping plate 221 and a first conductive plate 222, a second rotary shaft 260 is arranged in the middle of the first conductive plate 222, and the first conductive plate 222 rotates around the second rotary shaft 260; the first conductive plate 222 is fixed on the first clamping plate 221, the first conductive plate 222 is made of copper soft tape, the first conductive plate 222 is bent and extended out of the first clamping plate 221 and connected with the strut 100, the first conductive plate 222 is formed to limit the position of the first clamping plate 221 by the flexibility of the first conductive plate 222, and the stability of the initial installation angle of the electrode clamping plate 220 is effectively improved. When the electric power supply operation is completed, the electrode clamping plate 220 is separated from the conductive electrode, and the separated electrode clamping plate 220 can be restored to the initial state with the second rotary shaft 260 as the axis under the recovery action of the first conductive plate 222, thus realizing the self-adjusting effect of rotating the electrode clamping plate 220 with the second rotary shaft 260 as the axis.

In one embodiment, the strut 100 includes a base pillar 110 and an electric clamping plate 130 arranged on both sides of the base pillar 110. The base pillar 110 is provided with a butt groove 112. The electric clamping plate 130 is provided with a first butt hole 131. The first butt hole 131 is arranged on the electric clamping plate 130 at intervals. The electric clamping plate 130 is fixed on the base pillar 110 through a locking piece which is bolted. The locking piece is fixed in the butt groove 112 through the first butt hole 131. Because the positions of the first butt hole 131 on the electric clamping plate 130 are different, each butt groove 112 can be matched with a plurality of first butt holes 131. When the electric clamping plate 130 is installed on the base pillar 110, the electric clamping plate 130 can be fixed in the butt groove 112 through a plurality of locking pieces and form a stable connection between the electric clamping plate 130 and the base pillar 110. In addition, the first butt hole 131 is provided at different positions of the electric clamping plate 130 and the butt groove 112 is provided at the side wall of the base pillar 110, so that the relationship between the butt groove 112 and the first butt hole 131 is one-to-many, and the mounting height of the electric clamping plate 130 does not need to be particularly limited under the condition that the first butt hole 131 and the butt groove 112 are matched, so that the mounting is easier. Further, the end of the first conductive plate 222 extends out of the first clamping plate 221 and is placed between the base pillar 110 and the electric clamping plate 130. The end of the first conductive plate 222 is provided with a second butt hole 2221, which is arranged at intervals at the end of the first conductive plate 222. The second butt hole 2221 is fixed in the butt groove 112 after passing through the first butt hole 131 and the second butt hole 2221 through the locking piece, so as to realize the stable connection between the first conductive plate 222 and the strut 100. Finally, the first conductive block 800 connected with the strut 100 is used to transport the electricity from the external power supply device to the first conductive plate 222, thus realizing the power supply effect to the conductive electrode.

Further, the first conductive block 800 is provided with a third butt hole 810. After the locking piece passes through the third butt hole 810, the first butt hole 131 and the second butt hole 2221, the first conductive block 800 is stably fixed on the side of the electric clamping plate 130, so as to realize the electrical connection effect between the first conductive block 800 and the strut 100, thereby facilitating the transmission of electricity from the external power supply device to the strut 100. and then the strut 100 transmitting electricity to the electrode clamping assembly 200 to supply electricity to the conductive electrode.

In one embodiment, the base pillar 110 is rectangular in structure, and the upper end of the base pillar 110 is provided with a lifting ring mechanism 140 to facilitate the external hook to be hung on the pillar 110, thereby moving the entire strut 100 and facilitating the assembly of the equipment.

In the specific operation of the present application, the electrode clamping assembly 200 approaches the conductive electrode of one of the furnace bodies along with the transfer of the strut 100, and then the first driving member 240 starts to move, and the telescopic end of the first driving member 240 extends out to drive the connecting rod 232 located at both ends of the first driving member 240 to move away from each other. At this time, the first clamping arm 230 rotates with the first rotary shaft 250 as the axis center, and then drives the electrode clamping plate 220 at the first end of the first clamping arm 230 to move in the direction of approaching each other, thus realizing the clamping operation of the conductive electrode; when the electrode clamping assembly 200 approaches the conductive electrode of another furnace body along with the transfer of the strut 100, in order to ensure the stability of butting the electrode clamping assembly 200 with the conductive electrode. the length of the limiting position assembly 700 extending out of the first limiting hole 2341 is adjusted according to the initial mounting angle of the conductive electrode, and the mounting angle of the first clamping arm 230 is adjusted so that the opening direction of the electrode clamping plate 220 matches the mounting angle of the conductive electrode, thereby improving the butting stability of the electrode clamping assembly 200 with the conductive electrode; in addition, after the power-transmitting aluminum row is electrified, the aluminum row clamping mechanism 3000 transmits electricity to the conductive electrode through the electrode clamping assembly 200, and the conductive electrode tilts due to heating or cooling during the working process, which will synchronously drive the electrode clamping plate 220 to shift. After the deflection angle of the electrode clamping plate 220 reaches the upper limit, it will drive the first clamping arm 230 to deflect, so as to ensure that the opening direction of the electrode clamping plate 220 deflects along with the conductive electrode, thus ensuring the contact area between the electrode clamping plate 220 and the conductive electrode, and further improving the electrical conduction efficiency.

### Embodiment 5

Different from conventional workpieces, when the conductive electrode is in a high temperature state (about 300° C.). it will transfer heat to the electrode clamping plate 220 of the electrode clamping assembly 200 directly connected with it, and the electrode clamping plate 220 will deform when heated, which will lead to poor contact between the electrode clamping plate 220 and the conductive electrode and affect the graphitization effect of the conductive electrode. In addition, the electrode clamping plate 220 will accelerate its aging speed when it is in a high temperature state for a long time. In this way, in order to avoid the problems of poor contact and rapid aging caused by the electrode clamping plate 220 being in a high temperature state for a long time, the present embodiment specifically adopts the following cooling structure to solve the problems.

Referring to FIGS. 33-38, the electrode clamping assembly 200 includes:
Electrode clamping plates 220; the electrode clamping plates 220 is used for clamping the conductive electrodes on the furnace body;
A first clamping assembly 201 for driving the electrode clamping plates 220 close to or away from each other.

The electrode clamping plate 220 includes a first clamping plate 221 and a first conductive plate 222. The overall shape of the first clamping plate 221 is rectangular, and the size matches the size of the conductive electrode. It can be understood that the shape of the first clamping plate 221 can also be set to be circular, elliptical or other geometric shapes, and the rectangular shape is relatively easier to fabricate. The back surface of the first clamping plate 221 is provided with a cooling pipe 223. The cooling pipe 223 is provided with a connecting piece 224 for connecting the circulating liquid. At least two connecting pieces 224 are provided, one in and one out. The first conductive plate 222 is closely arranged on the front surface of the first clamping plate 221. The first conductive plate 222 directly contacts the conductive electrode and is connected with the electrode clamping mechanism 2000 through a connecting cable, so as to transmit the electricity of the aluminum row to the first conductive plate 222, and then the first conductive plate 222 transmits the electricity to the conductive electrode, thus realizing the power supply operation for Acheson graphite furnace.

When working, the first conductive plate 222 is in direct contact with the conductive electrode to raise the temperature. and the cooling pipeline 223 is connected with the external circulating liquid through the connecting pieces 224 at both ends. and the pipeline is filled with circulating cooling water, which can quickly take away the heat on the first conductive plate 222 to lower the temperature and reduce the adverse effects of high temperature on the deformation and aging of the first conductive plate 222; in addition, the structure in which the first conductive plate 222 and the first clamping plate 221 are assembled into the electrode clamping plate 220 is more scientific, practical and convenient for maintenance and replacement than the method in which the cooling pipe is directly provided on the first conductive plate 222.

In one embodiment, the cooling pipe 223 is attached to the back of the first clamping plate 221 in an S-shape, and the pipe of this structure is spread over the whole of the first clamping plate 221, so that a rapid and uniform cooling effect can be realized.

Specifically, the first clamping plate 221 is further provided with a protective case including a side plate 225 that surrounds the cooling pipe 223, and a cover plate 226 that covers the edge of the side plate 225. The cover plate 226 is provided with a through hole 227 corresponding to the connecting head 224. The arrangement of the protective case can protect the cooling pipe 223 and prevent the cooling pipe 223 from being damaged.

In one embodiment, the cooling pipeline may be designed as a water-cooling pipeline, and the circulating liquid is circulating water.

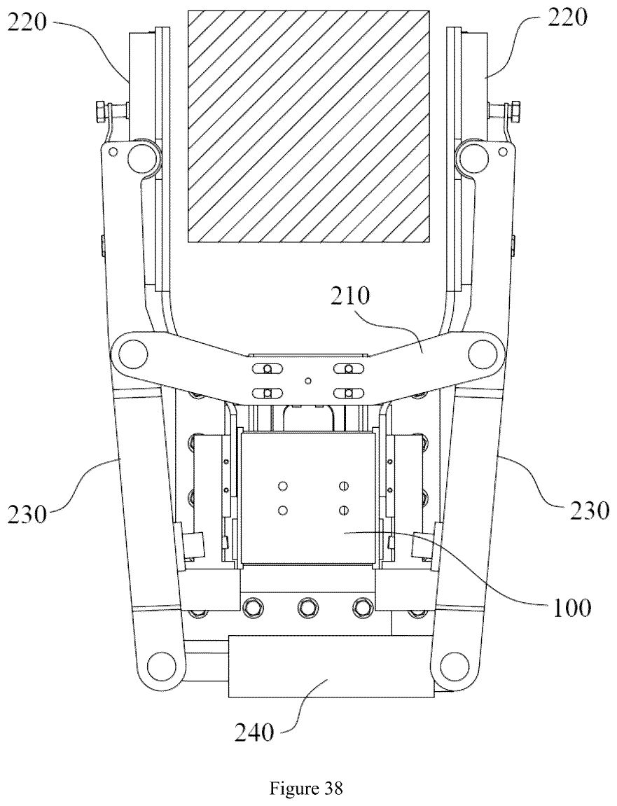

Referring to FIG. 38, the first clamping assembly 201 includes:
A first supporting frame 210;
Two first clamping arms 230 respectively hinged with both sides of the first supporting frame 210, and the electrode clamping plate 220 is matched and arranged on the first clamping arm 230; and
The first driving member 240 disposed between the two first clamping arms 230 and connected to the two first clamping arms 230 respectively.

Two sides of the first supporting frame 210 are respectively hinged with the middle parts of two first clamping arms 230 to form two fulcrums, and the first clamping arms 230 and the first supporting frame 210 are both sheet-shaped and elongated plates; both ends of the first driving member 240 are hinged on the first ends of the two first clamping arms 230. and the second ends of the two first clamping arms 230 can be opened and closed around the fulcrum under the driving of the first driving member 240. Hydraulic cylinder is selected as the first driving member 240 in this embodiment. Certainly, in other embodiments, a lead screw drive, a cylinder drive, or the like may also be used, which is not described herein again.

Correspondingly the electrode clamping plates 220 are provided with a pair hinged on the corresponding first clamping arms 230 so that the two electrode clamping plates 220 can be pivoted about the pivot axes respectively. When the electrode clamping plate 220 is clamped on the conductive electrode, the two electrode clamping plates 220 can also swing according to the deviation of the conductive electrode position, thereby reducing the resistance stress between the electrode clamping plate 220 and the conductive electrode, preventing the conductive electrode from being damaged, and prolonging the service life of the equipment.

In the actual production process of Acheson graphite furnace, the position of the conductive electrode can not be 100% ideal, and because of the uneven heating, the conductive electrode itself will expand and deform to a certain extent. If the position of the electrode clamping plate 220 and the conductive electrode is not aligned, there will be other resisting stresses besides clamping force between them after clamping, which may cause the damage of the conductive electrode. In a scheme in which the electrode clamping plates 220 are articulated at the end of the first clamping arm 230, the two electrode clamping plates 220 can be swung at a small angle to adapt to the position deviation, expansion deformation and the like of the conductive electrodes, thereby eliminating excess stress between the clamping plates and the conductive electrodes and preventing damage to the conductive electrodes.

Referring further to FIG. 38, in one embodiment, the ends of the two first clamping arms 230 protrude toward the clamping direction to form a first convex portion, and the first clamping plate 221 is connected to the first convex portion. The combined structure will give the electrode clamping plate 220 further room for movement inside the first clamping arm 230 and reduce interference between the electrode clamping plate 220 and the first clamping arm 230 when swinging.

The first clamping assembly 201 of the above embodiment utilizes the lever principle to apply force, that is, the first clamping arm 230 is divided into an upper section and a lower section with the end point of the first supporting frame 210 as a fulcrum, and the purpose of saving energy consumption can be achieved by setting the length ratio of the upper section and the lower section. For example, in a specific embodiment, if the length ratio of the lower section to the upper section is set to 1.5:1, only one part of the force applied to the driving end can obtain 1.5 times of the force applied to the clamping end, thus achieving the purpose of reducing the pressure of the hydraulic cylinder.

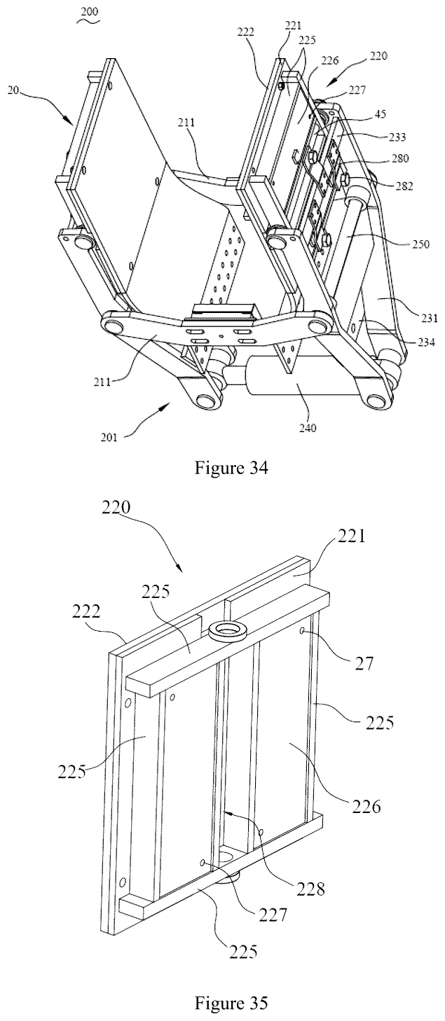

Referring further to FIG. 33. FIG. 34, FIG. 37 and FIG. 38, further, the first clamping arm 230 includes two first clamping arms 231 each articulated at a fulcrum of the first supporting frame 210; one end of the two first clamping arms 231 is fixed together by a connecting rod 232, and the other end of the two first clamping arms 231 is fixed together by a first fixing plate 233. Two ends of the first driving member 240 are respectively connected with the connecting rod 232, and the first driving member 240 drives the two first clamping arms 231 to move together by driving the connecting rod 232 to move, thus realizing the operation effect of driving the electrode clamping plate 220 to clamp or release the conductive electrode.

The first clamping arm 230 is provided with a limiting position plate 234 near the connecting rod 232, and two ends of the limiting position plate 234 are respectively connected with two first clamping arms 231, thereby improving the structural stability of the first clamping arm 230.

The first supporting frame 210 is provided with two first supporting plates 211 arranged in parallel, and both ends of each first supporting plate 211 are hinged with a first clamping arm 231 on a corresponding side through a first rotary shaft 250, which forms a fulcrum as described above.

Each electrode clamping plate 220 is hinged to the ends of the two first clamping arms 231 on the corresponding side by a second rotary shaft 260 and can be swung around the second rotary shaft 260.

The operation principle of the electrode clamping plates 220 for the conductive electrode of the furnace body is as follows:

The electrode clamping plate 220 for the conductive electrode of the furnace body is opened toward the horizontal side and moves to the vicinity of the conductive electrode during operation. When the conductive electrode is extended into the opening, the hydraulic cylinder is synchronously driven and elongated, and the two first clamping arms 230 are swung around the first rotary shaft 250, so that the first clamping arms 230 are pressed against each other, and finally the two electrode clamping plates 220 are clamped on the two opposite surfaces of the conductive electrode. The first conductive plate 222 is in direct contact with the surface of the conductive electrode, and cooling water flows in the cooling pipeline 223, so that heat is carried away at all times, and the temperature of the first conductive plate 222 is lowered, thereby avoiding problems such as structural aging caused by high temperature. When loosened, the hydraulic cylinder contracts synchronously, and then drives the first clamping arm 230 to open, so that the electrode clamping plate 220 is separated from the conductive electrode, and then translates away from the electrode in the reverse direction.

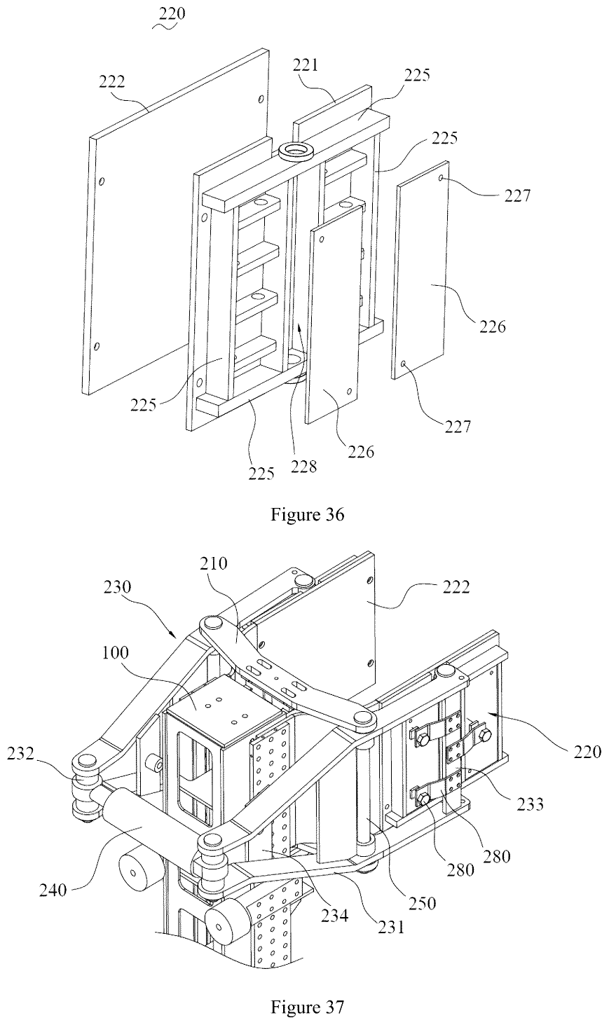

Referring to FIG. 33, FIG. 35 and FIG. 36, the structure of the electrode clamping plate 220 needs to be adjusted adaptively due to the existence of the first rotary shaft 250. Specifically, the whole cooling pipeline 223 is divided into a first pipeline and a second pipeline arranged side by side along the first direction, and a first protective case and a second protective case is respectively arranged corresponding to the first pipeline and the second pipeline. An avoidance groove 228 is arranged between the two protective cases, and the avoidance groove 228 is arranged for the first rotary shaft 250 to penetrate into, each protective case is provided with a cover plate 226, and the cover plate 226 is respectively provided with two through holes 227. The two pipes communicate with each other by connecting through holes 227 in the two cover plates 226 through a small tube arranged across the first rotary shaft 250. Thus, the presence of the first rotary shaft 250 does not affect the cooling function of the electrode clamping plate 220.

Referring to FIG. 37 and FIG. 38, the electrode clamping plate 220 for the conductive electrode of the furnace body is used to clamp the conductive electrode located on the side when in a working state, so that the opening of the electrode clamping plate 220 faces the horizontal side, and the side far away from the conductive electrode is used for connecting components such as cables.

Referring to FIG. 37 and FIG. 38, it is worth mentioning that the electrode clamping plate 220 for the conductive electrode of the furnace body is applied to the power transmission vehicle device. Specifically, after the power transmission vehicle device is assembled, the strut 100 passes through the space between the first supporting frame 210 and the first driving member 240, and the first supporting frame 210 is connected to the strut 100, so that the entire electrode clamping plate 220 is applied to the power transmission vehicle device.

The electrode clamping plate 220 may also be fixedly connected to the end of the first clamping arm 230 in a variety of ways such as welding or bolting. In this case the electrode clamping plate 220 can still achieve a cooling effect on the first conductive plate 222 but has less adaptive effect compared with the above-described embodiment and there is a case where the conductive electrode is pinched.

It should be pointed out that when the power transmission aluminum row works, it will generate more heat, which will be transferred to the aluminum row clamping plate of the aluminum row clamping assembly 300 directly connected with it. The aluminum row clamping plate will deform when heated, which will lead to poor contact between the aluminum row clamping plate and the power transmission aluminum row and affect the stable power transmission effect. In addition, the aluminum row clamping plate will be in a high temperature state for a long time, which will accelerate its aging speed. In this way, in order to avoid the problems of poor contact and rapid aging caused by the aluminum row clamping plate being in a high temperature state for a long time, the embodiment specifically adopts the following structure to solve the problems.

Since the cooling structure of the aluminum row clamping assembly 300 is identical to that of the electrode clamping assembly 200, the cooling structure applied to the electrode clamping assembly 200 can also be applied to the aluminum row clamping assembly 300 and need not be described here.

### Embodiment 6

Different from the conventional workpiece, the conductive electrode is arranged outside the furnace, and it needs to be clamped by the electrode clamping plate 220 to realize electrical connection. At this time, the electrode clamping plate 220 is in face contact with the conductive electrode. In actual production, the installation position of conductive electrode can not be absolutely accurate, and the perpendicular line of its cross section deviates from the initial direction more or less; at the same time, due to the deformation of the conductive electrode caused by heating or cooling, there is a gap between the conductive electrode and the electrode clamping plates 220, which can not be closely attached, resulting in poor conductive effect, thus affecting the final product quality produced by Acheson graphite furnace. Thus, in order to avoid the problem of poor conductive effect caused by the inability of the electrode clamping plate 220 to be closely attached to the conductive electrode, the present embodiment specifically adopts the following configuration to solve the problem.

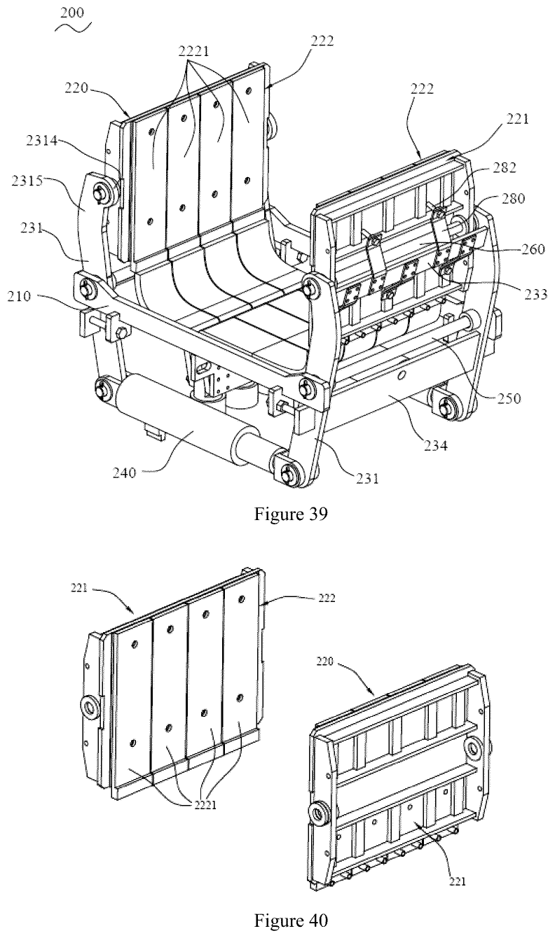

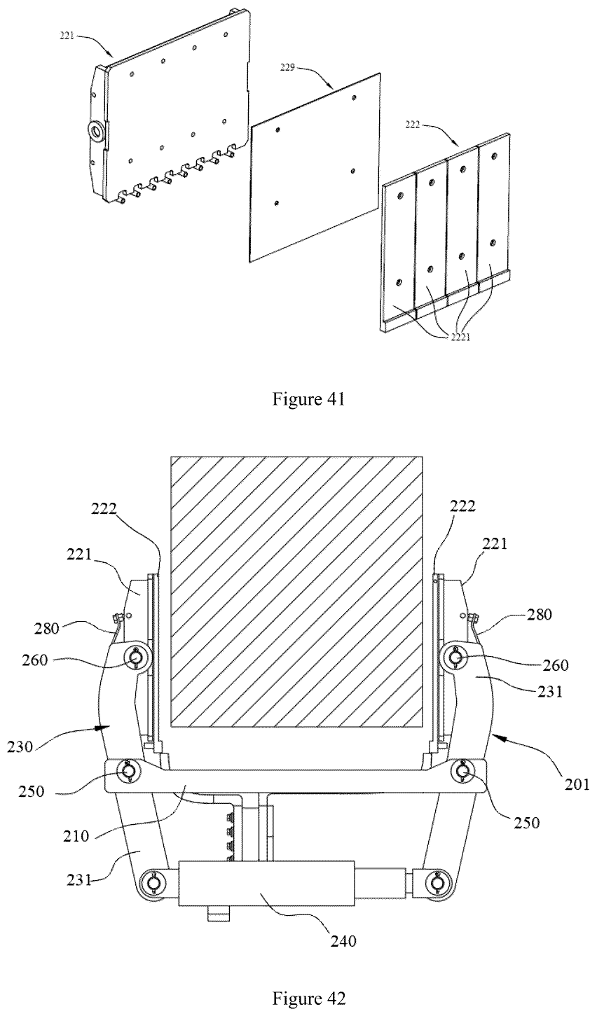

Referring to FIGS. 39 to 44, in the present embodiment, the electrode clamping assembly 200 is a clamp-type structure using a lever principle, and the electrode clamping assembly 200 includes:

Electrode clamping plates 220; the electrode clamping plates 220 is used for clamping conductive electrodes outside the furnace body;
A first clamping assembly 201 for driving the electrode clamping plates 220 close to or away from each other.
Referring to FIGS. 39 and 42, in one embodiment, the first clamping assembly 201 includes;
A first supporting frame 210;
Two first clamping arms 230 respectively hinged with both sides of the first supporting frame 210, and the electrode clamping plates 220 matched and arranged on the first clamping arms 230; and
The first driving member 240 disposed between the two first clamping arms 230 and connected to the two first clamping arms 230 respectively.

Two ends of the first supporting frame 210 are respectively hinged with the middle parts of two first clamping arms 230 to form two fulcrums, and the first clamping arms 230 and the first supporting frame 210 are both sheet-shaped and elongated plates; both ends of the first driving member 240 are hinged on the first ends of the two first clamping arms 230, and the second ends of the two first clamping arms 230 can be opened and closed around the fulcrum under the driving of the first driving member 240. The first driving member 240 in the present embodiment is a hydraulic cylinder. Of course, in other embodiments, a lead screw drive, a cylinder drive, etc. may also be used, which will not be described herein again.

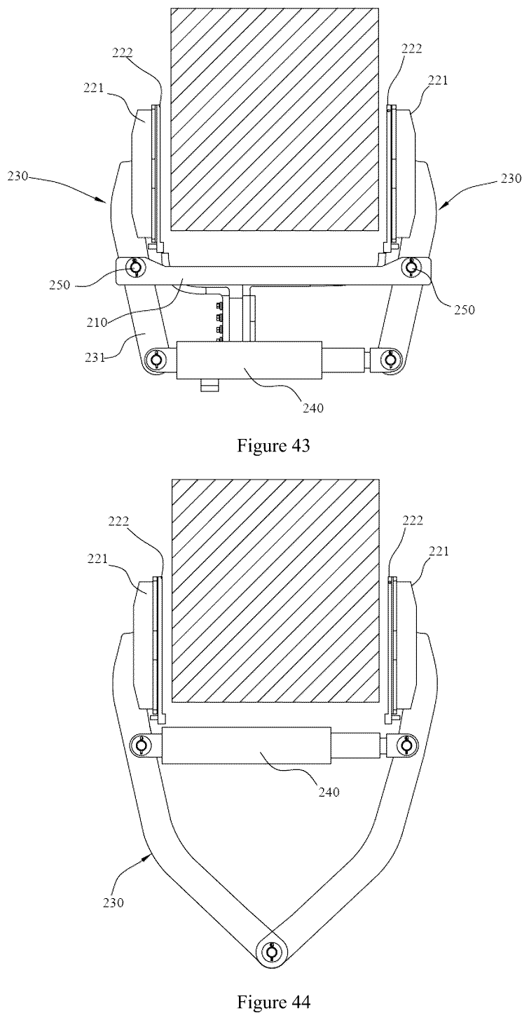

Referring to FIG. 43, the electrode clamping plate 220 includes a first clamping plate 221, and two first clamping plates 221 are fixedly connected to the ends of corresponding first clamping arms 230, respectively, so that the two first clamping plates 221 can be relatively approached or farther away under the drive of the first clamping arms 230, thereby achieving clamping and loosening effects. Specifically, the shape of the first clamping plate 221 is set to be rectangular, and the size matches the size of the conductive electrode. It can be understood that the shape of the first clamping plate 221 may also be set to be circular, elliptical or other geometric shapes, and the rectangular shape is relatively easier to fabricate.

Referring to FIGS. 39 to 41 a first conductive plate 222 for direct contact with a surface of a conductive electrode to conduct an electric current is mounted on the inner side of each of the first clamping plates 221. An elastic pad 229 is also arranged between the first conductive plate 222 and the first clamping plate 221, and the first conductive plate 222 is divided into a plurality of conductive sheets arranged in parallel, and the conductive sheets are formed of copper sheets 2221, for example, in this embodiment, four copper sheets 2221 are divided; the elastic pad 229 is made of elastic materials, such as rubber sheet, silicone rubber sheet, expanded PTFE sheet, graphite pad, asbestos pad, ceramic fiber pad, glass fiber pad, etc.

The electrode clamping assembly 200 of this embodiment operates as follows:

The opening of the electrode clamping assembly 200 is toward the side of the conductive electrode, and the electrode clamping assembly 200 moves to the side of the conductive electrode during operation. When the conductive electrode is in the opening, the hydraulic cylinder is driven to elongate, and the two first clamping arms 230 swing around the fulcrum so that the second ends of the first clamping arms 230 abut against each other, and finally drive the two first clamping plates 221 to clamp on the two opposite surfaces of the conductive electrode. Since the elastic pad 229 is arranged between the first conductive plate 222 and the first clamping plate 221, the first conductive plate 222 can be elastically sunk into the inside of the first clamping plate 221 when pressed, and since the first conductive plate 222 is divided into a plurality of copper sheets 2221 arranged in parallel, each copper sheet 2221 can be independently and adaptively sunk in the area covered by the whole first conductive plate 222, thereby improving the sensitivity of the whole first conductive plate 222 to the surface fluctuation of the conductive electrode, ensuring that the first conductive plate 222 and the surface of the conductive electrode can be tightly adhered and firmly adhered, thereby ensuring stable and good conductive effect. When loosened, the hydraulic cylinder is contracted, and then the second end of the first clamping arm 230 is driven to open, and the first clamping plate 221 is separated from the conductive electrode, thus completing the separation.

Referring to FIGS. 39 to 42, in one embodiment, two first clamping plates 221 are respectively pivoted at the ends of corresponding first clamping arms 230, so that the first clamping plates 221 can swing around the pivot. When the electrode clamping assembly 200 is clamped on the conductive electrode, the two first clamping plates 221 can also swing according to the deviation of the conductive electrode position, thereby reducing excess stress between the electrode clamping assembly 200 and the conductive electrode and improving the service life of the electrode clamping assembly 200.

In the actual production process of Acheson graphite furnace, the position of the conductive electrode will not be in an absolute opposition relationship with the electrode clamping assembly 200, and the conductive electrode itself will have a certain degree of bending deformation due to long-term use. The contact element structure can make up for the poor contact caused by uneven surface of the conductive electrode and eliminate the slight position deviation problem. However, if the overall shape of the conductive electrode has a large bending deformation, there will be a large torsional stress between the electrode clamping assembly 200 and the conductive electrode after clamping, which will consume more energy on the one hand and accelerate the fatigue aging rate of related structural parts on the other hand. The first clamping plate 221 is pivoted at the end of the first clamping arm 230, so that the two first clamping plates 221 can adapt to the deformation of the conductive electrode by swinging at a small angle, thereby eliminating the redundant stress caused by the deformation between the electrode clamping assembly 200 and the conductive electrode, thereby solving the above problems.

Referring further to FIGS. 39 and 42, as a preferred embodiment, the ends of the two first clamping arms 230 away from the first driving member 240 are bent opposite to each other to form a bend portion 2315, and the first clamping plate 221 is connected to the end of the bend portion 2315. The front end of the first clamping arm 230 is arranged to bend slightly inward, which is more conducive to force conduction, and the first clamping plate 221 obtains more movement space inside the first clamping arm 230.

Further, the end of the bending portion 2315 protrudes toward the clamping direction to form a first convex portion 2314, and the first clamping plate 221 is connected to the first convex portion 2314. This arrangement will give the first clamping plate 221 a further movable space inside the first clamping arm 230 and reduce mutual interference between the first clamping plate 221 and the first clamping arm 230 when the first clamping plate 221 swings.

The first clamping assembly 201 of the above embodiment utilizes the lever principle to apply force, that is, the first clamping arm 230 is divided into an upper section and a lower section with the end point of the first supporting frame 210 as a fulcrum, and the purpose of saving energy consumption can be achieved by setting the length ratio of the upper section and the lower section. For example, in a specific embodiment, if the length ratio of the lower section to the upper section is set to 1.5:1, only one part of the force applied to the driving end can apply 1.5 times of the force to the clamping end, thus achieving the purpose of reducing the pressure of the hydraulic cylinder.

Referring to FIG. 39, in the present embodiment, each of the first clamping arms 230 includes two first clamping arms 231 and a limiting position plate 234 fixedly connected between the two first clamping arms 231, the limiting position plate 234 for connecting the two first clamping arms 231 into a whole, the first clamping arms 230 having a frame structure, and the two first clamping arms 230 being symmetrically arranged;

1The first supporting frame 210 is provided with two first supporting plates 211 arranged in parallel, and the two first supporting plates 211 are arranged along the extending direction of the conductive electrodes. Both ends of each first supporting plate 211 are pivoted to a first clamping arm 231 on a corresponding side through a first rotary shaft 250, which forms a fulcrum as described above;
The first driving member 240 includes two, the two first driving members 240 are arranged in parallel, the two ends of each first driving member 240 are respectively hinged to the first end of the first clamping arm 231 on the same side; the two first driving member 240 operate synchronously;
Each of the first clamping plates 221 is pivoted to the end of the first clamping arm 231 on the same side through a second rotary shaft 260 and can be swung about the second rotary shaft 260.

The operating principle of the electrode clamping assembly 200 is as follows:

The electrode clamping assembly 200 opens toward the side of the conductive electrode and moves below the conductive electrode during operation. When the conductive electrode is in the opening, the two hydraulic cylinders are driven and elongated synchronously, and the two first clamping arms 230 swing around the first rotary shaft 250, so that the second ends of the first clamping arms 230 abut against each other, and finally drive the two first clamping plates 221 to clamp on the two opposite surfaces of the conductive electrode. Since the elastic pad 229 is arranged between the first conductive plate 222 and the first clamping plate 221, the first conductive plate 222 can be elastically sunk into the inside of the first clamping plate 221 when pressed, and since the first conductive plate 222 is divided into a plurality of copper sheets 2221 arranged in parallel. each copper sheet 2221 can be independently and adaptively sunk in the area covered by the whole first conductive plate 222. thereby improving the sensitivity of the whole first conductive plate 222 to the surface fluctuation of the conductive electrode. ensuring that the first conductive plate 222 and the surface of the conductive electrode can be tightly adhered and firmly adhered, thereby ensuring stable and good conductive effect. When released, the two hydraulic cylinders contract synchronously, and then the second end of the first clamping arm 230 is driven to open, and the first clamping plate 221 is separated from the conductive electrode, thus completing the separation.

Referring to FIG. 42, the electrode clamping assembly 200 is operated to clamp the conductive electrode located in front of it, so the opening of the electrode clamping assembly 200 faces the conductive electrode side, and the device side is used for connecting the connecting cable and other components. Specifically, each copper sheet 2221 is extended and folded a plurality of times according to the mounting space and finally connected to an external connecting cable.

Referring to FIG. 39, as a preferred embodiment, the electrode clamping assembly 200 is further provided with a first limiting mechanism for limiting the free swing amplitude of the first clamping plate 221 relative to the first clamping arm 230. Specifically, the first limiting mechanism includes a first fixing plate 233, a plurality of first elastomers 280 and a plurality of first limiting bolts 282.

The first fixing plate 233 is fixedly connected to the outside of the first clamping arm 230, specifically between the two first clamping arms 231, and is located outside the first clamping arm 230; and the first fixing plate 233 is perpendicular to the extending direction of the conductive electrode.

The first elastomers 280 have an arcuate sheet shape. One end of each first elastomer 280 is connected to the first fixing plate 233, and the other end extends upward or downward. A plurality of first elastomers 280 are staggered on both sides of the first fixing plate 233, i.e. at least one first elastomer 280 is arranged on the upper and lower sides of the first fixing plate 233, for example, four first elastomers 280, two facing upward and two facing downward, and are staggered from each other. The arched backs of the first elastomers 280 faces outward i.e. the plurality of first elastomers 280 are integrally pointed in a claw shape toward the back of the first clamping plate 221.

Each end of the first elastomer 280 is provided with a screw hole, and the first limit bolt 282 is penetrated into the screw hole, and the length of the first limit bolt 282 passing through the screw hole is adjustable.

The working principle of the first limiting mechanism is as follows:

A plurality of first elastomers 280 are pointed to the back of the first clamping plate 221 in a claw shape, so that when the first clamping plate 221 swings around the second rotary shaft 260, the first elastomer 280 will block the first elastomer 280, thereby limiting the swing amplitude of the first clamping plate 221 and preventing the first clamping plate 221 from swinging at a large angle; the bolt provided at the end of the first elastomer 280 ensures that the first elastomer 280 on the same side holds the first clamping plate 221 synchronously and evenly.

It should be noted that the first clamping assembly 201 utilizing the lever structure adopted in the above-mentioned embodiments is only an optimal embodiment of the present application, but the structure of the first clamping assembly 201 of the present application is not limited thereto. For example, in other embodiments, the first clamping assembly 201 can also be arranged as a V-shaped clamp structure, that is, the first ends of the two first clamping arms 230 are combined and hinged together, the second ends can be opened and closed, and the first driving member 240 is connected between the two first clamping arms 230 (as shown in FIG. 44); no matter how the first clamping assembly 201 is changed, as long as the first clamping plate 221 for contacting the conductive electrode adopts the spirit of the present application, that is, the elastic pad 229 is provided between the first conductive plate 222 and the first clamping plate 221, and the first conductive plate 222 is divided into a plurality of pieces, it should fall within the scope of protection of the present application.

It should be pointed out that the transmission aluminum row is arranged outside the furnace, and it needs to be clamped by the aluminum row splint to realize electrical connection. At this time, the aluminum row splint is in surface contact with the transmission aluminum row. In actual production, the installation position of power transmission aluminum row can not be absolutely accurate, and the perpendicular line of its section deviates from the initial direction more or less; at the same time, due to long-term use, the transmission aluminum row will also bend and deform, resulting in a gap between the transmission aluminum row and the splint of the aluminum row, which can not be tightly adhered, resulting in poor conductivity, and then affecting the final product quality produced by Acheson graphite furnace. In this way, in order to avoid the problem of poor conductive effect caused by the inability of the aluminum row splint and the power transmission aluminum row to be closely attached, the embodiment specifically adopts the following structure to solve the problem.

Since the clamping structure of the electrode clamping assembly 200 is consistent with the clamping structure of the aluminum row clamping assembly 300, the clamping structure of the electrode clamping assembly 200 can also be applied to the clamping structure of the aluminum row clamping assembly 300, and it is not necessary to elaborate here.

### Embodiment 7

Different from the embodiment 5, when the conductive electrode is in a high temperature state (about 300° C.) during operation, heat will be transferred to the electrode clamping plate 220 of the electrode clamping assembly 200 directly connected with the conductive electrode, and the electrode clamping plate 220 will be deformed when heated, thus causing poor contact between the electrode clamping plate 220 and the conductive electrode and affecting the graphitization effect of the conductive electrode. In addition, the aging speed of the electrode clamping plate 220 will be accelerated when the electrode clamping plate 220 is in a high temperature state for a long time. In this way, in order to avoid the problems of poor contact and rapid aging caused by the electrode clamping plate 220 being in a high temperature state for a long time, the present embodiment can also solve the problem by adopting the following configuration

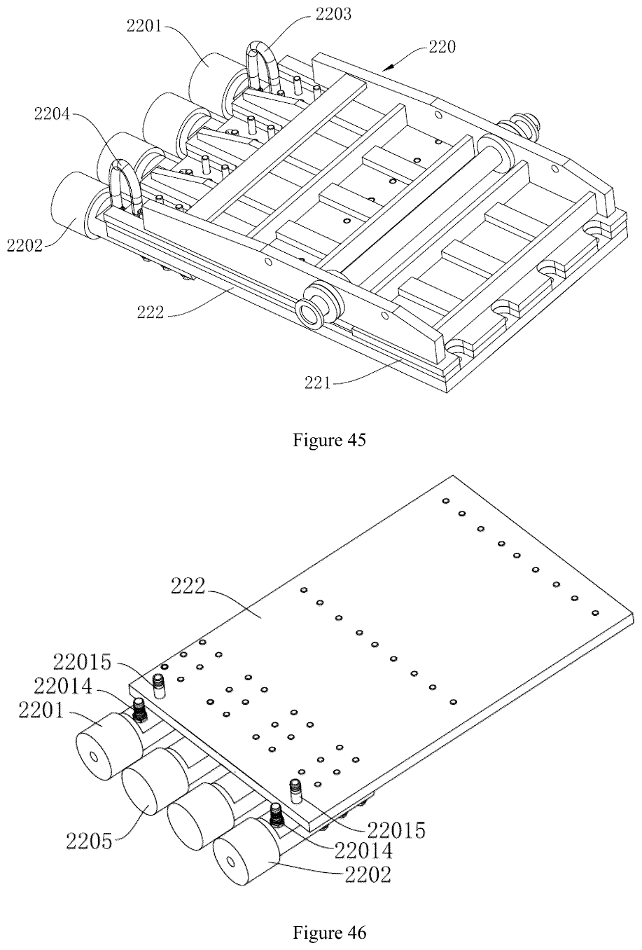

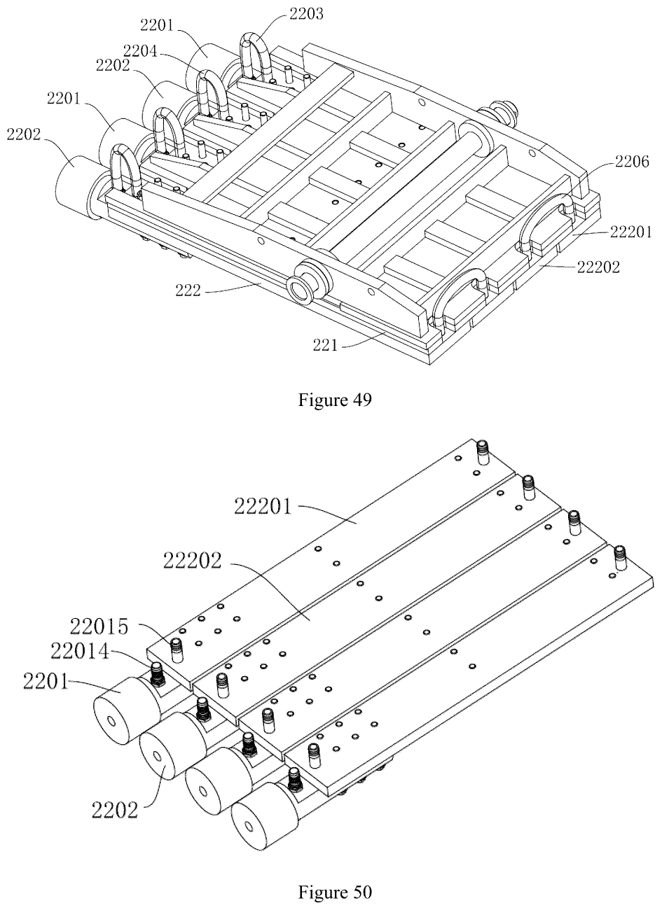

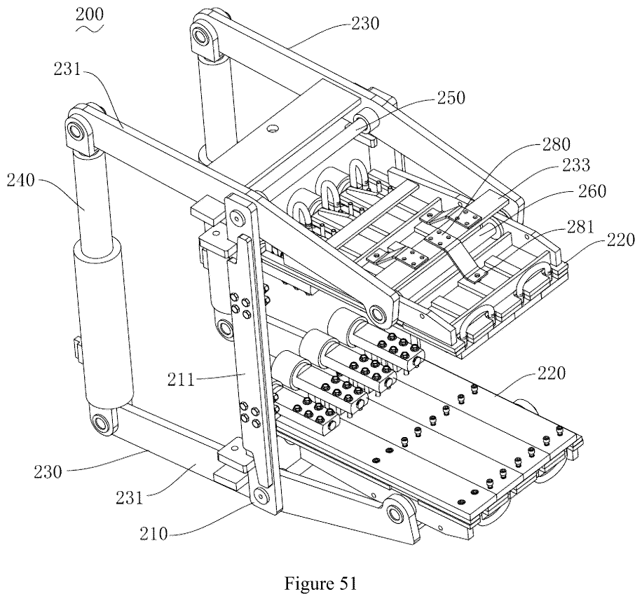

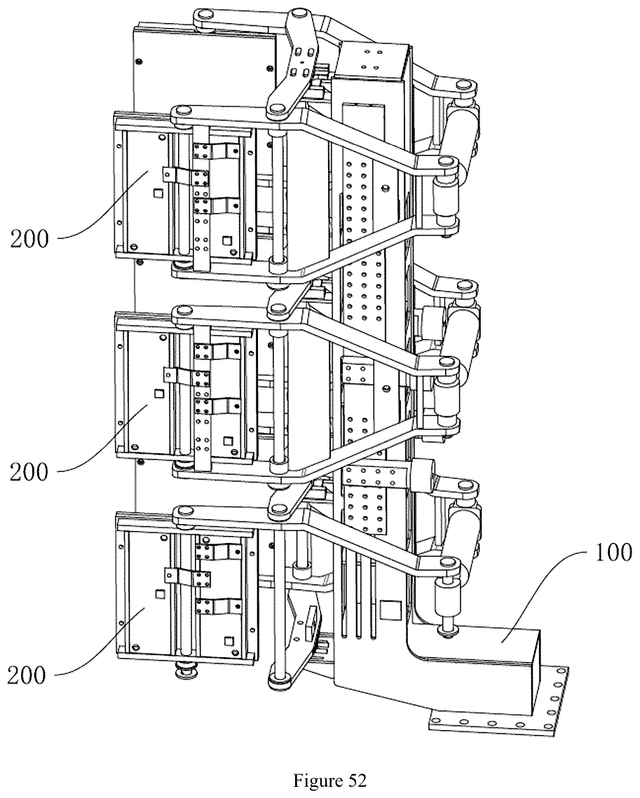

Referring to FIGS. 45 to 51, in the present embodiment, the electrode clamping assembly 200 is a clamp-type structure using a lever principle, and the electrode clamping assembly 200 includes:

Electrode clamping plate 220; the electrode clamping plate 220 is used for clamping conductive electrodes outside the furnace body.

In one embodiment, the electrode clamping assembly 200 further includes:
A first supporting frame 210;
Two first clamping arms 230 respectively hinged with both sides of the first supporting frame 210, and the electrode clamping plates 220 matched and arranged on the first clamping arms 230; and
The first driving member 240 disposed between the two first clamping arms 230 and connected to the two first clamping arms 230 respectively.

Two ends of the first supporting frame 210 are respectively hinged with the middle part of two first clamping arms 230 to form two fulcrums, and the first clamping arms 230 and the first supporting frame 210 are both sheet-shaped and elongated plates: both ends of the first driving member 240 are hinged on the first ends of the two first clamping arms 230, and the second ends of the two first clamping arms 230 can be opened and closed around the fulcrum under the driving of the first driving member 240. Hydraulic cylinder is selected as the first driving member 240 in this embodiment. Of course, in other embodiments screw lead drive, cylinder drive and the like may be used and will not be described here.

In this embodiment, each first clamping arm 230 includes two first clamping arms 231 and a first limiting plate 234 fixedly connected between the two first clamping arms 231, the first limiting plate 234 is used for connecting the two first clamping arms 231 into a whole, the first clamping arm 230 has a frame structure, and the two first clamping arms 230 are symmetrically arranged;
The first supporting frame 210 is provided with two first supporting plates 211 arranged in parallel, and the two first supporting plates 211 are arranged in parallel. Both ends of each first supporting plate 211 are pivoted to a first clamping arm 231 on a corresponding side through a first rotary shaft 250, which forms a fulcrum as described above;
The first driving member 240 includes two, the two first driving members 240 are arranged in parallel, the two ends of each first driving member 240 are respectively hinged to the first end of the first clamping arm 231 on the same side; the two first driving member 240 operate synchronously;
Each of the first clamping plates 221 is pivoted to the end of the first clamping arm 231 on the same side through a second rotary shaft 260 and can be swung about the second rotary shaft 260.

The electrode clamping plate 220 comprises a first clamping plate 221 and a first conductive plate 222, the first conductive plate 222 is fixed on the first clamping plate 221 by bolts, the first conductive end 2201 and the second conductive end 2202 are fixed on the first conductive plate 222 by bolts, one end of the first conductive end 2201 and the second conductive end 2202 are arranged on the first conductive plate 222 so as to connect with the external water-cooled cable, the first conductive end 2201 and the second conductive end 2202 are used to transfer the electricity from the conductive electrode to the first conductive plate 222 through the water-cooled cable, and the first conductive end 2201 and the second conductive end 2202 are used to transfer the electricity to the power transmission vehicle device for use; in addition, the first conductive end 2201 is also used for receiving the cooling water delivered from the external water supply device through the water-cooling cable, and the second conductive end 2202 is used for returning the cooling water to the external water supply device through the water-cooling cable, thereby realizing the recycling effect of the cooling water; specifically, both the first conductive end 2201 and the second conductive end 2202 are provided with an integrally formed connecting part 22011 for connecting with the water-cooled cable and a bonding part 22012 arranged on the first conductive plate 222, so that both the first conductive end 2201 and the second conductive end 2202 form an electrical connection relationship with the first conductive plate 222: in addition, by directly connecting the first conductive end 2201 and the second conductive end 2202 to the first conductive plate 222, the connection through other intermediate structures is avoided, thereby effectively saving assembly parts, thereby reducing the manufacturing cost. In addition, the cooling water path of the electrode clamping plate 220 is redesigned in coordination with the connection effect of the external water-cooling cable and the first conductive end 2201 and the second conductive end 2202, and the cooling water flow path is effectively reduced on the premise of ensuring that the cooling efficiency is not reduced.

The first conductive end 2201 is arranged in communication with the first conductive plate 222 through the first flow guide tube 2203, the second conductive end 2202 is arranged in communication with the first conductive plate 222 through the second flow guide tube 2204, the first conductive plate 222 is provided with a cooling channel for flowing through cooling water, so that the cooling water enters the first conductive plate 222 through the first flow guide tube 2203, and then flows out through the cooling channel and the second flow guide tube 2204 to realize the cooling operation of the first conductive plate 222, effectively carrying out the cooling operation on the first conductive plate 222, so that the electrode clamping plates 220 will not be in a high-temperature working state for a long time, thereby prolonging the service life of the electrode clamping plates 220; specifically, one end of the first guide pipe 2203 is connected to the first conductive end 2201, and the other end of the first guide pipe 2203 is connected to the first conductive plate 222, so that cooling water delivered by the water-cooling cable is delivered to the first conductive plate 222 through the first conductive end 2201 and the first guide pipe 2203; one end of the second guide pipe 2204 is connected with the second conductive end 2202, and the other end of the second guide pipe 2204 is connected with the first conductive plate 222, so that the cooling water flowing through the first conductive plate 222 is returned to the external water supply device through the second guide pipe 2204, the second conductive end 2202 and the water cooling cable, thereby realizing the recycling effect of the cooling water.

Further, both the first conductive end 2201 and the second conductive end 2202 are provided with a water flow path 22013, and the water flow path 22013 is used for cooling water to flow between the first conductive plate 222 and the corresponding water-cooling cable through the corresponding first guide pipe 2203 and the corresponding second guide pipe 2204; specifically, the water flow path 22013 in the first conductive end 2201 is used for sending the cooling water delivered from the external water-cooling cable to the first conductive plate 222 through the first guide pipe 2203, and the second conductive end 2202 is used for returning the cooling water in the first conductive plate 222 to the corresponding water-cooling cable through the second guide pipe 2204.

In one embodiment, both the first conductive end 2201 and the second conductive end 2202 are provided with a first draft tube 22014 connected with the water flow path 22013, the first draft tube 22014 is used for connecting with the corresponding first and second draft tubes 2203 and 2204, and the first draft tube 22014 is arranged outside the first conductive end 2201 and the second conductive end 2202 to facilitate connection with the corresponding first and second draft tubes 2203 and 2204.

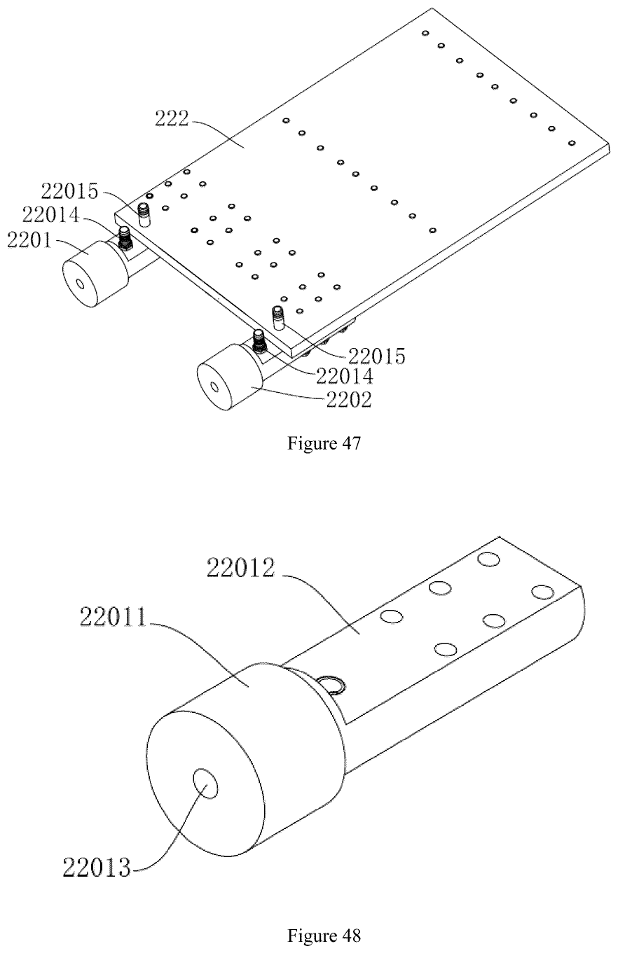

As shown in FIGS. 46 and 47, in one embodiment, the first conductive plate 222 is provided with a second drain tube 22015 connected with the cooling channel, the second drain tube 22015 is arranged for connecting with the corresponding first guide tube 2203 and the second guide tube 2204, and the second drain tube 22015 is arranged outside the first conductive plate 222 so as to facilitate connection with the corresponding first guide tube 2203 and the second guide tube 2204.

In one embodiment, the first conductive plate 222 is integrally formed, the cooling channel is arranged in the first conductive plate 222 in a serpentine shape, the water inlet end of the cooling channel is connected with the first draft tube 2203, and the water outlet end of the cooling channel is connected with the second draft tube 2204. The specific fixed positions of the first conductive end 2201 and the second conductive end 2202 on the first conductive plate 222 are not limited, and the first conductive end 2201 and the second conductive end 2202 can be arranged on the same side of the first conductive plate 222 or on different sides of the first conductive plate 222 as required: in other embodiments, the cooling channels may be arranged in the first conductive plate 222 in other curved shapes, which are not enumerated herein, to facilitate the flow of cooling water into or out of the first conductive plate 222; in this embodiment, the first conductive plate 222 can be provided with a plurality of first conductive ends 2201 and a second conductive end 2202, and the cooling water supply to the first conductive plate 222 can be realized through a plurality of water cooling cables at the same time. In addition, the third conductive end 2205 can be provided to connect with the first conductive plate 222, and the third conductive end 2205 does not need to provide a water flow path 22013. but only needs to conduct electricity delivered from the conductive electrode through the cable, so as to further ensure a stable electrical connection relationship between the conductive electrode and the first conductive plate 222.

Alternatively, the first conductive plate 222 includes at least one first conductive plate 22201 and at least one second conductive plate 22202, wherein, both the first conductive plate 22201 and the second conductive plate 22202 are made of copper sheet, the first conductive plate 22201 and the second conductive plate 22202 are arranged side by side, the first conductive end 2201 is fixedly connected to the first conductive plate 22201 through bolts, and the second conductive end 2202 is fixedly connected to the second conductive plate 22202 through bolts; one end of the first guide pipe 2203 is connected with the first conductive end 2201, the other end of the first guide pipe 2203 is connected with the first conductive piece 22201, the second guide pipe 2204 is connected with the second conductive end 2202, the other end of the second guide pipe 2204 is connected with the second conductive piece 22202, and the first conductive piece 22201 and the second conductive piece 22202 are connected with the second conductive piece 22202 through the third guide pipe 2206, so that the cooling water delivered by the water-cooled cable is delivered to the first conductive piece 22201 through the first conductive end 2201, the first guide pipe 2203. Then, the cooling water flows back to the external water supply apparatus through the third guide pipe 2206, the second conductive piece 22202, the second guide pipe 2204, the second conductive end 2202, and the water-cooled cable in sequence, so that the cooling operation is effectively performed on the first conductive sheet 22201 and the second conductive sheet 22202 while cyclic utilization of the cooling water are achieved, so that the electrode clamping plate 220 is not in a high-temperature working state for a long time, thereby improving the service life of the electrode clamping plate 220.

In one embodiment, the first conducting plate 22201 and the second conducting plate 22202 are longitudinally disposed on the first clamping plate 221, the arrangement of the first conducting plate 22201 and the second conducting plate 22202 on the first clamping plate 221 is not limited, and the first conducting plate 22201 and the second conducting plate 22202 may be alternately arranged on the first clamping plate 221, alternatively, at least two first conductive plates 22201 are arranged side by side and then crossed with the second conductive plates 22202 on the first clamping plate 221. The first guide pipe 2203 is used to transfer cooling water, and the third guide pipe 2206 is used to allow cooling water to flow between the first conductive sheet 22201 and the second conductive sheet 22202, the second guide pipe 2204 is used to return the cooling water, so that the first conductive plate 222 is effectively cooled. As a result, the electrode clamping plate 220 will not be operated at a high temperature for a long time, thereby prolonging the service life of the electrode clamping plate 220.

In one embodiment, the first conductive sheet 22201 is provided with a first cooling channel, and the second conductive sheet 22202 is provided with a second cooling channel. The first cooling channel is arranged in the first conductive sheet 22201 in a linear manner, and the second cooling channel is arranged in the second conductive sheet 22202 in a linear manner. In this embodiment, the cooling channel consists of the first cooling channel, the second cooling channel and the third draft tube 2206; in the first conductive sheet 22201, the water inlet end of the first cooling channel is connected with the first flow guide pipe 2203, and the water outlet end of the first cooling channel is connected with the third flow guide pipe 2206; in the second conductive sheet 22202, the water inlet end of the second cooling channel is connected with the third flow guide tube 2206, and the water outlet end of the second cooling channel is connected with the second flow guide tube 2204. The first flow guide tube 2203 is used to transport the cooling water, and the third flow guide tube 2206 is used to realize the circulation of the cooling water between the first conductive sheet 22201 and the second conductive sheet 22202, and the second flow guide tube 2204 is used to realize the backflow operation of the cooling water, so that the first conductive sheet 222 is effectively cooled, so that the electrode clamping plate 220 is not in a high-temperature working state for a long time, and the service life of the electrode clamping plate 220 is prolonged. In other embodiments, the first cooling channel and the second cooling channel may also be arranged in the corresponding first conductive sheet 22201 and the second conductive sheet 22202 in a curved shape such as a serpentine shape, which are not listed here to facilitate the flow of cooling water into or out of the first conductive sheet 22201 or the second conductive sheet 22202.

Furthermore, in order to increase the flow path of cooling water in the first conductive plate 222 and improve the cooling efficiency of the first conductive plate 22201 and the second conductive plate 22202, the following methods can be adopted; the first flow guide pipe 2203 and the second flow guide pipe 2204 are respectively arranged at one end of the first conductive plate 22201 and one end of the second conductive plate 22202, and the two ends of the third flow guide pipe 2206 are respectively connected with the other end of the first conductive plate 22201 and the other end of the second conductive plate 22202, so that the cooling water path flowing through the first conductive plate 22201 and the second conductive plate 22202 forms a U-shaped structure, effectively increasing the total flow path of cooling water in the first conductive plate 22201 and the second conductive plate 22202 to improve their cooling efficiency.

In one embodiment, in order to ensure the smooth flow of cooling water from the first conductive end 2201 to the first conductive plate 222 and from the first conductive plate 222 to the second conductive end 2202, the first draft tube 2203 and the second draft tube 2204 are U-shaped; in order to ensure smooth flow of cooling water from the first conductive sheet 22201 to the second conductive sheet 22202, the third draft tube 2206 has a U-shaped configuration.

In one embodiment, in order to facilitate the installation of the first, second and third draft tubes 2203. 2204 and 2206. the first clamping plate 221 is provided with slotted structures at the places matched with the first, second and third draft tubes 2203. 2204 and 2206, respectively, so as to facilitate the first, second and third draft tubes 2203, 2204 and 2206 to be connected and arranged with the first conductive plate 222 after avoiding the barrier of the solid structure part of the first clamping plate 221.

Taking the first conductive plate 222 including at least one first conductive plate 22201 and at least one second conductive plate 22202 as an example, when the electrode clamping plate 220 of the utility model works, the electrode clamping plate 220 is connected with the conductive electrode, and the conductive electrode transmits electricity to the power transmission vehicle device through the electrode clamping plate 220, and the current flowing through the electrode clamping plate 220 will make the first conductive plate 222 heat up; at this time, the external water supply device is turned on, and the cooling water is transported to the first conductive sheet 22201 through the first conductive end 2201 and the first guide pipe 2203 through the water-cooling cable, and then the cooling water is transported from the first conductive sheet 22201 to the second conductive sheet 22202 through the third guide pipe 2206, and finally the cooling water in the second conductive sheet 22202 is returned to the external water supply device through the second guide pipe 2204, the second conductive end 2202 and the water-cooling cable, so that the first conductive sheet 22201 and the second conductive sheet 22202 are effectively cooled, so that the electrode clamping plate 220 is not in a high-temperature working state for a long time, thus prolonging the service life of the electrode clamping plate 220 and realizing the recycling effect of cooling water.

It should be pointed out that in the process of transmitting electricity to the conductive electrode through the aluminum row plate, the aluminum row plate will generate a lot of heat in the working process, so that the aluminum row plate will continue to be in a high temperature state (100° C.˜300° C.), and the aluminum row plate will deform when heated, which will lead to poor contact between the aluminum row plate and the power transmission aluminum row and affect the graphitization effect of the conductive electrode. In addition, the aluminum row plate will be in a high temperature state for a long time. which will aggravate the rapid aging of the aluminum row plate and is not conducive to the improvement of the service life of the aluminum row plate. In this way, in order to avoid the problems of poor contact and rapid aging caused by the aluminum row plate being in a high temperature state for a long time, the embodiment can specifically adopt the following structure to solve the problems.

Since the cooling structure of the electrode clamping assembly 200 is consistent with the cooling structure of the aluminum row clamping assembly 300, the cooling structure applied to the electrode clamping assembly 200 can also be applied to the aluminum row clamping assembly 300, and it is not necessary to elaborate here.

### Embodiment 8

Different from conventional workpieces, the distance between the track of power transmission vehicle device and Acheson graphite furnace is usually designed as a fixed value. However, due to the limitation of the facility layout and the environment of some Acheson graphite furnaces, the distance between the track of power transmission vehicle device and Acheson graphite furnace has to be greater than this fixed value, which makes the contact area between the electrode clamping assembly 200 and the conductive electrode too small or even unable to contact even after the vertical columnar strut 100 moves to the limit position, thus unable to clamp the conductive electrode and poor power transmission stability. In this way, in order to solve the technical problems that the contact area between the electrode clamping assembly 200 and the conductive electrode is too small or even unable to contact due to the limitation of the facility layout of some Acheson graphite furnaces and the environmental site, and thus the conductive electrode cannot be clamped and the power transmission stability is poor, the present embodiment specifically adopts the following structure to solve the technical problems.

The strut 100 of the electrode clamping mechanism 2000 in the present application is one of the important components of power transmission vehicle device, and its main working mode is that the electrode clamping assembly 200 arranged on the strut 100 is moved back and forth through the sliding mechanism 400 to adjust the relative position between the electrode clamping assembly 200 and the conductive electrode at one end of the furnace body (furnace head and furnace tail), and the electrode clamping assembly 200 can clamp the conductive electrode when the position is appropriate.

Hereinafter a specific configuration of the strut 100 of the electrode clamping mechanism 2000 will be mainly described.

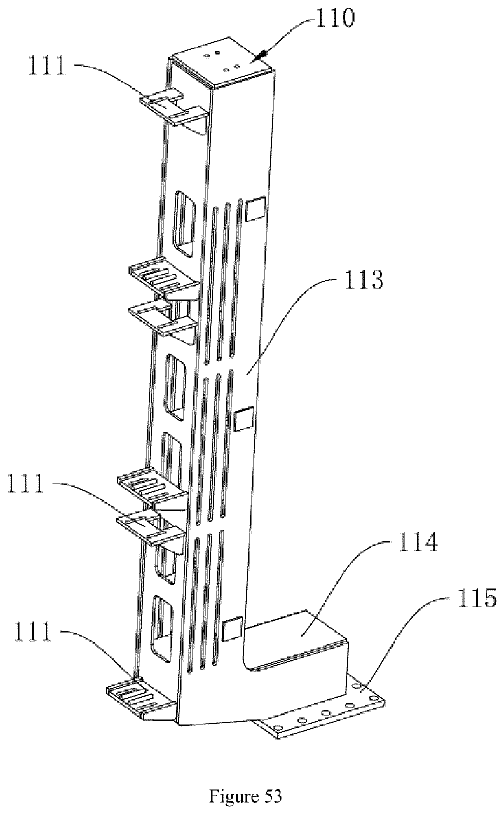

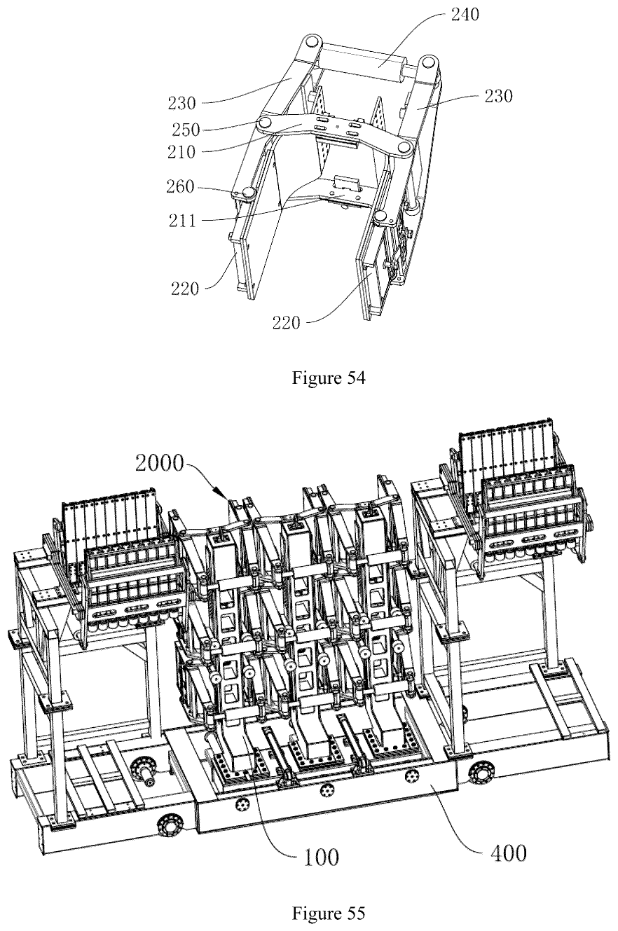

Referring to FIGS. 52-55, the strut 100 includes a base pillar 110 including a pillar 113 and a cross bar 114 connected to the pillar 113 and perpendicular to each other;

The crossbar 114 extends toward the Acheson graphite furnace.

In this embodiment, the base pillar 110 may be divided into two parts; the pillar body 113 and the cross bar 114, which are fixedly connected, and the connection mode is not limited to integral molding, welding, bolt connection, etc.

The pillar 113 here is similar to the support pillar in the prior art and may be either a regular vertical pillar or an irregular vertical pillar. For example, as shown in FIG. 52, the bottom of the pillar 113 may be designed in a ramp shape (bevel shape) or other shape.

The pillar 113 and the cross-bar 114 are perpendicular to each other and together form an L-shaped base pillar 110. For the L-shaped base pillar 110, each of the pillar 113 and the cross-bar 114 is one.

The pillars 113 and the cross bars 114 are perpendicular to each other and may together form a base pillar 110 similar to the H-type. For the base pillar 110 similar to the H-type, the pillars 113 may be two having different lengths and the cross bars 114 may be one.

See FIG. 52.

In a preferred embodiment, the lower end of the pillar 113 is connected to the cross bar 114.

The lower end of the pillar body 113 is fixedly connected to the crossbar 114, i.e. the pillar 110 is similar to the L-shaped strut 110. With the pillar 110 similar to the L-shaped, a better outward extension of the pillar and the electrode clamping assembly 200 (toward the Acheson graphite furnace) can be achieved with less material and a simpler structure, and an excessive force on the outward extension side does not cause the power transmission vehicle device to tilt and the vehicle is more stable.

Further, in one embodiment, the length of the pillar 113 is L1, the length of the cross bar 114 is L2, and L1:L2=3 to 5: 1.

In order to overcome the defect that the distance between the electrode clamping assembly 200 and the conductive electrode is not enough, the volume of the whole power transmission vehicle device can be more suitable for the field environment without excessive occupation, and the tilt caused by excessive change of the force on the vehicle during the outward movement of the base pillar 110 can be prevented according to the actual needs of the power transmission vehicle device. In this embodiment, it is preferable to set the length ratio between the pillar 113 and the cross bar 114 to 3 to 5:1, so as to achieve the above technical effect, ensure that the volume of the power transmission vehicle device is not too large and the vehicle is stable, and facilitate the inward retraction of the base pillar 110 to the power transmission vehicle device after the power transmission is finished, so as to facilitate the subsequent loading and transportation of the power transmission vehicle device.

See FIG. 52.

In one embodiment, the cross bar 114 is provided with a mounting seat 115. The mounting seat 115 is provided below the tail portion of the base pillar 110 that is below the cross bar 114. Specifically, the mounting seat 115 may be welded below the cross bar 114 and mounted on the sliding mechanism 400 so that the base pillar 110 can move together with the sliding mechanism 400.

Further, in one embodiment, the pillar 113 and the cross bar 114 are integrally formed. That is the pillar 113 and the cross bar 114 may be machined as a whole to form the base pillar 110 together. With the integrally formed base pillar 110, the stress degree of the base pillar 110 is improved, the base strut 110 is not easy to break, and the service life is longer.

In another embodiment, the pillar 113 is welded to one side of the cross bar 114. The pillar 113 and the cross bar 114 may also be relatively independent and are fixed by welding to form the base pillar 110. Further, the pillar 113 and the cross bar 114 may be fixedly connected together by providing bolts and threaded holes between them, respectively, and may be fixedly connected together by other means, which will not be described here.

By fixing the pillar 113 and the cross bar 114 together by welding or other connection methods, it is more convenient to design the base pillar 110 according to actual needs, and the pillar 113 and the cross bar 114 with different lengths can be selectively fixedly connected together, thus better adapting to the relative fixed distance between the power transmission vehicle device and the Acheson graphite furnace, and thus enabling the electrode clamping assembly 200 to reach the position where the conductive electrodes are located and clamped according to different use scenarios of the power transmission vehicle device. For example, if the fixed distance between the power transmission vehicle device and the Acheson graphite furnace is longer, the length of the crossbar 114 may be increased accordingly, so that the electrode clamping assembly 200 may be extended for a longer distance when the base strut 110 is moved.

In one embodiment, a plurality of supporting block groups is provided at intervals on the side of the pillar 113 away from the cross bar 114, and each supporting block group is composed of two supporting blocks 111 arranged in parallel.

It should be noted that the supporting block 111 may be welded or bolted fixedly to the side of the pillar 113 away from the cross bar 114.

One set of supporting blocks 111 is used to receive one electrode clamping assembly 200 so that a plurality of sets of supporting blocks 111 can be provided on the pillar 113 to receive a plurality of electrode clamping assemblies 200.

The spacing distance between the two supporting block groups and the spacing distance between the two supporting blocks 111 of each supporting block group can be designed according to actual needs and are not limited here.

In the present application, a cross bar 114 is arranged on the base pillar 110 in the electrode clamping mechanism 2000. and the cross bar 114 is connected with the pillar 113, and the two are perpendicular to each other; the crossbar 114 extends toward the Acheson graphite furnace. Therefore, the electrode clamping assembly 200 extends towards the Acheson graphite furnace for a longer distance under the drive of the base strut 110, and then the electrode clamping assembly 200 can reach the position where the conductive electrode is located, and the conductive electrode can be clamped to stably send electricity to complete graphitization of the conductive electrode.

In one embodiment, the electrode clamping assembly 200 is disposed on the strut 100.

Specifically, the electrode clamping assembly 200 includes:
A first supporting frame 210 for being disposed on the strut 100;
Two opposite electrode clamping plates 220; wherein, the two electrode clamping plates 220 jointly realize the clamping operation of the conductive electrodes on the furnace;
Two first clamping arms 230 respectively hinged with both sides of the first supporting frame 210, and two electrode clamping plates 220 are respectively arranged on the two first clamping arms 230; and
The first driving member 240 disposed between the two first clamping arms 230 and connected to the two first clamping arms 230 respectively.

Two sides of the first supporting frame 210 are respectively hinged with the middle parts of two first clamping arms 230 to form two fulcrums, and the first clamping arm 230 and the first supporting frame 210 are both sheet-shaped and elongated plates; the two ends of the first driving member 240 are respectively articulated at the first ends of the two first clamping arms 230, and the second ends of the two first clamping arms 230 are driven by the first driving member 240 to make opening and closing movement around the fulcrum, thereby driving the two electrode clamping plates 220 to approach or move away from each other, thus realizing clamping or loosening operation of the conductive electrodes. Hydraulic cylinder is selected as the first driving member 240 in this embodiment. Of course, in other embodiments screw lead drive, cylinder drive and the like may be used and will not be described here.

Both sides of the first supporting frame 210 are respectively hinged with the first clamping arm 230 on the corresponding side through a first rotary shaft 250 which forms the fulcrum as described above.

Each electrode clamping plate 220 is hinged to an end of the first clamping arm 230 on a corresponding side through a second rotary shaft 260 and can be swung around the second rotary shaft 260.

The first supporting frame 210 includes two first supporting plates 211 arranged in parallel, the top and the bottom end of the electrode clamping assembly 200 are respectively arranged on the first supporting plate 211, the two first supporting plates 211 are respectively arranged on the two supporting blocks 111, and the top and the bottom end of the first rotary shaft 250 are respectively arranged through the two first supporting plates 211, thereby improving the stability of the connection between the first clamping arm 230 and the first supporting plate 211.

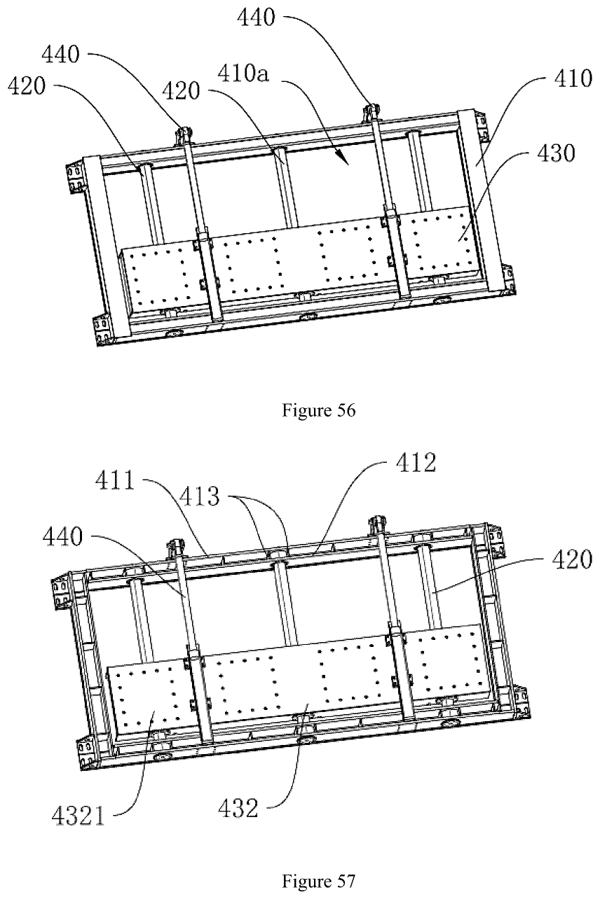

Referring to FIGS. 55 to 58, a specific configuration of the sliding mechanism 400 will be mainly described below.

The sliding mechanism 400 is used for driving the electrode clamping mechanism 2000 to move. The sliding mechanism 400 includes a supporting frame 410, at least one supporting shaft 420, a moving mechanism 430 and a driving mechanism 440. A moving space 410a suitable for the electrode clamping mechanism 2000 is formed inside the supporting frame 410. At least one supporting shaft 420 is located in the moving space 410a and is connected to the supporting frame 410. The moving mechanism 430 is positioned within the moving space 410a and movably disposed with respect to the supporting shaft 420 and is configured to support the connection of electrode clamping mechanism 2000. A driving mechanism 440 is provided on the supporting frame 410 and is driven and connected with the moving mechanism 430. The driving mechanism 440 is configured to drive the moving mechanism 430 to drive the electrode clamping mechanism 2000 to move in the axial direction of the supporting shaft 420.

In the sliding mechanism 400 provided in the embodiment of this specification, the supporting frame 410 can support the supporting shaft 420, the moving mechanism 430, and the driving mechanism 440, and can also provide a corresponding space for the movement of the moving mechanism 430, that is, a moving space 410a. The supporting shaft 420 is positioned in the moving space 410a and connected to the supporting frame 410 to provide support and guidance for the moving mechanism 430. The moving mechanism 430 is located in the moving space 410a of the supporting frame 410, and the driving mechanism 440 can drive the moving mechanism 430 to move relative to the supporting shaft 420, so that the moving mechanism 430 can drive the electrode clamping mechanism 2000 to move relative to the vehicle body 1000 of the power transmission vehicle device. Therefore, the position of the electrode clamping mechanism 2000 of the power transmission vehicle device can be quickly adjusted by the sliding mechanism 400 of the embodiment of the present specification to facilitate clamping of the conductive electrode even if the area of the production workshop is limited, thereby reducing the difficulty of clamping the conductive electrode by the electrode clamping mechanism 2000 and improving the power transmission efficiency.

In the embodiment of the present specification, a moving space 410a suitable for the electrode clamping mechanism 2000 is formed inside the supporting frame 410, and it can be understood that the supporting frame 410 can provide a space for accommodating the moving mechanism 430 to move inside it, so that the moving mechanism 430 can drive the electrode clamping mechanism 2000 to move in a direction parallel to a horizontal plane within the moving space 410a. The strong structural strength of the supporting frame 410 can provide better supporting stability while the moving mechanism 430 drives the electrode holding mechanism 2000 to move, thereby contributing to improving the moving stability of the moving mechanism 430.

Referring to FIG. 57, in some embodiments the supporting frame 410 includes a first supporting frame 411, a second supporting frame 412 and a stiffening member 413; the second supporting frame 412 is positioned in the first supporting frame 411 and a moving space 410a is formed inside the second supporting frame 412. The stiffening member 413 is connected between the first supporting frame 411 and the second supporting frame 412; the supporting shaft 420 is connected to the first supporting frame 411 and/or the second supporting frame 412.

In the above embodiment, the supporting frame 410 includes a first supporting frame 411 and a second supporting frame 412 located in the first supporting frame 411. The arrangement of the first supporting frame 411 and the second supporting frame 412 can improve the structural strength of the supporting frame 410, and the stiffening member 413 is connected between the first supporting frame 411 and the second supporting frame 412, which can further improve the structural strength of the supporting frame 410, thus enabling the supporting frame 410 to have good supporting stability. thereby contributing to improving the stability of the moving mechanism 430 when driving the electrode clamping mechanism 2000 to move.

In addition, the shapes and materials of the first supporting frame 411 and the second supporting frame 412 can also contribute to improving the overall structural strength of the supporting frame 410. In some embodiments the first supporting frame 411 and the second supporting frame 412 have an annular shape which can further improve the overall structural strength of the supporting frame 410. In other embodiments the first supporting frame 411 and the second supporting frame 412 may be made of a metallic material such as copper, aluminum or an alloy thereof. In some embodiments of the present application. copper-aluminum or iron-aluminum alloy may be used based on a combination of weight and structural strength of the supporting frame 410.

In the embodiment of the present specification, the sliding mechanism 400 is mounted to the vehicle body 1000 of the power transmission vehicle device through the above-mentioned supporting frame 410, and the supporting frame 410 can be mounted in any manner well known in the art, such as welding, riveting, and the like. In some embodiments, the moving mechanism 430 includes a moving frame 431 and a supporting connection member 432. The moving frame 431 is movably connected to the supporting shaft 420. The supporting connection member 432 is connected to the moving frame 431 and has at least one supporting connection surface 4321 configured to support the connection of electrode clamping mechanism 2000. The driving mechanism 440 is in drive connection with at least one of the moving frames 431 and the supporting connection member 432.

In the above-described embodiment, the moving frame 431 can drive the supporting connecting member 432 to move stably relative to the supporting shaft 420 under the driving action of the driving mechanism 440, wherein the supporting connection member 432 has a supporting connection surface 4321 for supporting and connecting the electrode clamping mechanism 2000, so that the moving stability of the electrode clamping mechanism 2000 driven by the moving mechanism 430 can be improved.

As can be seen from some of the above-mentioned embodiments, the structural strength of the supporting frame 410 affects the stability of the supporting frame and thus the stability of the moving mechanism 430 when moving the electrode clamping mechanism 2000. Thus, the structural strength of the moving frame 431 also affects the moving stability of the moving mechanism 430 by affecting its own supporting stability.

In embodiments of the present specification, the shape and material of the moving frame 431 can help improve its overall structural strength. In some embodiments the moving frame 431 has an annular shape which can further improve the overall structural strength of the moving frame 431. In other embodiments, the moving frame 431 may be made of a metallic material such as copper, aluminum or an alloy thereof or the like. In some embodiments of the present application, copper-aluminum or iron-aluminum alloy may be used based on a combination of weight and structural strength of the moving frame 431.

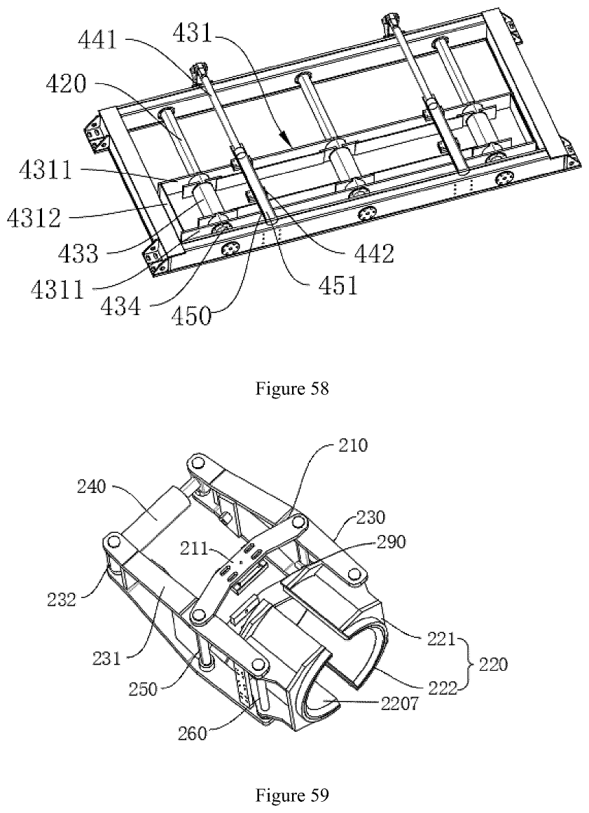

Further referring to FIG. 58, in some embodiments, the moving frame 431 includes two first moving members 4311 and two second moving members 4312. Two first moving members 4311 are arranged in parallel in the axial direction of the supporting shaft 420, and the two first moving members 4311 are provided with first sliding holes at respective relative positions; two second moving members 4312 are respectively connected between the two first moving members 4311; the supporting shaft 420 is positioned between the two second moving members 4312 and arranged in parallel with the second moving member 4312, and is connected with the supporting frame 410 through the first sliding hole.

In the above embodiment, the moving frame 431 includes two first moving members 4311 and two second moving members 4312, and the proper arrangement of the moving members can further improve the moving stability of the moving frame 431, thereby helping to drive the electrode clamping mechanism 2000 to accurately clamp the conductive electrode.

The sliding hole may be provided on the second moving member 4312 and the specific arrangement of the sliding hole needs to be selected according to the moving direction of the electrode clamping mechanism 2000. The number of sliding holes on each moving member is adapted to the number of supporting shafts 420, and the number of sliding holes in the embodiment of the present specification is not specifically limited, and may be 2, 3, or even more than 3.

In some embodiments, the first moving member 4311 and the second moving member 4312 have a plate-like structure which can reduce the weight of the moving frame 431, thereby reducing the energy consumption for driving the moving frame 431 to move.

In some embodiments, the supporting connection member 432 also has a plate-like structure and the supporting connection member 432 has a plurality of supporting connection surfaces 4321 and an area between two adjacent supporting connection surfaces 4321 may be used to connect the drive mechanism 440.

In the above-described embodiments, the number of supporting connection surfaces 4321 provided by the supporting connection member 432 is compatible with the number of conductive electrodes of the Acheson graphitization furnace arranged in the transverse direction. For example, if the number of conductive electrodes of the Acheson graphite furnace arranged in the transverse direction is four, the supporting connection member 432 has four supporting connection surfaces 4321.

Referring further to FIG. 58, in some embodiments, the moving mechanism 430 also includes a sliding sleeve 433 and at least one flange 434. A sliding sleeve 433 is sleeved outside the supporting shaft 420. At least one flange 434 is disposed coaxially with the sliding sleeve 433, and the flange 434 is connected between the end of the sliding sleeve 433 and the first moving member 4311.

In the above-described embodiments, the arrangement of the sliding sleeve 433 can reduce friction between the first moving member 4311 and the supporting shaft 420 to help the first moving member 4311 move in the axial direction of the supporting shaft 420, while the flange 434 is connected between the end of the sliding sleeve 433 and the first moving member 4311, which can reduce the collision of the first moving member 4311 with other members during movement.

Referring further to FIG. 58, in some embodiments, the driving mechanism 440 includes a driving member 441 and a connecting member 442. A driving member 441 is provided on the supporting frame 410. The connecting member 442 is connected between the driving member 441 and the moving mechanism 430.

In embodiments of the present specification, the driving member 441 may be a power providing component well known in the art. For example, in some examples, the driving member 441 may be a motor. In other examples, the driving member 441 may also be a cylinder.

The connecting member 442 may also be a member well known in the art that can provide a connecting function. For example, in some examples, the connecting member 442 may be a connecting base.

With continued reference to FIG. 58, in some embodiments the sliding mechanism 400 further includes a stopper portion 450 coupled between the connecting member 442 and the driving part 441 and the stopper portion 450 configured to restrict movement of the moving mechanism 430 within the moving space 410a.

In the above-described embodiments, the stopper portion 450 can limit the movement of the moving mechanism 430 in the axial direction of the supporting shaft 420, and on the one hand, it can prohibit the moving mechanism 430 from falling off the moving space 410a, and on the other hand, it can limit the movement distance of the moving mechanism 430 in the axial direction of the supporting shaft 420 to further reduce the collision with other parts during the movement.

Referring again to FIG. 58, in some embodiments, the stopper portion 450 has a stopping groove 451 extending in the axial direction of the stopper portion 450, wherein the driving member 441 cooperates with the stopping groove 451 so that the driving member 441 drives the moving mechanism 430 to move.

In some embodiments, both ends of the stopping groove 451 are closed.

### Embodiment 9

Different from the conventional workpiece, when the power transmission vehicle device is transmitting electricity to

Acheson graphite furnace, the clamping surface of the electrode clamping plate 220 is generally flat to clamp on the two sides of the conductive electrode in order to adapt to its square pillar structure. However, when the surface of the clamped conductive electrode is curved, the contact area between the electrode clamping plate 220 and the conductive electrode in the general flat design is very small, and the electrode clamping plate 220 cannot realize the fastening and clamping of the conductive electrode. which leads to poor conductive stability of the power transmission vehicle device. In this way, in order to avoid the problem of poor conductive stability of the power transmission vehicle device when the surface of the conductive electrode is curved. the present embodiment specifically adopts the following structure to solve the problem.

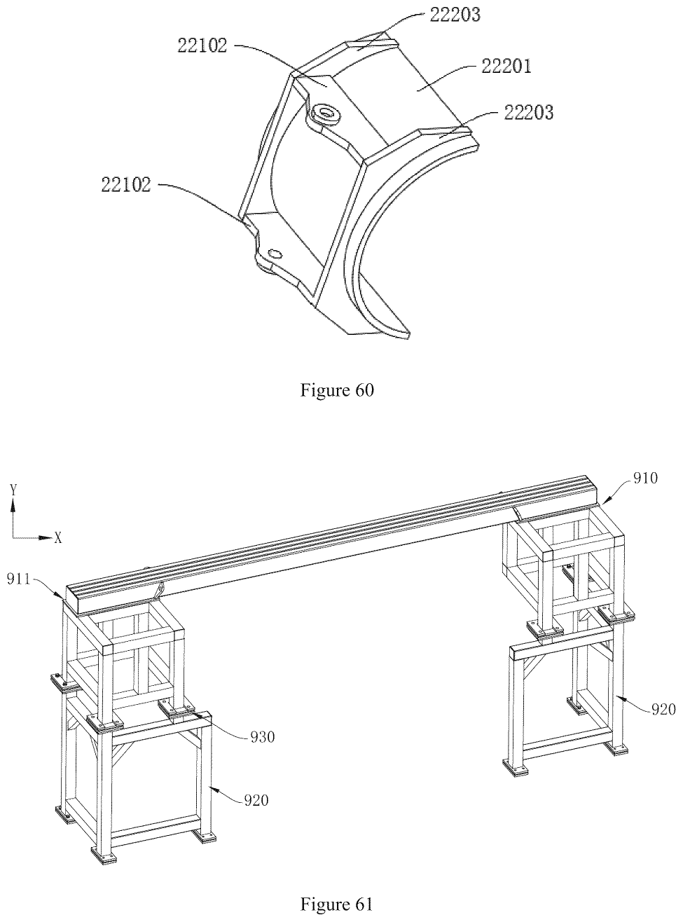

Referring to FIGS. 59 and 60, the electrode clamping assembly 200 includes:
A first supporting frame 210 for being disposed on the strut 100;
Two opposite electrode clamping plates 220; the clamping surfaces 2207 of the two electrode clamping plates 220 are arranged opposite to each other and have curved surfaces, and the clamping surfaces 2207 of the two electrode clamping plates 220 are arranged as curved surfaces to satisfy the conductive electrodes whose external contours are curved surfaces, thereby improving the adaptability of the electrode clamping plates 220, further increasing the contact area between the electrode clamping plates 220 and the conductive electrodes, so that the connectivity between the two is better and the conductive stability is better;

1Two first clamping arms 230 respectively hinged with both sides of the first supporting frame 210, and two electrode clamping plates 220 are respectively arranged on the two first clamping arms 230; and
The first driving member 240 disposed between the two first clamping arms 230 and connected to the two first clamping arms 230 respectively.

Two ends of the first supporting frame 210 are respectively hinged with the middle parts of two first clamping arms 230 to form two fulcrums, and the first clamping arms 230 and the first supporting frame 210 are both sheet-shaped plates and elongated; both ends of the first driving member 240 are hinged on the first ends of the two first clamping arms 230, and the first ends of the two first clamping arms 230 can be opened and clamped around the fulcrum under the driving of the first driving member 240. Hydraulic cylinder is selected as the first driving member 240 in this embodiment. Of course, in other embodiments, screw lead drive, cylinder drive and the like may be used and will not be described here.

Both sides of the first supporting frame 210 are respectively hinged with the first clamping arm 230 on the corresponding side through a first rotary shaft 250 which forms the fulcrum as described above.

Each electrode clamping plate 220 is hinged to an end of the first clamping arm 230 on a corresponding side through a second rotary shaft 260 and can be swung around the second rotary shaft 260.

Referring to FIG. 59, the first clamping arm 230 includes two first clamping arms 231, the first rotary shaft 250 is arranged through the two first clamping arms 231, and the upper and lower ends of the first rotary shaft 250 are respectively connected with the first supporting frame 210 to improve the stability of the structure of the electrode clamping assembly 200; one end of the two first clamping arms 231 is fixed together by a connecting rod 232, and the other end of the two first clamping arms 231 is fixed together by a first fixing plate 233. Two ends of the first driving member 240 are respectively connected with the connecting rod 232, and the first driving member 240 drives the two first clamping arms 231 to move together by driving the connecting rod 232 to move, thus realizing the operation effect of driving the electrode clamping plate 220 to clamp or release the conductive electrode.

The first clamping arm 230 is provided with a limiting position plate 234 near the connecting rod 232, and two ends of the limiting position plate 234 are respectively connected with two first clamping arms 231, thereby improving the structural stability of the first clamping arm 230.

Referring to FIGS. 59 and 60, the electrode clamping plate 220 includes a first clamping plate 221 affixed to the inner side of the first clamping plate 221 and a first conductive plate 222, with an outer side of the first clamping plate 221 extending in the direction of the first clamping arm 230 and being rotationally connected to the first clamping arm 230, and a clamping surface 2207 provided on one side of the first conductive plate 222 away from the first clamping plate 221. The two clamping surfaces 2207 are arranged opposite to each other and have curved surfaces for clamping conductive electrodes with curved peripheral contours, so that the contact area between the electrode clamping plate 220 and the conductive electrodes is increased, thereby improving the adaptability of the electrode clamping assembly 200, further improving the fit degree between the electrode clamping plate 220 and the conductive electrodes, and making the connectivity between the two better, so as to meet good contact to realize conduction.

Referring to FIG. 60, in particular, in the present embodiment, the first clamping plate 221 includes a bending portion 22101, two stiffeners 22102 and two connecting plates 22103; each stiffener 22102 extends in the circumferential direction of the bending portion 22101 two stiffeners 22102 arranged at intervals along the axial direction of the bending portion 22101. the two connecting plates 22103 arranged at intervals along the circumferential direction of the bending portion 22101, and both ends are respectively connected to the two stiffeners 22102, the bending portion 22101 is rotationally connected to the first clamping arm 230 through the connecting plates 22103. The shape of the bending portion 22101 is adapted to the outer shape of the conductive electrode, and the stiffener 22102 is fixed to the outer circumference of the bending portion 22101. It will be understood by those skilled in the art that the stiffener 22102 and the connecting plate 22103 may be integrally formed with the bending portion 22101 or may be fixedly connected by welding.

Referring to FIG. 59, in this embodiment, the outer circumferential contour of the conductive electrode is cylindrical. Therefore, in order to adapt to the contour of the conductive electrode, the bending portion 22101 and the first conductive plate 222 have the same structure and are both semicircular. The two first conductive plates 222 are combined into a cylindrical shape to cooperate with the conductive electrode and better clamp the conductive electrode, so that the connection between the two is stable and the conductive is reliable.

The first conductive plate 222 is a plate having an arc-shaped cross section and preferably the first conductive plate 222 is a copper tile. The copper tile has good electrical conductivity and high temperature resistance, and can prevent the first clamping plate 221 from being deformed by high temperature melting in the clamping process, thereby effectively improving the stability of the structure, and further improving the clamping force so as to stabilize the electrical conductivity.

Each of the first conductive plates 222 is provided with a holding space, in which a cooling liquid is injected to reduce the high temperature of the first conductive plate 222, and the holding space is used for circulating the cooling liquid to prevent the first conductive plate 222 from being deformed due to excessive stability. It will be understood that the holding space is communicated with an external cooling liquid supply apparatus through a pipe 290. In this embodiment, the cooling liquid is cooling water. Specifically, the first conductive plate 222 is externally connected with a water-cooling system, and the cooling water flows into the first conductive plate 222 through an inlet pipe, then exchanges heat, and then flows out through an outlet pipe.

Specifically, the connecting plate 22103 on the electrode clamping plate 220 is rotationally connected to the end of the first clamping arm 230 through the second rotary shaft 260. Thus, the electrode clamping plate 220 can be rotated about the second rotary shaft 260 to adjust the angle so that the placement position of the conductive electrode can be adapted.

The first supporting frame 210 is used for positioning the distance between the two first clamping arms 230. Specifically, the first supporting frame 210 is two first supporting plates 211 arranged in up-down parallel. Both ends of each first supporting plate 211 are connected with the two first clamping arms 231, each first supporting plate 211 is rotationally connected to the first clamping arm 230 through a second rotary shaft 260.

The electrode clamping assembly 200 provided by the embodiment of the utility model clamps the conductive electrode through the electrode clamping plate 220, and sets the clamping surfaces 2207 of the two electrode clamping plates 220 as curved surfaces to satisfy the conductive electrodes whose external contours are curved surfaces, thereby improving the adaptability of the electrode clamping assembly 200, further increasing the contact area between the electrode clamping plate 220 and the conductive electrodes, so that the connectivity between the two is better and the conductive stability is better.

### Embodiment 10

Different from conventional workpieces, when the power transmission vehicle device carries out power transmission operation to Acheson graphite furnace, it will connect the power transmission aluminum row through the aluminum row clamping mechanism 3000, and the aluminum row clamping mechanism 3000 has heavy weight. Therefore, the supporting structure of the power transmission vehicle device used to fix the aluminum row clamping mechanism 3000 needs to have high structural strength and is generally made of metal materials. However, these metal materials are usually conductive metal materials. When the power transmission vehicle device is connected with the power transmission aluminum row and connected with high voltage, too high voltage is easy to produce electrical breakdown on the supporting structure, which may lead to safety accidents caused by operators touching the supporting structure by mistake, thus reducing the safety of power transmission vehicle device. In this way, in order to avoid the problem that an operator may accidentally touch the supporting structure and cause a safety accident, the embodiment specifically adopts the following structure to solve the problem.

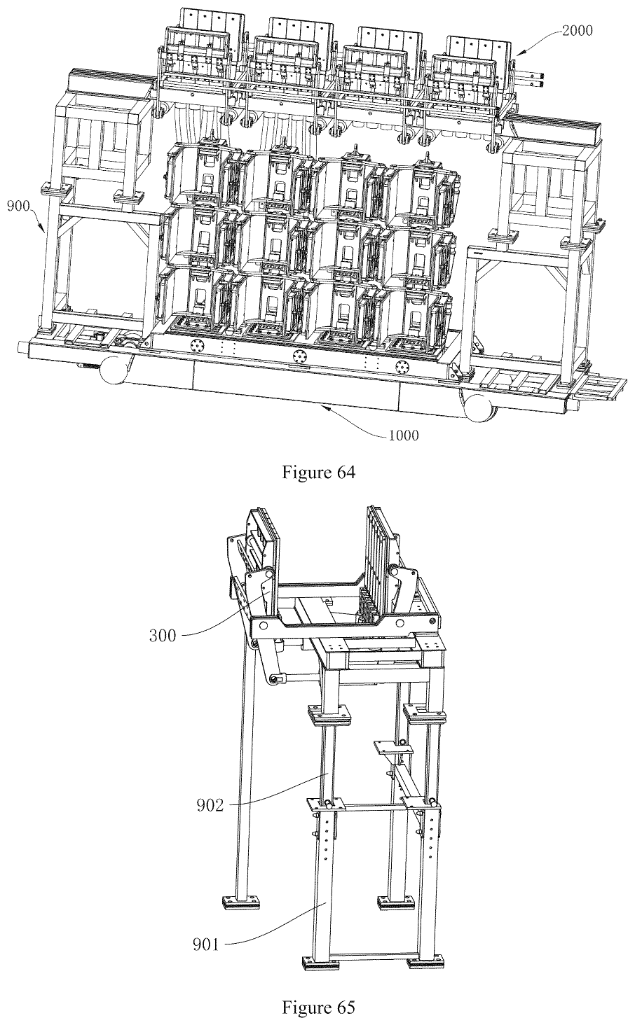

Referring to FIGS. 61 to 64, the aluminum row clamping mechanism 3000 further includes a base frame 900 disposed on the vehicle body 1000, and the base frame 900 includes a mounting frame 910, a supporting frame 920, and an insulating connection member 930. The mounting frame 910 is configured to mount the aluminum row clamping assembly 300 of the power transmission vehicle device. The supporting frame 920 is connected to the mounting frame 910 in a first direction. The insulating connection member 930 has an insulating connection area and an insulating edge area disposed around the insulating connection area, the insulating connection area being connected between the mounting frame 910 and the supporting frame 920, wherein the first surface area S1 of the insulating connection member 930 is greater than or equal to the contact area S3 between the mounting frame 910 and the insulating connection area, the second surface area of the insulating connection member 930 is greater than or equal to the contact area between the supporting frame 920 and the insulating connection area. and the first surface and the second surface are disposed opposite each other.

In this embodiment, the contact area S3 refers to an area where the surface of the mounting frame 910 contacts the insulating connection area when the mounting frame 910 is brought into contact with the insulating connection area, and the contact area S4 refers to an area where the surface of the supporting frame 920 contacts the insulating connection area when the supporting frame 920 is brought into contact with the insulating connection area.

In this embodiment the first direction is the direction indicated by Y in FIG. 61 that is the direction perpendicular to the horizontal plane.

In one embodiment the height of the base frame 900 in the first direction may be designed according to the height of the Acheson graphite furnace and the embodiments of this specification are not specifically limited herein. In some embodiments, the height of the base frame 900 in the first direction is about 4 m. To facilitate transportation and assembly, the base frame 900 includes a mounting frame 910 and a supporting frame 920, the mounting frame 910 and the supporting frame 920 may be connected in a first direction, wherein the mounting frame 910 has a height of about 2 m. The supporting frame 920 has a height of about 2 m, and operators working on the ground are prone to accidentally touching the supporting frame 920. Therefore, the base frame 900 provided by the embodiments of this specification also includes an insulating connection member 930, which has an insulating connection area connected between the mounting frame 910 and the supporting frame 920, and an insulating edge area disposed around the insulating connection area, and one surface area of the insulating connection member 930 is greater than or equal to the contact area between the mounting frame 910 and the insulating connection area, and one surface area of the insulating connection member 930 is greater than or equal to the contact area between the supporting frame 920 and the insulating connection area. Thus, a brim structure can be formed, thereby cutting off' an electrical gap between the mounting frame 910 and the supporting frame 920 (the electrical gap refers to the shortest distance between the mounting frame 910 and the supporting frame 920 that can be insulated by air under the condition of ensuring stable and safe electrical performance) and increasing a creepage distance between the mounting frame 910 and the supporting frame 920 (the creepage distance refers to the shortest path between the mounting frame 910 and the supporting frame 920 measured along the surface of the insulating connection member 930) reduces the phenomenon of electrical breakdown due to overvoltage, thereby improving the power transmission safety of the power transmission vehicle device.

In the above-described embodiments, since the height of the mounting frame 910 is about 2 m and the height of the supporting frame 920 is about 2 m, it is difficult for an operator to contact the mounting frame 910 at ordinary times when working on the ground. Therefore, based on the manufacturing cost of the base frame 900 and the difficulty of contacting the mounting frame 910, it is unnecessary to do electrical protection work on the mounting frame 910.

In one embodiment, the mounting frame 910 is provided with an uncharged marker area, and the supporting frame 920 is provided with a charged marker area, which can alert the operator and reduce the occurrence of electric shock caused by accidental contact. Furthermore, in other embodiments, in order to improve the warning effect, the uncharged marker area and the charged marker area may be respectively coated with different colors, for example, the uncharged marker area may be coated with yellow paint, and the charged marker area may be coated with red paint.

Further the mounting frame 910 and the supporting frame 920 may be made of any metal material well known in the art such as copper, iron and their alloys and the like and the embodiments of this specification are not specifically limited herein. Further, the insulating connection member 930 may be made of any insulating material well known in the art such as plastic, quartz or high temperature resistant rubber and the embodiment of this specification is not specifically limited herein.

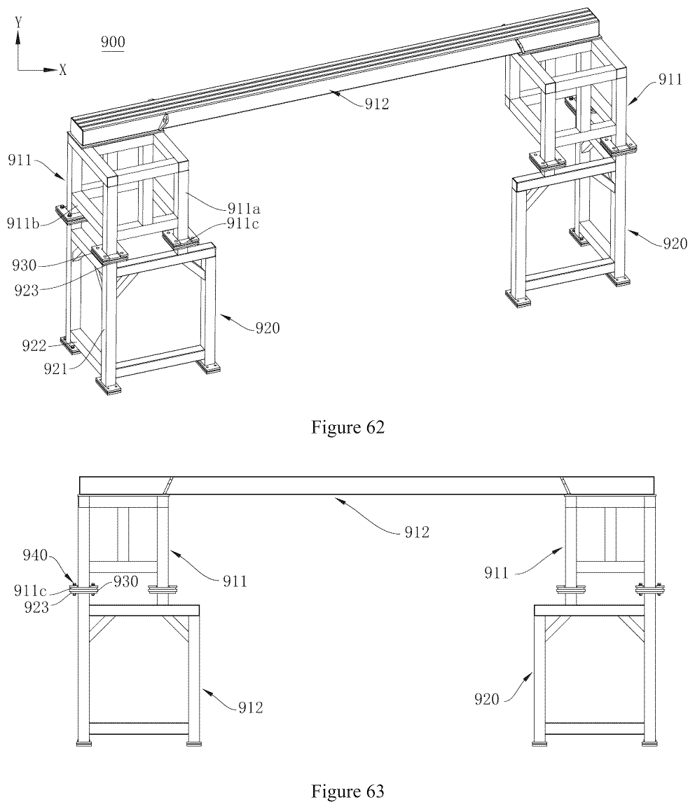

Referring to FIG. 62, in one embodiment, the mounting frame 910 includes two mounting frame bodies 911 and a cross beam 912. The two mounting frame bodies 911 are arranged at intervals in a second direction wherein the first direction and the second direction intersect. A cross beam 912 is connected between the two mounting frame bodies 911 and is configured to mount an aluminum row clamping assembly 300 of a power transmission vehicle device.

In this embodiment the second direction is the X direction shown in FIG. 62 that is a direction parallel to the horizontal plane.

In the above-described embodiments the cross beam 912 can be used not only for mounting the aluminum row clamping assembly 300 of the power transmission vehicle device but also connected between the two mounting frame bodies 911 to enhance the supporting stability of the base frame 900. The two mounting frame bodies 911 are respectively connected to the supporting frame 920 via the insulating connection member 930 thereby further enhancing the supporting stability of the base frame 900.

Referring to FIG. 62, in one embodiment, the mounting frame body 911 includes at least four first legs 911a, a first connecting portion 911b and a first contact portion 911e. The first connecting portion 911b is connected between two adjacent first legs 911a so that at least four first legs 911a enclose the mounting frame body 911. The first contact portion 911e is provided at the second end of the first leg part 911a, and the contact surface area of the first contact portion 911e is larger than the area of the second end of the first leg 911a, wherein the first contact portion 911e is connected to the insulating connection member 930.

In the above-described embodiments, the mounting frame body 911 is constituted by at least four first leg 911a, the first connecting portion 911b, and the first contact portion 911c, so that the support stability of the base frame 900 can be enhanced while the cross beam 912 and the aluminum row clamping assembly 300 are well supported.

In this case, the surface area of the first contact portion 911 can be understood as the contact area S3. In addition, the gap between the two mounting frame bodies 911 can also be used for mounting the aluminum row clamping assembly 300, so that the gap between the two mounting frame bodies 911 can be fully utilized, thereby reducing the volume of the power transmission vehicle device, thereby reducing the floor space of the workshop and reducing the investment cost.

In addition, the first leg 911a of the mounting frame body 911 may also be used for wiring thereby rationalizing the wiring of the power transmission vehicle device.

In one embodiment, a reliable connection between the insulating connection member 930 and the mounting frame and the supporting frame 920 can also improve the supporting stability of the base frame 900.

Referring to FIG. 63, in one embodiment, the base frame 900 further includes an insulating fastening member 940 configured to be removably and fixedly connected with the first contact portion 911c, the insulating connection member 930. and the supporting frame 920. The connection between the first contact portion 911c, the insulating connection member 930. and the supporting frame 920 can be made more reliable by the insulating fastening member 940, thereby further improving the support stability of the base frame 900.

In some embodiments, the insulating fastening member 940 includes an insulating fastening body, an insulating bolt and an insulating nut. The insulating fastening body is provided with a bolt through hole penetrating through the surface thereof in a first direction. The insulating bolt passes through the insulating fastening body, the first contact part 911c, the insulating connection part 930 and the bolt through hole of the supporting frame 920 in sequence to cooperate with the insulating nut, so that the first contact part 911c, the insulating connection part 930 and the supporting frame 920 are detachably connected.

In the above-described embodiments, the insulating fastening body includes a first end portion, a middle portion, and a second end portion, the middle portion being connected between the first end portion and the second end portion to form a concave shape, wherein at least one of the first end portion, the middle portion, and the second end portion is provided with a bolt through hole penetrating its surface in a first direction, so that the insulating fastening member 940 can have a notch by which to surround the first leg 911a; and the first contact part 911c, the insulation connecting part 930 and the supporting frame 920 are connected more reliably by the cooperation of the insulation bolt and the insulation nut.

In one embodiment, the insulating fastening body, the insulating bolt and the insulating nut may be made of an insulating material well known in the art, or an insulating layer may be provided on their surfaces, the insulating layer may also be made of an insulating material well known in the art, the insulating material may be plastic, quartz, high temperature resistant rubber, etc. The embodiments of this specification are not specifically limited herein.

In one embodiment, the area ratio of the first surface area S1 of the insulating connection member 930 to the contact area S3 of the mounting frame 910 and the insulating connection area is (2-5): 1. When the area ratio of the first surface area S1 to the contact area S3 is within the above range, the creepage distance between the mounting frame 910 and the supporting frame 920 can be increased, and the material can be saved and the manufacturing cost can be reduced.

In one embodiment, the first surface area S11 of the insulating connection area is greater than or equal to the contact area S3 between the mounting frame 910 and the insulating connection area, which can help to further increase the creepage distance between the mounting frame 910 and the supporting frame 920, reduce the occurrence probability of electrical breakdown, and further improve the safety of the power transmission vehicle device when transmitting power.

It will be understood that the first surface of the insulating connection region is located within the first surface of the insulating connection member 930.

In some examples, the contact surface of the mounting frame 910 and the insulating connection area is located in the center area of the first surface of the insulating connection area, which can further make the creepage distance between the respective positions of the mounting frame 910 and the corresponding positions of the supporting frame 920 close, thereby further reducing the occurrence probability of electrical breakdown, thereby improving the safety of the power transmission vehicle device during power transmission.

Referring to FIG. 62, in one embodiment, the supporting frame 920 includes at least three second legs 921, second connection portion 922 and second contact portion 923. The second connecting portion 922 is connected between two adjacent second legs 921 so that at least three second legs 921 enclose the main body of the supporting frame 920. The second contact portion 923 is provided at the second end of the second leg 921, and the contact surface area of the second contact portion 923 is larger than the end face area of the second end of the second leg 921. The insulating connection member 930 is connected between the first contact portion 911c and the second contact portion 923, and the insulating fastening member 940 is configured to detachably fixedly connect the insulating connection member 930, the first contact portion 911c and the second contact portion 923.

In the above-described embodiments, the supporting frame 920 is constituted by at least three second legs 921, the second connecting portion 922, and the second contact portion 923, which can provide a good supporting effect for the mounting frame 910 and enhance the supporting stability of the base frame 900.

In this case, the surface area of the second contact portion 923 can be understood as the contact area S4.

In the above-described embodiments, the area ratio of the second surface area S2 of the insulating connection member 930 to the contact area S4 of the supporting frame 920 and the insulating connection region is (2-5): 1. When the area ratio of the second surface area S2 to the contact area S4 is within the above range, the creepage distance between the mounting frame 910 and the supporting frame 920 can be increased, and the material can be saved and the manufacturing cost can be reduced.

In addition, in the above-described embodiments, the second surface area S21 of the insulating connection area is larger than or equal to the contact area S4 between the supporting frame 920 and the insulating connection area, which can help to further increase the creepage distance between the mounting frame 910 and the supporting frame 920, reduce the occurrence probability of electrical breakdown, and thereby further improve the safety of the power transmission vehicle device during power transmission.

It will be understood that the second surface of the insulating connection area is located within the second surface of the insulating connection member 930.

In some examples, the contact surface of the supporting frame 920 and the insulating connection area is located in the center area of the second surface of the insulating connection area, which can further make the creepage distance between the respective positions of the supporting frame 920 and the corresponding positions of the mounting frame 910 close, thereby further reducing the occurrence probability of electrical breakdown, thereby improving the safety of the power transmission vehicle device during power transmission.

In the above-described embodiments, a first stiffener may be provided between the first leg 911a and the first connecting part 911b in the mounting frame 910, which can further improve the structural strength of the mounting frame 910, thereby improving the supporting stability of the mounting frame 910.

In addition, a second stiffener may be provided between the second leg 921 and the second connecting portion 922 in the supporting frame 920.

In one embodiment the creepage distance between the supporting frame 920 and the mounting frame 910 is 10-150 cm.

### Embodiment 11

Different from conventional workpieces, the aluminum row clamping mechanism 3000 mainly includes an aluminum row clamping assembly 300 and a base frame 900. When the aluminum row clamping assembly 300 is arranged on the top of the base frame 900, the height of the power transmission vehicle device is high and cannot be adjusted, so it is difficult to find a truck with an adaptive height cargo compartment, and the loading and transportation costs are relatively high. In this way, in order to solve the technical problem that the overall height of the power transmission vehicle device is too high and cannot be adjusted, which leads to inconvenient loading and transportation, the embodiment specifically adopts the following structure to solve the problem.

Referring to FIGS. 65 to 68, a specific configuration of the aluminum row clamping mechanism 3000 will be mainly described below.

The aluminum row clamping mechanism 3000 further includes:

The base frame 900 provided on the vehicle body 1000, and the aluminum row clamping assembly 300 provided on the base frame 900.

The base frame 900 includes an upper frame 902 and a lower frame 901; the upper bracket 902 is nested into the lower bracket 901, each of the upper bracket 902 and the lower bracket 901 is provided with a plurality of second limiting holes, and the upper bracket 902 and the lower bracket 901 are connected through their respective second limiting holes through limiting position assembly to adjust the height of the entire base frame 900; the aluminum row clamping assembly 300 is fixedly connected to the upper part of the base frame 900 and the opening of the aluminum row clamping assembly 300 faces upwards.

In the present embodiment, it should be noted that the aluminum row clamping assembly 300 and the upper portion of the base frame 900 may be fixedly connected by welding. bolt connection or other means.

Specifically, in an embodiment, the base frame 900 includes a mounting frame 9022 which is provided at the top end of the base frame 900; the aluminum row clamping assembly 300 is fixedly connected to the mounting frame 9022.

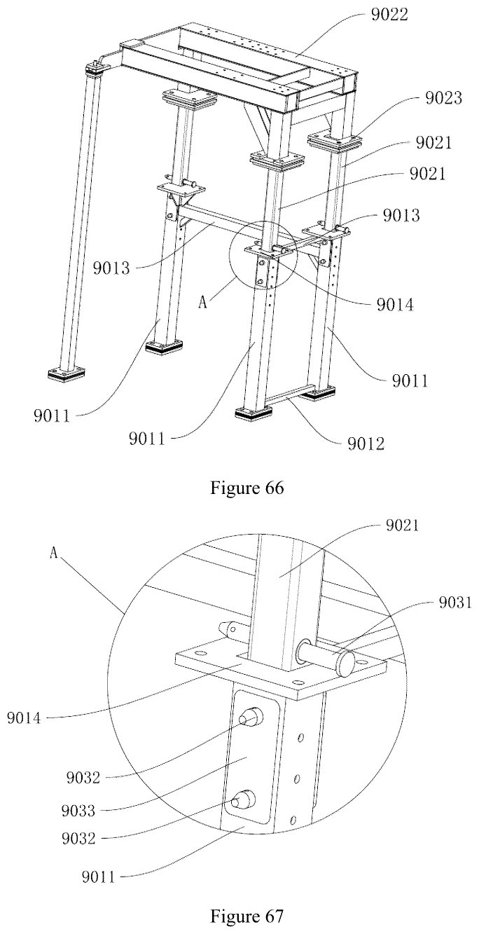

Referring to FIGS. 65 and 66, the aluminum row clamping assembly 300 may be welded or bolted to the mounting frame 9022 of the base frame 900.

In an embodiment, the lower bracket 901 includes a first supporting post 9011 and a third supporting plate 9014; a third supporting plate 9014 is fixedly provided at the top end of the first supporting post 9011; the upper bracket 902 includes a second supporting post 9021, and the limiting position assembly includes a first limiting position assembly 9031; the upper bracket 902 and the lower bracket 901 are connected through a second limiting hole of the second supporting post 9021 through a first limiting position assembly 9031; the first stopping piece 9031 abuts against the third supporting plate 9014 under the action of gravity.

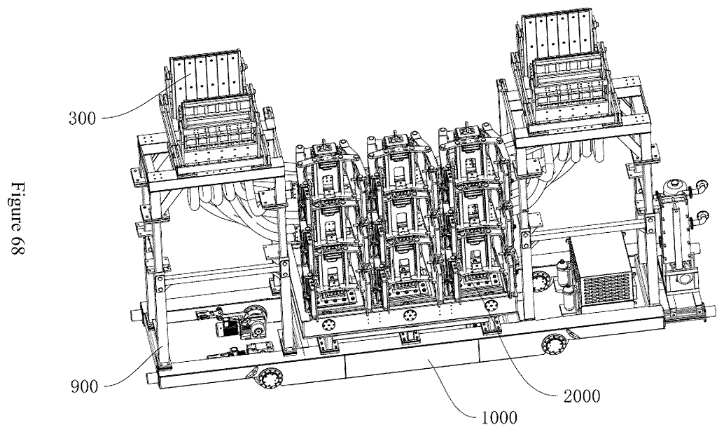

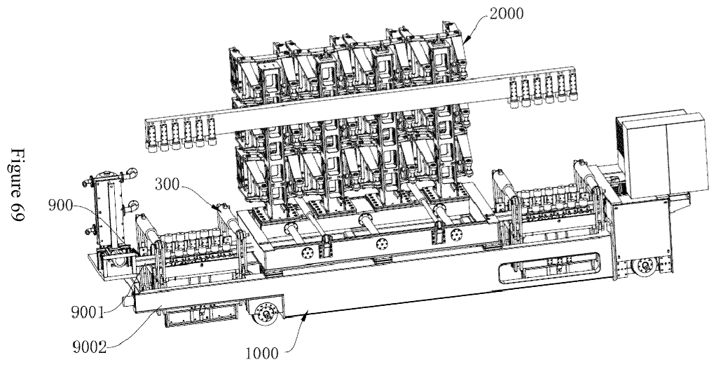

See FIGS. 66 and 67.

In this embodiment, it should be noted that the upper bracket 902 includes four second supporting posts 9021, which are fixedly welded or bolted below the mounting frame 9022 and are specifically provided at each end of the mounting frame 9022.

Both the first supporting post 9011 and the second supporting post 9021 can both be hollow columnar structures, and the cross-sectional area of the first supporting post 9011 is slightly larger than the cross-sectional area of the second supporting post 9021, so that the second supporting post 9021 can be nested within the first supporting post 9011 just in close proximity.

The third supporting plate 9014 and the first supporting post 9011 may be integrally formed or the third supporting plate 9014 may be welded to the first supporting post 9011.

Each of the second limiting holes of the upper bracket 902 may be provided on the second supporting post 9021. The second limiting holes are arranged in pairs on opposite sides of the second supporting post 9021, and each pair of the second limiting holes is on the same horizontal line, so as to ensure that the horizontal stability of the structure is maintained when the limiting piece penetrates, and each pair of the second limiting holes can be arranged on the front and back opposite sides of the second supporting post 9021 or on the left and right opposite sides of the second supporting post 9021.

The first limiting position 9031, which may be a pin or other metal column, is fixedly connected to the upper bracket 902 and the lower bracket 901 by penetrating the first limiting position 9031 into a pair of second stopping holes horizontally opposite to the second supporting post 9021 and pressing against the third supporting plate 9014 under the action of gravity. which is also fixedly connected to the first supporting post 9011 and the second supporting post 9021.

In the aluminum row clamping mechanism 3000 of the present application, the height of the entire base frame 900 is adjustable by arranging an upper bracket nested into a lower bracket, and a plurality of second limiting holes and limiting position assembly for passing through the second limiting holes are arranged in both the upper bracket and the lower bracket. and the upper bracket and the lower bracket are fixedly connected by penetrating the limiting position piece into the second limiting holes at the same height respectively; in the transportation scene, the upper bracket is more nested in the lower bracket, and after being adjusted to a suitable height, it passes through the second limiting hole through the limiting position piece to fix the height of the whole bracket, so that the height of the whole power transmission vehicle is reduced, which is more convenient for loading and transporting the power transmission vehicle and reduces the loading and transporting cost. In addition, the aluminum row clamping mechanism 3000 in the present application, based on its structural function of freely adjusting height, can also adaptively adjust the power-transmitting aluminum rows at different heights, so as to better adjust the position of reaching the power-transmitting aluminum rows and clamp the power-transmitting aluminum rows, and ensure that graphitization of conductive electrodes is more stably realized after being electrified.

Based on the above embodiments, in one embodiment, the limiting position piece further includes a second limiting position piece 9032; the upper bracket 902 and the lower bracket 901 are also connected through the second limiting hole of the second supporting post 9021 and the second limiting hole of the first supporting post 9011 at the same time through the second limiting position piece 9032.

See FIGS. 66 and 67 for details.

In this embodiment, the second limiting holes on the lower bracket 901 can all be arranged on the first supporting post 9011, and the second limiting holes are arranged in pairs on opposite sides of the first supporting post 9011 and each pair of the second limiting holes is on the same horizontal line, so as to ensure that the horizontal stability of the structure is maintained when the limiting position piece penetrate, and each pair of the second limiting holes can be arranged on the front and back opposite sides of the first supporting post 9011 or on the left and right opposite sides of the first supporting post 9011.

Likewise, the second limiting position piece 9032 may also be a pin or other metal column.

In order to further strengthen the stability of the connection between the upper bracket 902 and the lower bracket 901. the second limiting position piece 9032 may be simultaneously penetrated through the second limiting hole of the second supporting post 9021 and the second limiting hole of the first supporting post 9011, and the second limiting position piece 9032 may be a plurality. In this way, the upper bracket 902 and the lower bracket 901 can be more stably connected to each other by providing the second limiting position piece 9032 and the first limiting position piece 9031, thereby preventing the upper bracket 902 and the lower bracket 901 from shaking.

Furthermore, preferably, the second limiting position assembly 9032 and the first limiting position assembly 9031 may be arranged vertically and horizontally as shown in FIG. 67, so that the stability of the connection between the upper and lower brackets 901 can be ensured to the greatest extent.

Based on the above-mentioned embodiments, in one embodiment, the outer surfaces of opposite sides of the upper part of the first supporting post 9011 are provided with attachment plates 9033 which is provided with a second limiting hole; the upper bracket 902 and the lower bracket 901 are connected through the second limiting hole of the first supporting post 9011. the second limiting hole of the second supporting post 9021 and the second limiting hole of the attachment plates 9033 at the same time through the second limiting position assembly 9032.

A pair of attachment plates 9033 may be welded to the outer surfaces of any opposite sides (left and right or front and back) of the upper part of the first supporting post 9011 near the third supporting plate 9014, or the attachment plates 9033 may not be welded to the two sides, and only the attachment plates 9033 need be pressed to the two sides under the penetrating action of the second limiting position assembly 9032.

The attachment plate 9033 is also provided with a second limiting hole matched with the first supporting post 9011. and the second limiting position assembly 9032 can simultaneously penetrate the second limiting hole of the first supporting post 9011, the second limiting hole of the second supporting post 9021 and the second limiting hole of the attachment plate 9033 to realize the connection between the upper and lower brackets 901.

In this embodiment, the attachment plate 9033 is provided to avoid local stress on the second limiting hole of the first supporting post 9011, to improve the stress capacity of the second limiting hole, and to further improve the reliability and stability of the connection between the upper and lower brackets 901.

Based on the above embodiments, in one embodiment, the base frame 900 further includes a first cross brace 9012 and a second cross brace 9013; a first cross brace 9012 and a second cross brace 9013 are respectively disposed between the plurality of first supporting posts 9011 at intervals.

Referring to FIG. 66, the bottom of the first supporting post 9011 is also provided with a base. A first cross brace 9012 is disposed between the first supporting posts 9011 and adjacent to the base.

A second cross brace 9013 is disposed between the first supporting posts 9011 and close to the third supporting plate 9014.

Specifically, when the first cross brace 9012 is disposed between a plurality of first supporting posts 9011, the first cross brace 9012 may be disposed between each of the first supporting posts 9011, and may be selectively disposed between certain two first supporting posts 9011 or not disposed between certain two first supporting posts 9011.

Similarly, the second cross brace 9013 is provided between the plurality of first supporting posts 9011 in the same manner and will not be described here.

In this embodiment, the stability and the stress bearing capacity of the base frame 900 can be improved by providing the cross braces.

Based on the above embodiments, in one embodiment, the second supporting post 9021 is provided with an insulating composite plate 9023 which includes an insulating pad and a metal plate.

Specifically in one embodiment, the insulating composite plate 9023 includes two layers of insulating pads and two layers of metal plates; two layers of insulating pads and two layers of metal plates are fixedly connected together; wherein, the insulating pad and the metal plate are adjacent and attached.

In this embodiment, the two layers of insulating pads and the two layers of metal plates can be provided with through holes around them and fixedly connected together by bolts, wherein an insulating layer is provided in the through holes, and the bolts directly contact with the insulating layer in the through holes.

The insulating pad and the metal plate can be bonded to each other in a specific way: from top to bottom, the insulating composite plate 9023 is sequentially provided with a first layer of insulating pad, a second layer of metal plate, a third layer of insulating pad and a fourth layer of metal plate. For this particular insulating composite plate 9023, in which the upper portion of the second supporting post 9021 is welded to the second metal plate through the first insulating pad and the lower portion of the second supporting post 9021 is directly welded to the fourth metal plate, therefore, the insulating composite plate 9023 is provided on the second supporting post 9021.

In this embodiment, the insulating composite plate 9023 is arranged so that the aluminum row clamping mechanism 3000 above the insulating composite plate 9023 is normally conductive, and the aluminum row clamping mechanism 3000 below is non-conductive, thus ensuring the safety of electricity consumption and preventing electric shock.

### Embodiment 12

Different from the conventional workpiece, in the process of power transmission, the power transmission circuit of the power transmission vehicle device needs to be connected with the power transmission aluminum row to obtain high current. and the aluminum row clamp is arranged on the top of the vehicle frame to connect with the power transmission aluminum row, and the clamping opening of the aluminum row clamp is arranged upward to facilitate the power transmission aluminum row to be clamped. However, the way of arranging the aluminum row clamp on the top of the base frame 900 often greatly increases the overall installation height of the power transmission vehicle device, and at the same time, placing the power transmission vehicle device with the aluminum row clamp on the top of the base frame 900 in the work site will lead to the increase of installation height of the power transmission aluminum row. Under the condition of height limit in the installation site of the Acheson graphitization furnace, the power transmission aluminum row cannot or is difficult to complete the adaptive installation. As a result, the power transmission vehicle in which the aluminum row clamp is arranged on the top of the base frame 900 cannot be used effectively. In this way, in order to avoid the problem that the adaptability installation of the power transmission aluminum row cannot be completed or the installation difficulty of the power transmission aluminum row is increased under the condition that the height limit exists in the installation site of the Acheson graphitization furnace, the embodiment specifically adopts the following structure to solve the problem.

Referring to FIG. 69, the aluminum row clamping mechanism further includes a base frame 900 disposed on the vehicle body 1000 and an aluminum row clamping assembly 300 disposed on the base frame 900; specifically, the base frame 900 extends transversely and is provided at both ends of the vehicle body 1000, and the bottom portion of the vehicle body 1000 is hollow to facilitate installation of the power transmission aluminum row through the bottom portion of the vehicle body 1000.

Because the vehicle body 1000 is used for bearing the electrode clamping mechanism 2000, and the base frame 900 extends transversely and is arranged on the vehicle body 1000, the installation height of the upper end of the base frame 900 is greatly smaller than that of the electrode clamping mechanism 2000, so that the installation height of the aluminum row clamping assembly 300 can be synchronously reduced, and the overall height of the power transmission vehicle device is effectively reduced, thereby avoiding the problem that the whole vehicle height of the improved power transmission vehicle device is higher than that of the existing power transmission vehicle device, so as to meet the height limit requirement of the installation site of the Acheson graphitization furnace; in addition, the aluminum row clamping assembly 300 is installed by utilizing the height of the bottom structure of the vehicle body 1000, which greatly saves the occupied space of the power transmission vehicle device; in addition, by reducing the overall height of the power transmission vehicle device, the problem that the overall center of gravity of the power transmission vehicle device is too high is effectively avoided, and the operation stability of the power transmission vehicle device is ensured.

In one embodiment, the aluminum row clamping opening of the aluminum row clamping assembly 300 is disposed toward and spaced from the ground; in the initial state, the power transmission aluminum row is arranged in the aluminum row clamping opening of the aluminum row clamping assembly 300 and keeps a certain gap with the aluminum row clamping assembly 300, so as to avoid the effect that the power transmission aluminum row continuously contacts with the aluminum row clamping assembly 300 and hinders the power transmission vehicle device from moving along the ground track; as the aluminum row clamping opening of the aluminum row clamping assembly 300 is arranged facing the ground, the mounting height of the aluminum row clamping assembly 300 is limited by the height of the structure of the base frame 900 itself, which can effectively reduce the overall height of the power transmission vehicle device, thereby avoiding the problem that the whole vehicle height of the improved power transmission vehicle device is higher than that of the existing power transmission vehicle device, so as to meet the height limit requirement of the installation site of the Acheson graphitization furnace; in addition, the aluminum row clamping assembly 300 is installed by utilizing the height of the bottom structure of the vehicle body 1000. which greatly saves the occupied space of the power transmission vehicle device; in addition, by reducing the overall height of the power transmission vehicle device, the problem that the overall center of gravity of the power transmission vehicle device is too high is effectively avoided, and the operation stability of the power transmission vehicle device is ensured.

In one embodiment, the base frame 900 comprises a fixing rod 9001 and limiting baffles 9002 respectively extending from both sides of one end of the vehicle body, the fixing rod 9001 is arranged higher than the limiting baffles 9002, the aluminum row clamping assembly 300 is arranged on the fixing rod 9001, the outer side of the aluminum row clamping opening of the aluminum row clamping assembly 300 is arranged close to the two limiting baffles 9002, and the limiting baffles 9002 are used for limiting the width of the aluminum row clamping opening of the aluminum row clamping assembly 300. On the one hand, the assembled volume of the aluminum row clamping assembly 300 is reduced to facilitate the power transmission vehicle device to be transported to different places, and on the other hand, the aluminum row clamping assembly 300 is protected by the limiting baffles 9002. It is avoided that the width of the aluminum row clamping opening of the aluminum row clamping assembly 300 is too large and the power transmission vehicle device is affected by a sudden event such as collision in the use state.

In other embodiments, the aluminum row clamping opening of the aluminum row clamping assembly 300 is disposed transversely and spaced from the ground to facilitate matching the installation effect of the power transmission aluminum row; correspondingly, the design of the base frame 900 is also required to match the transverse orientation of the aluminum row clamping opening, and the base frame 900 is designed to satisfy the fixing effect of the aluminum row clamping assembly 300; wherein, the transverse orientation of the aluminum row clamping opening can be toward the side of the conductive electrode or toward the side away from the conductive electrode as required, preferably, the aluminum row clamping opening is transversely oriented toward the side away from the conductive electrode, so that the matched installed power transmission aluminum row can keep a certain distance from the conductive electrode and avoid mutual interference between the two in the use state.

Referring to FIG. 70, in one embodiment, the aluminum row clamping assembly 300 includes:
A second supporting frame 310; the second supporting frame 310 is fixed to the base frame 900;
Two opposite aluminum row clamping plates 320; wherein, the two aluminum row clamping plates 320 jointly realize the clamping operation of the power transmission aluminum row on the furnace body: in this embodiment, the aluminum row clamping opening is formed by two aluminum row clamping plates 320, which are arranged in the front-rear directions;
Two second clamping arms 330 are respectively hinged with both sides of the second supporting frame 310, and two aluminum row clamping plates 320 are respectively arranged on the two second clamping arms 330; the second clamping arm 330 is arranged close to the two limiting baffles 9002 to limit the width of the aluminum row clamping opening of the aluminum row clamping assembly 300. On the one hand, the volume of the assembled aluminum row clamping assembly 300 is reduced to facilitate the power transmission vehicle device to be transported to different places; on the other hand, the limiting baffles 9002 are used to protect the aluminum row clamping assembly 300 to avoid the impact of unexpected events such as bumps of power transmission vehicle device and the like caused by the excessive width of the aluminum row clamping opening of the aluminum row clamping assembly 300 in the use state; and
The second driving member 340 is disposed between the two second clamping arms 330 and connected to the two second clamping arms 330 respectively.

Two sides of the second supporting frame 310 are respectively hinged with the middle parts of two second clamping arms 330 to form two fulcrums, and the second clamping arm 330 and the second supporting frame 310 are both sheet-shaped and elongated plates; two ends of the second driving member 340 are respectively hinged at the second ends of the two second clamping arms 330, and the second ends of the two second clamping arms 330 can make opening and closing movement around the fulcrum under the drive of the second driving member 340, thereby driving the two aluminum row clamping plates 320 to approach or move away from each other, thus realizing the clamping or loosening operation of the power transmission aluminum row. Hydraulic cylinder is selected as the second driving member 340 in this embodiment. Of course, screw lead drive, cylinder drive and the like may be used in other embodiments, which will not be described here.

Two sides of the second supporting frame 310 are respectively hinged with second clamping arms 330 on corresponding sides through third rotary shafts 350 which form the fulcrum as described above.

Each aluminum row clamping plate 320 is hinged to the end of the second clamping arm 330 on the corresponding side through a fourth rotary shaft 360 and can swing around the fourth rotary shaft 360; specifically, the fourth rotary shaft 360 is arranged in the middle of the aluminum row clamping plate 320. both ends of the fourth rotary shaft 360 are respectively connected with the second clamping arm 330, and the aluminum row clamping plate 320 rotates with the fourth rotary shaft 360 as the axis center; when the second driving member 340 drives the second clamping arm 330 to approach each other, the aluminum row clamping plate 320 on the second clamping arm 330 will gradually approach the power transmission aluminum row. In order to ensure the tightness with the power transmission aluminum row, the aluminum row clamping plate 320 will rotate with the fourth rotary shaft 360 as the axis center according to actual needs to self-adjust, thereby maximizing the contact area between the aluminum row clamping plate 320 and the power transmission aluminum row, and further improving the electrical conduction efficiency.

The second clamping arm 330 is provided with a second elastomer 370, which is of a spring plate structure, the second elastomer 370 is bent and extended with a second stopper portion 371 abutted against one side of the aluminum row clamping plate 320, and the second stopper portion 371 is used for limiting the initial installation angle of the aluminum row clamping plate 320, so as to be suitable for setting the width of the power transmission aluminum row.

In one embodiment, the second stopper portions 371 of at least two second elastomer 370 are respectively arranged on both sides of the third rotary shaft 350, so as to ensure that the aluminum row clamping plate 320 will be pressed against by the second stopper portions 371 on the corresponding side regardless of forward rotation or reverse rotation with the third rotary shaft 350 as the axis center, thus ensuring that the opening corresponding to the initial installation angle of the aluminum row clamping plate 320 on the second clamping arm 330 is suitable for the width of the power transmission aluminum row. Before the aluminum row clamping plate 320 clamps the power transmission aluminum row, the opening width between the aluminum row clamping plates 320 can adapt to the size of the power transmission aluminum row; when the aluminum row clamping plate 320 clamps the power transmission aluminum row, the aluminum row clamping plate 320 can also form a stable bonding relationship with the power transmission aluminum row and ensure the contact area between the aluminum row clamping plate 320 and the power transmission aluminum row.

In one embodiment, the second clamping arm 330 is provided with a second fixing plate 380, the second elastomer 370 is arranged on the second fixing plate 380 at intervals, and the second stopper portions 371 on both sides of the second fixing plate 380 are respectively arranged on both sides of the third rotary shaft 350, so as to ensure that the aluminum row clamping plate 320 will be pressed against by the second stopper portions 371 on the corresponding side regardless of forward rotation or reverse rotation with the third rotary shaft 350 as the axis center, and further ensure that the opening corresponding to the initial installation angle of the aluminum row clamping plate 320 on the second clamping arm 330 is suitable for the width of the aluminum row. Before the aluminum row clamping plate 320 clamps the power transmission aluminum row, the opening width between the aluminum row clamping plates 320 can adapt to the size of the power transmission aluminum row; when the aluminum row clamping plate 320 clamps the power transmission aluminum row, the aluminum row clamping plate 320 can also form a stable bonding relationship with the power transmission aluminum row and ensure the contact area between the aluminum row clamping plate 320 and the power transmission aluminum row.

In other embodiments, the second elastomer 370 is provided on the second clamping arm 330 to match both ends of the aluminum row clamping plate 320, respectively limiting both ends of the aluminum row clamping plate 320, thereby limiting the initial mounting angle of the aluminum row clamping plate 320 to meet the width requirements of the power transmission aluminum row.

In one embodiment, the second fixing plate 380 is provided with a fixing hole, and one end of the second elastomer 370 is fixed on the second fixing plate 380 through a screw member, and the screw member passes through one end of the second elastomer 370 and is clamped in the fixing hole.

In one embodiment, a screw hole is provided on the second stopper portion 371, and a second adjusting bolt (not shown) is arranged in the screw hole, the second adjusting bolt is clamped in the screw hole, one end of the second adjusting bolt is abutted against one side of the aluminum row clamping plate 320, and the initial installation angle of the aluminum row clamping plate 320 is adjusted by adjusting the length of the screw hole extended from one end of the second adjusting bolt. so as to adapt to different sizes of power transmission aluminum rows.

Further, the second supporting frame 310 includes two second supporting plates 311 arranged in parallel, the two second support plates 311 respectively fixed to the base frame 900, specifically, the two second supporting plates 311 fixed to the fixing rod 9001; the second clamping arm 330 comprises a second clamping arm 331, the aluminum row clamping plate 320 is arranged at one end of the two second clamping arms 331 on the same side, the two ends of the second driving member 340 are respectively hinged at the other ends of the second clamping arm 331 of the two second clamping arms 330, the second end of the second clamping arm 331 can be opened and closed around the third rotary shaft 350 under the drive of the second driving member 340, thereby driving the two aluminum row clamping plates 320 to approach or move away from each other to realize the clamping or loosening operation of the aluminum row clamping mechanism on the power transmission aluminum row; the third rotary shaft 350 is hinged between the two second clamping arms 331 on the same side, and is arranged through the second supporting plate 311, and both ends of the third rotary shaft 350 are respectively connected with the middle parts of the two second clamping arms 331; in the present embodiment, the number of second driving members 340 is two, and the two ends of each second driving member 340 are respectively connected with the second clamping arm 331; in other embodiments, the number of the second driving member 340 can also be designed as one, and the second clamping arm 330 can be formed by connecting the two second clamping arms 331 through connecting rods, and the two ends of the second driving member 340 are respectively connected with two connecting rods, so as to drive the two second clamping arms 330 to approach or move away from each other by driving the two connecting rods to move.

The above embodiments are only illustrative of several embodiments of the present application and the description thereof is more specific and detailed but is not therefore to be construed as limiting the scope of the present application. It should be noted that a number of modifications and improvements may be made to one of ordinary skill in the art without departing from the concept of the application, which fall within the scope of the application. Therefore, the scope of protection of the present application shall be subject to the appended claims.

1. A power transmission vehicle device, comprising a vehicle body, an electrode clamping mechanism and an aluminum row clamping mechanism, wherein the electrode clamping mechanism and the aluminum row clamping mechanism are both provided on the vehicle body, the aluminum row clamping mechanism is used for clamping a power transmission aluminum row, and the aluminum row clamping mechanism is electrically connected to the electrode clamping mechanism;
the electrode clamping mechanism comprises a strut and an electrode clamping assembly arranged on the strut, the strut is arranged on the vehicle body, the electrode clamping assembly is used for clamping a conductive electrode, and the electrode clamping assembly is movably arranged on the strut.

2. The power transmission vehicle device according to claim 1, wherein the electrode clamping assembly is arranged on the strut being movable back and forth.

3. The power transmission vehicle device according to claim 2, wherein the electrode clamping assembly is provided with a slide assembly, the strut comprises a base pillar, a supporting block is arranged on one side of the base pillar facing the conductive electrode, and the electrode clamping assembly is arranged on the supporting block being movable back and forth through the slide assembly.

4. The power transmission vehicle device according to claim 3, wherein the electrode clamping assembly further comprises:
a first supporting frame arranged on the supporting block to be movable back and forth through the slide assembly;
two electrode clamping plates together realize clamping operation for a conductive electrode on a furnace;
two first clamping arms respectively hinged to two sides of the first supporting frame, and two electrode clamping plates being respectively arranged on the two first clamping arms; and
a first driving member arranged between the two first clamping arms and connected to the two first clamping arms.

5. The power transmission vehicle device according to claim 4, wherein the electrode clamping assembly further comprises an ejection assembly arranged on the first supporting frame, and the ejection assembly is used for displacing the electrode clamping assembly back and forth.

6. The power transmission vehicle device according to claim 5, wherein the ejection assembly comprises a mounting block and an ejection member, which are connected to each other, the mounting block disposed on the first supporting frame, and an ejection member is used for abutting against one side of the strut.

7. The power transmission vehicle device according to claim 4, wherein the first supporting frame comprises two first support plates, and the sliding assembly comprises a first sliding member and/or a second sliding member, wherein the first sliding member is arranged below one of the first support plates; and/or a second sliding member is provided below the other first support plate.

8. The power transmission vehicle device according to claim 1, wherein the strut comprises a base pillar, a supporting block is arranged on one side of the base pillar facing the conductive electrode, and an electrode clamping assembly is movably arranged on the supporting block; the electrode clamping mechanism also comprises a connecting component which is arranged between the electrode clamping assembly and the supporting block;
the connecting component comprises a connecting piece and a plurality of elastic pieces arranged on both sides of the connecting piece, one end of the elastic piece is connected with the supporting block, and the other end is connected with the electrode clamping assembly; at least one of the electrode clamping assembly, the supporting block and the connecting piece is provided with a circular arc portion, and the electrode clamping assembly can rotate opposite to the connecting piece along the bending direction of the circular arc portion.

9. The power transmission vehicle device according to claim 8, wherein the electrode clamping assembly comprises a first supporting frame, the connecting piece is arranged between the first supporting frame and the supporting block, and one end of the clastic pieces is connected with the first supporting frame and the other end is connected with the supporting block.

10. A power transmission vehicle device according to claim 9, wherein the circular arc portion is provided on the connecting piece, the first supporting frame and/or the supporting block are in contact with the connecting piece through the circular arc portion, and the first supporting frame and/or the supporting block can rotate along the bending direction of the circular arc portion of the connecting piece.

11. The power transmission vehicle device according to claim 9, wherein the circular arc portion is provided on the first supporting frame, and the first supporting frame is in contact with the connecting piece through the circular arc portion.

12. The power transmission vehicle device according to claim 9, wherein the circular arc portion is provided on the supporting block, and the supporting block is in contact with the connecting piece through the circular arc portion.

13. The power transmission vehicle device according to claim 1, wherein the electrode clamping assembly comprises:
a first supporting frame arranged on the strut;
two opposite electrode clamping plates; the two electrode clamping plates jointly realize the clamping operation of the conductive electrodes on the furnace;
two first clamping arms respectively hinged with both sides of the first supporting frame, and two electrode clamping plates are respectively provided on the two first clamping arms; each electrode clamping plate is hinged on a first clamping arm on a corresponding side through a second rotating shaft, and the electrode clamping plate can be swung around the second rotating shaft; and
a first driving member arranged between the two first clamping arms and respectively connected with the two first clamping arms;
at least one first clamping arm provided with a first elastic body, which is bent to extend a stopper portion for abutting against one side of the electrode clamping plate.

14. The power transmission vehicle device according to claim 13, wherein the stopper portions of the two first elastic body are respectively provided on both sides of the second rotating shaft.

15. The power transmission vehicle device according to claim 13, wherein the first clamping arm is provided with a first fixing plate, and the first elastic body is provided on the first fixing plate at intervals.

16. The power transmission vehicle device according to claim 13, wherein a screw hole is provided in the limit part, and a first limit bolt is arranged in the screw hole, and one end of the first limit bolt is used for abutting against one side of the electrode clamping plate.

17. The power transmission vehicle device according to claim 13, wherein a cushion block is protruded toward the side of the electrode clamping plate toward the stopper portion, and the cushion block is arranged to abut against with the stopper portion.

18. The power transmission vehicle device according to claim 1, wherein the electrode clamping mechanism further comprises a stopper assembly, the electrode clamping assembly comprising:
a first supporting frame arranged on the strut;
two opposite electrode clamping plates;
two first clamping arms respectively hinged with both sides of the first supporting frame, and two electrode clamping plates are respectively arranged on the two first clamping arms; and
a first driving member arranged between the two first clamping arms and respectively connected with the two first clamping arms;
wherein, two stopper assemblies are respectively arranged on both sides of the strut, and the stopper assembly is used for adjusting the direction of opening of the electrode clamping plates.

19. The power transmission vehicle device according to claim 18, wherein when the stopper assembly is arranged on the first clamping arm, a stopper plate is arranged at the first end of the first clamping arm, a first limiting hole is provided on the stopper plate, and the stopper assembly is arranged through the first limiting hole and close to one side of the strut.

20. The power transmission vehicle device according to claim 18, wherein, when the stopper assembly is arranged on the strut, the distance between the strut and the first end of the first clamping arm is adjusted by adjusting the limiting assembly, so as to adjust the opening direction of the electrode clamping plate.

21. The power transmission vehicle device according to claim 1, wherein the electrode clamping assembly comprises an electrode clamping plate comprising a first clamping plate and a first conductive plate, a cooling pipeline is arranged on the back of the first clamping plate, and a connecting hole for connecting circulating liquid is arranged at the end of the cooling pipeline; the first conductive plate is tightly arranged on the front surface of the first clamping plate.

22. The power transmission vehicle device according to claim 21, wherein the first clamping plate is further provided with a protective case, the protective case comprising a side plate surrounding the cooling pipeline and a cover plate covering an edge of the side plate; the cover plate is provided with a through hole corresponding to the connecting hole.

23. The power transmission vehicle device according to claim 22, wherein the cooling pipeline comprises a first pipeline and a second pipeline arranged side by side along the first direction of the first clamping plate, a first protective case and a second protective case are respectively arranged corresponding to the first pipeline and the second pipeline, and an avoidance groove is arranged between the two protective cases, and the avoidance groove is provided in the avoidance groove for pivots to penetrate.

24. The power transmission vehicle device according to claim 21, wherein the cooling pipeline is a water-cooling pipeline and the circulating liquid is circulating water.

25. The power transmission vehicle device according to claim 1, wherein the electrode clamping assembly comprises two electrode clamping plates which are close to or far away from each other, the electrode clamping plate comprises a first clamping plate, a first conductive plate is installed on the inner side of the first clamping plate, an elastic pad is also arranged between the first conductive plate and the first clamping plate, and the first conductive plate is divided into a plurality of conductive sheets arranged in parallel.

26. The power transmission vehicle device according to claim 1, wherein the electrode clamping assembly comprises an electrode clamping plate, the electrode clamping plate comprises a first clamping plate and a first conductive plate, the first conductive plate is arranged on the first clamping plate, and the first conductive plate is provided with a first conductive end and a second conductive end;
the first conductive end is arranged in communication with the first conductive plate through a first flow pipe, the second conductive end is arranged in communication with the first conductive plate through a second flow pipe, and a cooling channel is arranged on the first conductive plate.

27. The power transmission vehicle device according to claim 26, wherein the first conductive plate is integrally formed, the inlet of the cooling channel is connected with the first flow pipe, and the outlet of the cooling channel is connected with the second flow pipe.

28. The power transmission vehicle device according to claim 26, wherein the first conductive plate comprises at least one first conductive sheet and at least one second conductive sheet, the first conductive sheet and the second conductive sheet are arranged side by side, the first conductive end is fixedly connected to the first conductive sheet, and the second conductive end is fixedly connected to the second conductive sheet; one end of the first flow pipe is connected with the first conductive end, the other end of the first flow pipe is connected with the first conductive sheet, one end of the second flow pipe is connected with the second conductive end, the other end of the second flow pipe is connected with the second conductive sheet, and the first conductive sheet is connected with the second conductive sheet through a third flow pipe.

29. The power transmission vehicle device according to claim 1, wherein the strut comprises a base pillar, the base pillar comprises a pillar body and a cross bar, and the cross bar is connected to the pillar body and is perpendicular to each other;
among them, the crossbar extends towards Acheson graphite furnace.

30. The power transmission vehicle device according to claim 1, wherein the electrode clamping assembly comprises:
a first supporting frame;
two opposite electrode clamping plates; wherein, the clamping surfaces of the two electrode clamping plates are arranged opposite to each other with curved surfaces;
two first clamping arms respectively hinged with both sides of the first supporting frame, and two electrode clamping plates respectively arranged on the two first clamping arms; and
the first driving member arranged between the two first clamping arms and respectively connected with the two first clamping arms.

31. The power transmission vehicle device according to claim 30, wherein the electrode clamping plate comprises a first clamping plate and a first conductive plate, the first conductive plate is attached to the inner side of the first clamping plate, the outer side of the first clamping plate extends in the direction of the first clamping arm and is rotationally connected to the first clamping arm, and the clamping surface is one side surface of the first conductive plate away from the first clamping plate.

32. The power transmission vehicle device according to claim 31, wherein the first clamping plate comprises a bending portion, two stiffeners and two connecting plates; each stiffener extends in the circumferential direction of the bending portion, two stiffeners arranged at intervals along the axial direction of the bending portion; the two connecting plates arranged at intervals along the circumferential direction of the bending portion, and both ends connected to the two stiffeners respectively, the connecting plates being rotationally connected to the first clamping arm.
